(19) United States
(12) Patent Application Publication
(10) Pub. No.: US 2013/0232062 A1
(43) Pub. Date: Sep. 5, 2013

(54) SYSTEMS AND METHODS FOR PROVIDING ONLINE MARKET

(71) Applicant: WORK MARKET, INC., New York, NY (US)

(72) Inventor: Jeffrey LEVENTHAL, Lloyd Harbor, NY (US)

(73) Assignee: WORK MARKET, INC., New York, NY (US)

(21) Appl. No.: 13/782,998

(22) Filed: Mar. 1, 2013

Related U.S. Application Data
(60) Provisional application No. 61/605,723, filed on Mar. 1, 2012.

(51) Int. Cl. G06Q 10/10

(52) U.S. Cl. CPC G06Q 10/1053
USPC 705/39; 705/321

(57) ABSTRACT

An online market place system enables a user, also referred to as a buyer, to solicit services from other users by distributing or advertising assignments. The online market place system also enables other users, also referred to as sellers, to accept one or more assignments and perform the solicited services. If the performed assignments are associated with payment terms, the sellers can receive payments from the buyer pursuant to the payment terms. In some cases, the online market place system can provide trade credits to buyers. This way, buyers can create assignments even before funding their accounts on the online market place.

### CROSS-REFERENCE TO RELATED APPLICATION

This application claims the benefit, under 35 U.S.C. §119(e), of the earlier priority date of the U.S. Provisional Patent Application No. 61/605,723, entitled “Systems and Methods for Crowd-sourced Credit and Payment Terms,” by Jeffrey Leventhal, filed on Mar. 1, 2012, which is expressly incorporated herein by reference in its entirety.

### FIELD OF THE DISCLOSURE

The present disclosure relates generally to systems and methods for providing an online market.

### BACKGROUND

Oftentimes, online markets are limited to sales of goods. For example, vendors can list products and inventories on an online market, and buyers can select one of the listed products to buy from the online market. Unfortunately, these online markets often do not scale to accommodate online markets for hiring workers to perform services and/or provide work product (collectively, “contract work”) and for offering contract work. Furthermore, existing online markets can be rigid in that sellers and buyers cannot negotiate terms of the desired contract work and payment terms. Such rigidness can limit the effectiveness of online markets.

### SUMMARY OF THE INVENTION

Some embodiments of the disclosed subject matter include a computer system configured to provide an online market place. The disclosed online market place system can enable a user, also referred to as a buyer, to solicit services from other users by distributing or advertising assignments. The disclosed online market place system can also enable other users, also referred to as a seller, to accept one or more assignments and perform the solicited services. If the performed assignments are associated with payment terms, the sellers can receive payments from the buyer pursuant to the payment terms. In some cases, the disclosed online market place system can provide trade credits to buyers. This way, buyers can create assignments even before funding their accounts on the online market place.

The disclosed subject matter can include a method for operating an online market. The method can include receiving, at a trade credit crowd sourcing module within a server, trade credit from a plurality of accounts associated with one or more computing devices, wherein the server is configured to communicate with the one or more computing devices over a communication network, and consolidating, at the trade credit crowd sourcing module, the trade credit received from the one or more computing devices. The method can further include determining, at an account manager module within the server and in communication with the trade credit crowd sourcing module, if a first account of the online market is associated with a bank account, wherein the first account is associated with a first computing device, and if the first account is associated with a bank account, providing, by a facility assignment module within the server and in communication with the trade credit crowd sourcing module, a portion of the consolidated trade credit as a facility to the first account, wherein the facility comprises trade credit with which the first account can create assignments to purchase one of work services and work product.

The disclosed subject matter can include a network device for operating an online market. The network device can include one or more interfaces configured to provide communication with a first computing device, a second computing device, and one or more additional computing devices over a communication network, wherein the first computing device is associated with a first account, and the second computing device is associated with a second account. The network device can further include a processor, in communication with the one or more interfaces, and configured to receive trade credit, through a trade credit crowd sourcing module, from accounts associated with the one or more computing devices, consolidate, through the trade credit crowd sourcing module, the trade credit received from the one or more computing devices, and determine, through an account manager module, if a first account of the online market is associated with a bank account. If the first account is associated with a bank account, the processor is configured to provide, through a facility assignment module, a portion of the consolidated trade credit as a facility to the first account, wherein the facility comprises trade credit with which the first account can create assignments to purchase one of work services and work product.

The disclosed subject matter can include tangible, non-transitory computer readable media. The computer readable media can include machine-readable executable code operable to cause a data processing apparatus to receive trade credits, through a trade credit crowd sourcing module, from a plurality of accounts associated with one or more computing devices over a communication network, consolidate, through the trade credit crowd sourcing module, the trade credit received from the one or more computing devices, and determine, through an account manager module, if a first account of the online market is associated with a bank account. If the first account is associated with a bank account, the machine-readable executable code in the computer readable media is operable to cause a data processing apparatus to provide, through a facility assignment module, a portion of the consolidated trade credit as a facility to the first account, wherein the facility comprises trade credit with which the first account can create assignments to purchase one of work services and work product.

In one aspect, the method, the network device, or the non-transitory computer readable media can include steps, modules, or executable instructions for receiving, at an assignment coordination module within the server, an assignment from the first computing device, wherein the assignment comprises a description of a requested task, a payment term duration, and a fee associated with the assignment; providing, by the assignment coordination module within the server, the assignment to a second computing device associated with a second account; receiving, at the assignment coordination module within the server, an acceptance message from the second computing device, accepting the assignment created by the first computing device; and providing, by the assignment coordination module within the server, the acceptance message to the first computing device, thereby causing a formation of an agreement to perform the assignment.

In one aspect, the method, the network device, or the non-transitory computer readable media can include steps, modules, or executable instructions for providing the assignment to the second computing device selected by the first computing device.

In one aspect, the second computing device is selected by the first computing device based in part on a Seller Quality Metric score.

In one aspect, the method, the network device, or the non-transitory computer readable media can include steps, modules, or executable instructions for determining, by the facility assignment module within the server, an amount of the facility to be provided to the first account based on one or more of following factors: (1) an amount of facility requested by a user of the first account, (2) a credit rating associated with the user of the first account, (3) a number of workers employed by the user of the first account, (4) a number of years in business by the user of the first account, (5) a reputation of officers working with the user of the first account, and (6) an amount of trade credit offered by a plurality of accounts associated with one or more computing devices.

In one aspect, the credit rating comprises a Dun & Bradstreet rating.

In one aspect, the method, the network device, or the non-transitory computer readable media can include steps, modules, or executable instructions for determining whether the first account should nevertheless receive the facility, and if so, providing, by the facility assignment module within the server, the facility to the first account.

In one aspect, the method, the network device, or the non-transitory computer readable media can include steps, modules, or executable instructions for requesting, by a payment module within the server and in communication with the account manager module, the first account associated with the first computing device to pay the fee in accordance with the payment term duration associated with the assignment; receiving, at the payment module within the server, a payment of the fee from the first account associated with the first computing device; and disbursing, by the payment module within the server, a portion of the payment to the second account associated with the second computing device.

In one aspect, the method, the network device, or the non-transitory computer readable media can include steps, modules, or executable instructions for sending an invoice associated with the assignment to the first computing device.

In one aspect, the invoice associated with the assignment further comprises payables associated with other assignments created by the first account.

In one aspect, the method, the network device, or the non-transitory computer readable media can include steps, modules, or executable instructions for sending a statement associated with the assignment to the first computing device.

In one aspect, providing the facility to the first account is performed before receiving any monetary deposit from the first account.

In one aspect, the method, the network device, or the non-transitory computer readable media can include steps, modules, or executable instructions for providing, by the account manager module within the server to the first computing device, a list of accounts associated with users satisfying one or more predetermined criteria.

In one aspect, the predetermined criteria comprises at least one of (1) a location of a user, (2) a group with which a user is affiliated, (3) skills associated with a user, (4) credentials of a user, (5) qualifications of a user, (6) an age of a user, (7) licenses held by a user, (8) a rating associated with a user, (9) a frequency at which a user's work was declined, and (10) an average fee charged by a user.

In one aspect, the method, the network device, or the non-transitory computer readable media can include steps, modules, or executable instructions for receiving, at the account manager module within the server from the first computing device, a list of users to be associated with a group.

In one aspect, the method, the network device, or the non-transitory computer readable media can include steps, modules, or executable instructions for providing, by the account manager module within the server, a list of assignments created by the first account.

In one aspect, the method, the network device, or the non-transitory computer readable media can include steps, modules, or executable instructions for sending a request to the first computing device, by a pricing calculator module within the server and in communication with the assignment coordination module, to specify the fee associated with the assignment; computing a transaction fee based on the fee associated with the assignment; and providing a total fee, including the fee associated with the assignment and the transaction fee, to the first account.

In one aspect, the method, the network device, or the non-transitory computer readable media can include steps, modules, or executable instructions for sending a request to the first computing device, by a pricing calculator module within the server and in communication with the assignment coordination module, to specify a total fee to be paid for the assignment; and computing a transaction fee based on the total fee.

### BRIEF DESCRIPTION OF THE DRAWINGS

FIG. 1 illustrates a system architecture for providing an online market in accordance with some embodiments of the disclosed subject matter.

FIG. 2 shows a communication system implementing the online market in accordance with some embodiments of the disclosed subject matter.

FIG. 3 illustrates a message flow for the online market system in accordance with some embodiments of the disclosed subject matter.

FIG. 4 illustrates an interface for configuring an account for the online market in accordance with certain embodiments of the disclosed subject matter.

FIG. 5 illustrates an interface for providing contact information in accordance with certain embodiments of the disclosed subject matter.

FIG. 6 illustrates an interface for adding an employee to a user's account in the online market in accordance with certain embodiments of the disclosed subject matter.

FIG. 7 illustrates an interface for adding a financial account with a user's account in the online market in accordance with certain embodiments of the disclosed subject matter.

FIG. 8 illustrates an interface for configuring default assignment settings in accordance with some embodiments of the disclosed subject matter.

FIG. 9 illustrates an interface for configuring default assignment settings in accordance with some embodiments of the disclosed subject matter.

FIG. 10 illustrates payment mechanisms supported by the online market system in accordance with some embodiments of the disclosed subject matter.

FIG. 11 illustrates an interface for requesting the buyer to specify payment terms in accordance with some embodiments of the disclosed subject matter.

FIG. 12 illustrates an interface for configuring payment terms in accordance with some embodiments of the disclosed subject matter.

FIG. 13 illustrates an interface for configuring default payment term duration in accordance with some embodiments of the disclosed subject matter.

FIGS. 14-15 illustrate an interface for creating a payment term duration candidate in accordance with some embodiments of the disclosed subject matter.

FIG. 16 illustrates an interface for enabling an auto-pay option in accordance with some embodiments of the disclosed subject matter.

FIG. 17 illustrates an interface for configuring the auto-send of invoices in accordance with some embodiments of the disclosed subject matter.

FIG. 18 illustrates an interface for configuring payment terms in accordance with some embodiments of the disclosed subject matter.

FIG. 19 illustrates an interface for configuring an interval for receiving payment statements in accordance with some embodiments of the disclosed subject matter.

FIG. 20 illustrates an interface for configuring a number of days for processing the received statements in accordance with some embodiments of the disclosed subject matter.

FIG. 21 illustrates an interface for configuring a payment method in accordance with some embodiments of the disclosed subject matter.

FIG. 22 illustrates a review panel in accordance with some embodiments of the disclosed subject matter.

FIG. 23 illustrates a process for crediting a new buyer's account with facilities in accordance with some embodiments of the disclosed subject matter.

FIG. 24 illustrates an interface for overriding the server's bank setup in accordance with some embodiments of the disclosed subject matter.

FIG. 25 illustrates an interface for creating and setting up a seller's account in accordance with some embodiments of the disclosed subject matter.

FIG. 26 illustrates an interface for specifying the certifications associated with the seller in accordance with some embodiments of the disclosed subject matter.

FIG. 27 illustrates an interface for identifying products associated with the seller in accordance with some embodiments of the disclosed subject matter.

FIG. 28 illustrates an interface for providing tax information associated with a seller in accordance with some embodiments of the disclosed subject matter.

FIG. 29 illustrates a home dashboard for buyers in accordance with some embodiments of the disclosed subject matter.

FIG. 30 illustrates a home dashboard for sellers in accordance with some embodiments of the disclosed subject matter.

FIG. 31 illustrates an interface for viewing a profile of an account in accordance with some embodiments of the disclosed subject matter.

FIG. 32 illustrates a profile page with a status pane in accordance with some embodiments of the disclosed subject matter.

FIG. 33 illustrates an interface for creating an assignment in accordance with some embodiments of the disclosed subject matter.

FIG. 34 illustrates an interface for identifying the client and the project for an assignment in accordance with some embodiments of the disclosed subject matter.

FIG. 35 illustrates an interface for creating a project for an assignment in accordance with certain embodiments of the disclosed subject matter.

FIG. 36 illustrates a project table for maintaining a list of projects associated with an assignment in accordance with some embodiments of the disclosed subject matter.

FIG. 37 illustrates an interface for specifying a schedule for the assignment in accordance with some embodiments of the disclosed subject matter.

FIG. 38 illustrates a custom fields pane and a surveys pane for specifying custom fields and surveys in accordance with certain embodiments of the disclosed subject matter.

FIG. 39 illustrates an interface for specifying a fee for the assignment in accordance with some embodiments of the disclosed subject matter.

FIG. 40 illustrates an interface for specifying a fee for the assignment in accordance with some embodiments of the disclosed subject matter.

FIG. 41 illustrates an interface for modifying a payment term duration for an assignment in accordance with some embodiments of the disclosed subject matter.

FIG. 42 illustrates an interface for specifying closing instructions in accordance with certain embodiments of the disclosed subject matter.

FIG. 43 illustrates an interface for managing assignment templates in accordance with some embodiments of the disclosed subject matter.

FIG. 44 illustrates an interface for selecting target sellers in accordance with some embodiments of the disclosed subject matter.

FIG. 45 shows an interface for creating a group of sellers in accordance with some embodiments of the disclosed subject matter.

FIG. 46 illustrates an interface for sending invitations to join a group in accordance with some embodiments of the disclosed subject matter.

FIG. 47 illustrates an interface listing groups of sellers available for the user in accordance with some embodiments of the disclosed subject matter.

FIG. 48 illustrates an interface for creating a test in accordance with some embodiments of the disclosed subject matter.

FIG. 49 shows a test pane for providing a list of tests in accordance with some embodiments of the disclosed subject matter.

FIG. 50 shows an interface showing a summary of an assignment distributed to sellers in accordance with some embodiments of the disclosed subject matter.

FIG. 51 illustrates an assignment viewed by a seller in accordance with some embodiments of the disclosed subject matter.

FIG. 52 illustrates an interface for modifying terms of an assignment in accordance with some embodiments of the disclosed subject matter.

FIG. 53 illustrates an interface for requesting modification of schedules for the assignment in accordance with some embodiments of the disclosed subject matter.

FIG. 54 illustrates a reimbursement request pane for requesting a reimbursement in accordance with some embodiments of the disclosed subject matter.

FIG. 55 shows a status pane for the seller in accordance with some embodiments of the disclosed subject matter.

FIG. 56 illustrates an interface for evaluating seller's work product in accordance with some embodiments of the disclosed subject matter.

FIG. 57 shows an interface requesting the buyer to pay the due balance in accordance with some embodiments of the disclosed subject matter.

FIG. 58 shows an interface for stopping payment in accordance with some embodiments of the disclosed subject matter.

FIG. 59 illustrates an interface for rating other users in accordance with some embodiments of the disclosed subject matter.

FIG. 60 shows an assignment dashboard in accordance with some embodiments of the disclosed subject matter.

FIG. 61 shows a finance dashboard in accordance with some embodiments of the disclosed subject matter.

FIG. 62 shows a payable dashboard in accordance with some embodiments of the disclosed subject matter.

FIG. 63 shows a ledger dashboard in accordance with some embodiments of the disclosed subject matter.

FIG. 64 shows a receivable dashboard in accordance with some embodiments of the disclosed subject matter.

FIG. 65 shows an interface for funding an account in accordance with some embodiments of the disclosed subject matter.

FIG. 66 illustrates an interface for creating a campaign in accordance with some embodiments of the disclosed subject matter.

FIG. 67 shows an interface for managing recruiting campaigns in accordance with some embodiments of the disclosed subject matter.

FIG. 68 illustrates an interface for receiving a report of activities in accordance with some embodiments of the disclosed subject matter.

FIG. 69 shows an interface for building a custom report in accordance with some embodiments of the disclosed subject matter.

FIG. 70 shows a notification pane for an account in accordance with some embodiments of the disclosed subject matter.

FIG. 71 shows an interface for creating a survey in accordance with certain embodiments of the disclosed subject matter.

FIG. 72 illustrates an interface for inviting sellers to take a survey in accordance with some embodiments of the disclosed subject matter.

FIG. 73 shows a survey pane for maintaining a list of surveys in accordance with some embodiments of the disclosed subject matter.

FIG. 74 illustrates an interface for managing custom fields created by a user in accordance with some embodiments of the disclosed subject matter.

FIG. 75 illustrates a learning center in accordance with some embodiments of the disclosed subject matter.

FIG. 76 illustrates an interface for taking a test in accordance with some embodiments of the disclosed subject matter.

FIG. 77 shows a test manager pane in accordance with some embodiments of the disclosed subject matter.

FIG. 78 illustrates a logical diagram of a server in accordance with some embodiments of the disclosed subject matter.

### DESCRIPTION OF EXAMPLE EMBODIMENTS

The disclosed subject matter relates generally to systems and methods for providing an online market for hiring workers to perform services and/or provide work product (collectively, “contract work”) and for offering contract work. In the present disclosure, the online market system is termed the Work Market system, or the WM in short.

The WM can allow users to interact with one another to create work assignments, execute work assignments, and complete assignment-related transactions. The WM refers to some users as a buyer and some users as a seller. A buyer refers to a person, a company, or a party that is seeking to receive contract work; a seller refers to a person, a company, or a party that is seeking to provide contract work. For example, a seller can enter into an agreement with a buyer to provide contract work to the buyer in exchange for consideration such as money, shares, securities, or goods. Sometimes, a seller is also referred to as a resource. Buyers and sellers can maintain an account with the WM and use the account to perform assignment-related transactions.

The WM can provide many benefits to buyers. The WM can provide mechanisms to adapt the workforce based on the actual need. For example, using the WM, a buyer can hire sellers that satisfy certain qualifications and needs of the assignment, instead of hiring an employee that may not have the skills to work on a variety of assignments. In some cases, the buyer can use the WM to vet the sellers to find just the right sellers for assignments.

The WM can also provide mechanisms for a buyer to allocate assignments to sellers efficiently and to avoid workforce redundancies. For example, using the WM, a buyer can monitor the location and the status of sellers, the capabilities of the sellers, and the current assignments associated with the sellers.

The WM can manage project tasks and monitor the progress of the assigned project tasks. For example, the WM can manage individual sellers and progress of project tasks, and report the progress to the buyer. The WM can also provide mechanisms for a buyer to meet milestones and assignment deadlines by keeping project management and team communication in one place, and to monitor the issues in real-time, thereby facilitating speedy resolution of issues.

The WM can also manage invoices for all assignments deployed through the WM. For example, the WM can keep track of invoices and due dates associated with them, and notify buyers when any of the invoices are due for payment. Thus, the WM provides a centralized invoice management system for buyers.

In some cases, the WM can provide trade credit to buyers even when the buyers' accounts are not funded. It may take time for buyers to fund their accounts at the WM because buyers do not have enough funds to deploy the assignments or because bank transactions take time. The WM can address these issues by providing trade credit to buyers even when the buyers' accounts are not funded. This way, the buyer can deploy assignments using trade credit even before funding its account at the WM. The WM can be configured to provide trade credit when the buyer's bank account is associated with its WM account. In some cases, the WM can be configured to provide trade credit to a buyer even if the buyer's bank account is not associated with the buyer's WM account.

The WM can also provide insurance coverage to buyers. For example, the WM can provide insurance to cover buyer's general liability and professional liability. The insurance can cover errors and omissions that might occur while the seller is on-site to perform buyer's assignment. For example, the insurance can cover buyer's liability in seller's physical harm that may occur due to buyer's error or omission. Also, the insurance may cover business interruptions. In some cases, the insurance coverage can be provided via a subsidiary of the WM.

The WM can also provide many benefits to sellers. The WM can provide fast payment for a seller's work. For example, if a seller works on an assignment associated with immediate payment terms, the seller can be paid immediately after the assignment is approved by the buyer, thereby eliminating a long period of hassle and unnecessary costs associated with collecting payments.

The WM can reduce the risk associated with not receiving prompt payment. When a seller accepts an assignment on certain payment terms, the WM can enforce the payment terms to reduce the risk associated with not receiving prompt payment. For example, if a buyer does not pay a contractor, the WM can close the buyer's account.

The WM can also provide a market place through which the seller can generate additional income. The seller can simply create an account with the WM and allow the WM to bring work to the seller. In some cases, the WM can provide mechanisms for sellers to join groups and take tests to increase their exposure to more work.

The WM can also assist with tax filing and compliance. The WM can consolidate a seller's income into a single tax form, such as the Form 1099, regardless of the number of buyers for whom the seller completed assignments. In some cases, the WM can automatically handle the compliance and filing of the tax form, which can save money for the seller, and gives sellers the added security of not having to share personal information with buyers.

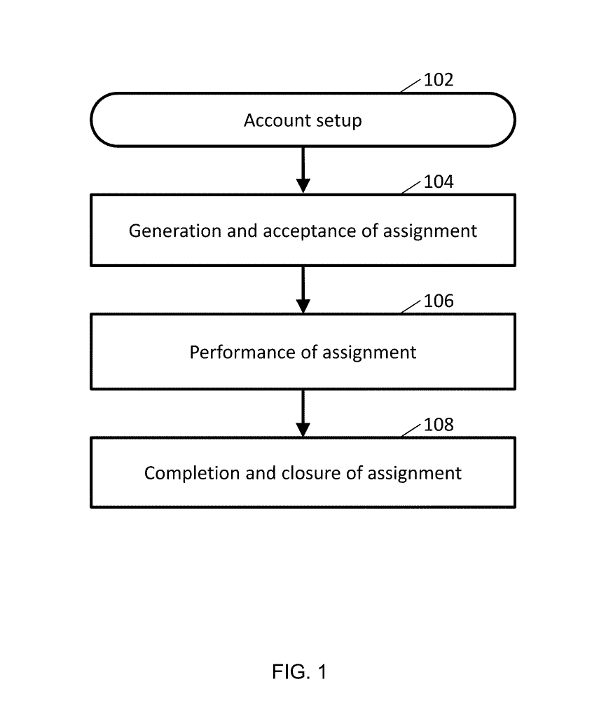

FIG. 1 illustrates a high-level transaction within the WM for creating assignments and performing assignments in accordance with some embodiments of the disclosed subject matter. In step 102, the buyer and the seller can setup their accounts and provide their profile information to the WM. For example, the buyer can provide the party's name, the contact information, and the affiliated industry; and the seller can provide the party's name, the contact information, and any qualifications or licenses associated with the seller.

In step 104, once a buyer sets up an account, the buyer can use its account to create an assignment. The assignment can specify the type of work to be done, the desired time frame, and/or any sought-after qualifications of sellers. In some cases, the buyer can select one or more sellers from a pool of sellers and send the created assignment only to the selected sellers. Upon reviewing the created assignment, a seller can use its account to accept the buyer's assignment. If needed, the buyer and the seller can further negotiate the terms of the assignment before forming an agreement to perform the assignment.

In step 106, the seller can perform the assignment. In some cases, the seller and the buyer can modify terms of the assignment during the performance of the assignment, as is necessary.

In step 108, once the seller completes the assigned tasks, the buyer can review the rendered service or the work product. If the buyer approves the service or the work product and pays the agreed fee, the WM can close the assignment. On the other hand, if the buyer is dissatisfied with the rendered service or the work product, the buyer can reject the service or the work product, and ask the seller to cure the deficiencies.

Therefore, the WM can integrate, consolidate, and automate a plurality of business activities for a plurality of buyers and sellers. Buyers can more easily find and contract with qualified sellers. Buyers are exposed to a large number of qualified professionals, and professionals are exposed to a large number of assignments that were previously unavailable. Thus, the WM includes social networking elements that allows a buyer to “crowd-source” projects and credit and recruit sellers.

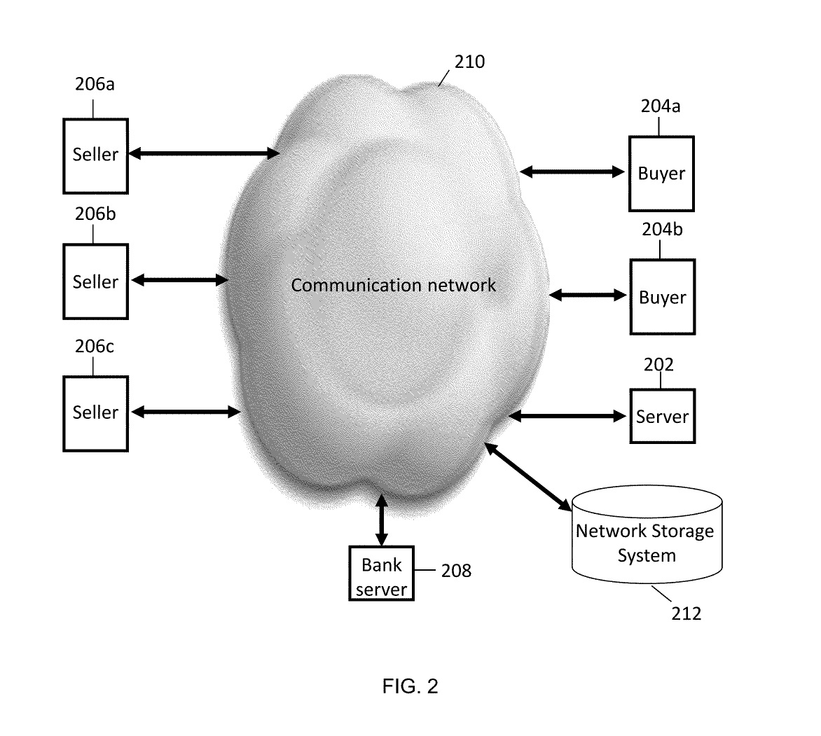

FIG. 2 illustrates a system architecture for providing the WM in accordance with some embodiments of the disclosed subject matter. The system of FIG. 2 includes a server 202, one or more buyer computing devices 204a-204b, one or more seller computing devices 206a-206c, a bank server 208, and a communication network 210.

In some embodiments, the buyer computing devices 204a-204b and the seller computing devices 206a-206c include a client to communicate with other buyers and sellers on the WM. The client can include custom software or a web browser. The computing device is capable of communicating over a communication network 210. Each computing device can send data to, and receive data from, the server 202 over the communication network 210. Each computing device can be directly coupled to the server 202; alternatively, each computing device can be connected to server 202 via any other suitable device, communication network, or combination thereof. For example, each computing device can be coupled to the server 202 via one or more routers, switches, access points, and/or communication networks (as described below in connection with communication network 210).

A computing device can include a desktop computer, a mobile computer, a tablet computer, a cellular device, or any computing system that is capable of performing appropriate computation. In some embodiments, the computing device is a long term evolution (LTE) user equipment. The user equipment can communicate with one or more radio access networks and with wired communication networks. The user equipment can be a cellular phone having phonetic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system such as Symbian OS, iPhone OS, RIM's Blackberry, Windows Mobile, Linux, HP WebOS, and Android. The screen might be a touch screen that is used to input data to the mobile device, in which case the screen can be used instead of the full keyboard. The user equipment can also keep global positioning coordinates, profile information, or other location information.

The computing device can also include any other platforms capable of computations and communication. Non-limiting examples can include televisions (TVs), video projectors, set-top boxes or set-top units, digital video recorders (DVR), computers, netbooks, laptops, and any other audio/visual equipment with computation capabilities. The computing device can have a memory such as a computer readable medium, flash memory, a magnetic disk drive, an optical drive, a programmable read-only memory (PROM), and/or a read-only memory (ROM). The computing device is configured with one or more processors that process instructions and run software that may be stored in memory. The processor also communicates with the memory and interfaces to communicate with other devices. The processor can be any applicable processor such as a system-on-a-chip that combines a CPU, an application processor, and flash memory. The computing device can also provide a variety of user interfaces such as a keyboard, a touch screen, a trackball, a touch pad, and/or a mouse. The computing device may also include speakers and a display device in some embodiments.

The operator can use the server 202 to manage the WM. The WM operator can use the server 202 to provide content to the buyers and sellers, and to receive information from the buyers and the sellers. The server 202 can be a single server, or a network of servers, or a farm of servers in a data center.

In some embodiments, the server 202 can be coupled to a network storage system 212. The network storage system 212 can include two types of network storage devices: a local network storage and a remote network storage. The local network storage and the remote network storage can each include at least one physical, non-transitory storage medium. The network storage system can maintain a database for account information associated with the buyer and the seller. The network storage system can also include modules or databases for receiving money, transmitting money, and consolidating credit facilities, as described in more detail below.

The bank server 208 can communicate with the server 202 via the communication network 210. FIG. 2 shows the bank server 208 as a single server; however, the bank server 208 can include a network of servers, or a farm of servers in a data center. The bank server 208 can include a bank server associated with buyer's bank accounts, a bank server associated with seller's bank accounts, a bank server associated with the WM's bank account, and/or a bank server associated with the buyer's or the seller's credit card. The server 202 can work with the bank server 208 to complete banking and credit card transactions, including wire transfers, a lockbox, and automated clearing house transfers (ACH).

The communication network 210 provides a communication channel between the server 202, buyers 204, sellers 206, and a bank server 208. In some embodiments, communication network 210 is the collection of networks commonly referred to as the Internet. The communication network 210 can include a network or combination of networks that can accommodate private data communication. For example, the communication network 210 can include a local area network (LAN), a virtual private network (VPN) coupled to the LAN, a private cellular network, a private telephone network, a private computer network, a private packet switching network, a private line switching network, a private wide area network (WAN), a corporate network, or any number of private networks that can be referred to as an Intranet. The communication network 210 can accommodate various communication protocols, including Hypertext Transfer Protocol (HTTP.) Such networks may be implemented with any number of hardware and software components, transmission media and network protocols. FIG. 2 shows the network 210 as a single network; however, the network 210 can include multiple interconnected networks listed above.

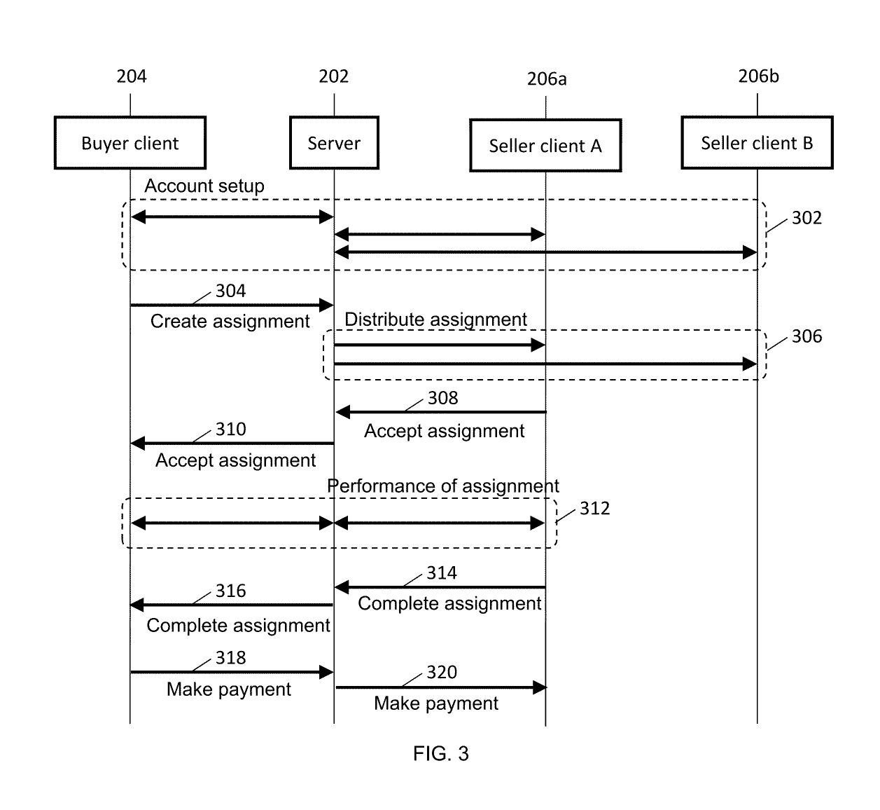

FIG. 3 illustrates a message flow for the online market system in accordance with some embodiments of the disclosed subject matter. The message flow in FIG. 3 illustrates, at a high level, the type of messages communicated between the server and computing devices within the online market system. Detailed descriptions of the messages in FIG. 3 are provided below throughout the disclosure.

In step 302, the buyer client 204 and the seller clients 206a-206b can communicate with the server 202 to set up their accounts and the profile information, including default payment terms and bank account information. The payment terms can include conditions under which a buyer is soliciting acceptance of the assignment. The conditions can include a period allowed to a buyer to pay the amount due, or a deferred payment structure. During the account setup, the buyer client 204 can receive the facilities or trade credit necessary for creating new assignments for the purchase of contract work.

In step 304, the buyer client 204 can use the account to create an assignment and provide the assignment to the server 202. The assignment can include the description of the requested tasks and the payment terms. In some cases, the buyer client 204 can specify seller clients 206 to which the server 202 should provide the assignment. In step 306, the server 202 can distribute the assignment. If the server 202 receives instructions for the distribution of the assignment, the server 202 can adhere to the received instructions. For example, the server 202 can distribute the assignment to sellers specified by the buyer client 204; or the server 202 can distribute the assignment to all sellers that satisfy certain qualifications specified by the seller. In some cases, the server 202 can post the assignment on a website on which sellers can view the assignment. In step 308, one of the seller clients, can accept the assignment and send the acceptance to the server 202. In FIG. 3, the seller client A 206a accepts the assignment. Subsequently, in step 310, the server 202 can relay the acceptance to the buyer client 204, thereby forming an agreement to perform the assignment. In some cases, during steps 308 and 310, the seller and the buyer can negotiate certain terms of the assignment. The negotiation can take place within the WM, or off-line.

In step 312, the seller client A 206a can perform the assignment. In some cases, during the performance, the buyer client 204 and the seller client A 206a can modify the terms of the assignment, if needed. For example, the buyer client 204 and the seller client A 206a can agree to modify the due date of the assignment or the payment structure of the assignment. In step 314, the seller client A 206a can complete the assignment and notify the server 202 that the assignment has been completed. Along with the notification, the seller client A 206a can also provide any work product generated during the assignment. In step 316, the server 202 can notify the buyer client 204 that the assignment has been completed, and relay any work product received from the seller client 206.

In step 318, the buyer client 204 can review the rendered services and/or the work product. If the buyer client 204 is satisfied, the buyer client 204 can approve the rendered services and/or the work product. If the buyer client 204 is dissatisfied, the buyer client 204 can request the seller client 206 to cure any deficiencies.

In step 320, upon approval, the buyer client 204 can make the payment to the server 202 pursuant to payment terms associated with the assignment. The server 202 would receive the payment from the buyer client 204, and the server 202 can disburse the payment to the seller client A 206a. This way, the seller's bank account information does not need to be distributed to all the buyers working with the seller. In some cases, the buyer client 204 may directly pay the seller client A206a, for example, through off-line means including cash payment, bank account transfers, money order payments, or a check payment.

In some embodiments, the buyer client 204 can launch several assignments in parallel. In some embodiments, the buyer client 204 can allow several sellers to work on a single assignment.

While the disclosed embodiments are designed to facilitate transactions between buyers and sellers, the disclosed embodiments are also designed to reduce communication overhead between buyers and sellers. Even though most of the transactions can take place via the WM, buyers and sellers can also communicate off-line, such as over the phone.

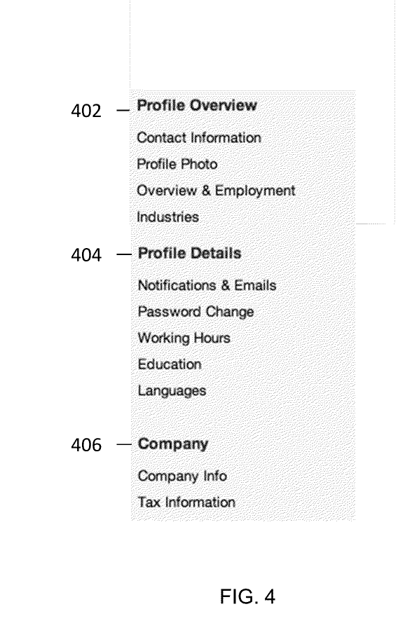

As discussed in step 302, a new user of the online market place can create an account in order to create assignments at the WM. FIG. 4 illustrates an interface for configuring an account for a new buyer in the online market in accordance with certain embodiments of the disclosed subject matter. The interface can include a profile overview pane 402, a profile details pane 404, and a company pane 406. The profile overview pane 402 can allow the user to provide one or more of the following: contact information, a profile photograph, an overview of the user, and industries associated with the user. The profile details pane 404 can allow the user to provide or alter one of more of the following: notification and email settings, password, working hours, academic credentials, and/or list of languages at which the user is proficient. The company pane 406 can allow the user to provide information about the company with which the user is affiliated, and any tax information associated with the company. In some embodiments, the server 202 may gather information about the user and pre-populate the profile information with the gathered information. In some cases, the server 202 may gather information from social networking sites, including LinkedIn and Facebook. In other cases, the server 202 may contact and search corporate databases to gather information. In some embodiments, the server 202 may gather information about the seller in response to a request from the seller; in other embodiments, the server 202 may automatically gather information about the seller.

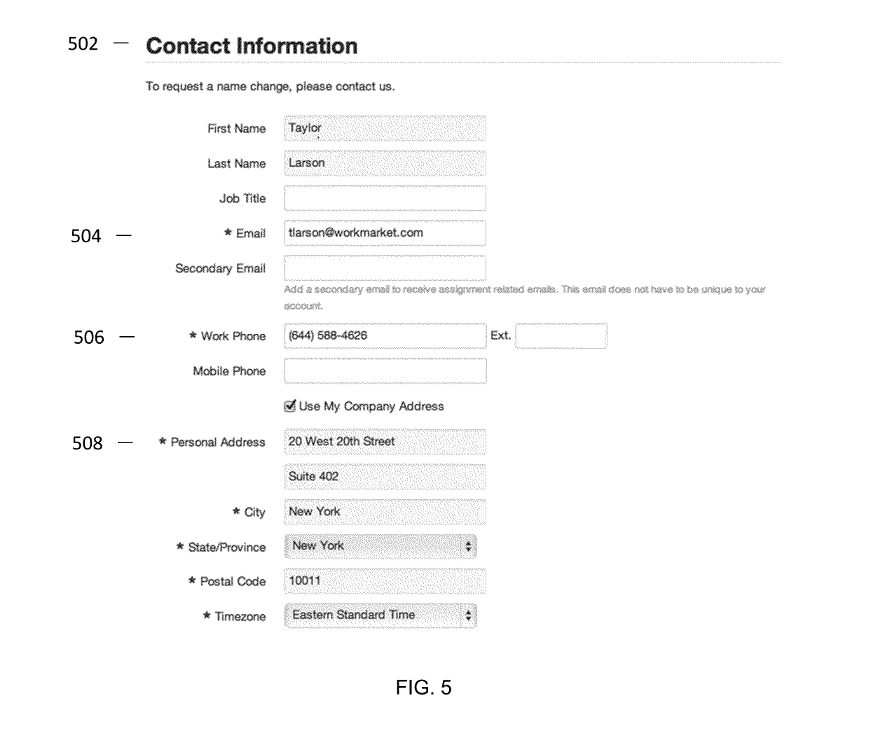

In some embodiments, a new user can click on one of the entries on the panes 402-406 to edit account information. For example, the user can click on the “contact information” element to edit the user's contact information. When the user clicks on the contact information, the user can be provided with a contact information pane, as illustrated in FIG. 5 in accordance with certain embodiments of the disclosed subject matter. The contact information pane 502 can include fields for providing email addresses 504, phone numbers 506, and a personal address 508. Similar interfaces can be available for other elements illustrated in FIG. 4.

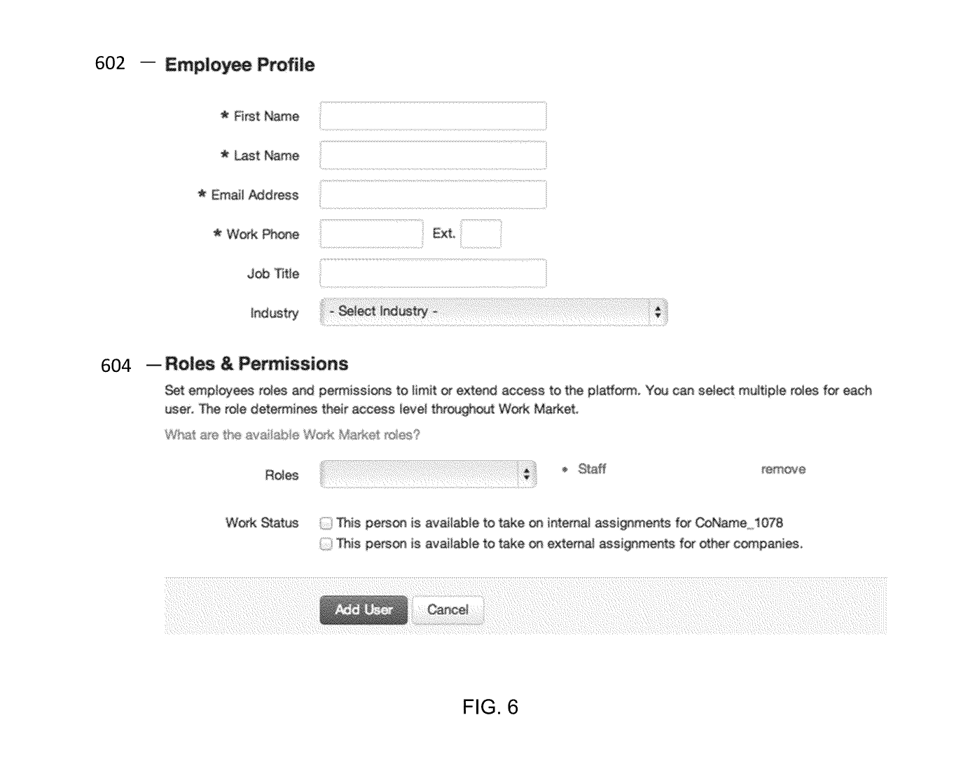

In some embodiments, the user can add employees associated with the company to the WM account. This way, the user can authorize the employees to act on behalf of the user, based on the roles and responsibilities associated with the employees. FIG. 6 illustrates an interface for adding an employee to a user's account in the online market in accordance with certain embodiments of the disclosed subject matter. The user can provide the employee's profile information using the employee profile pane 602. Along with the profile information, the user can also indicate the roles and permissions to be associated with the employee using the Roles and Permissions pane 604. For example, the user can indicate that Phillip Goldenberg is a staff at the user's company. In some embodiments, the user can specify more than one roles associated with the employee.

In some embodiments, a user's account can be associated with a security setting. For example, a user's account may not be accessed from IP addresses other than specified by the user.

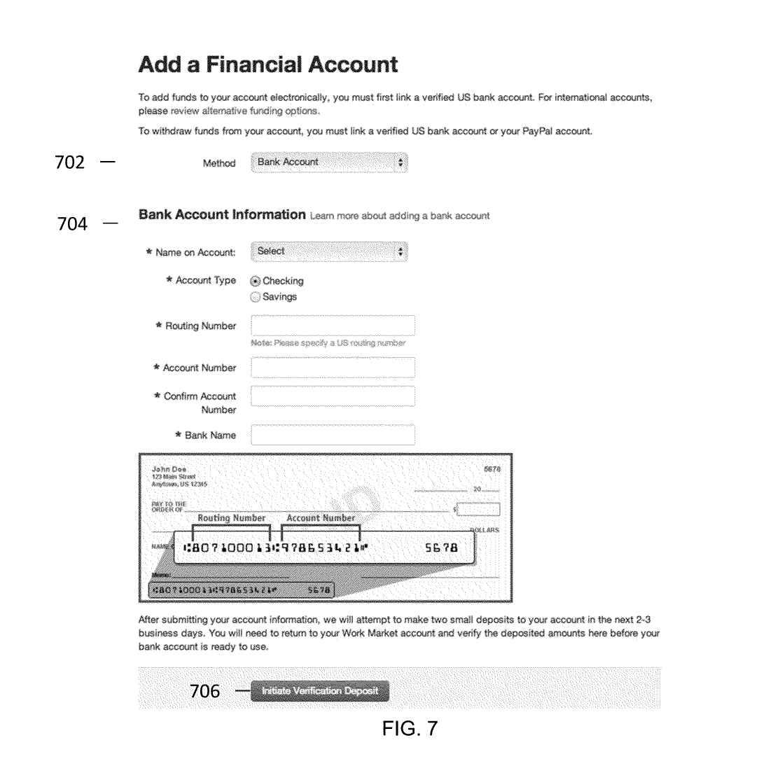

In some embodiments, the user can add at least one financial account associated with the user's WM account. FIG. 7 illustrates an interface for adding a financial account with a user's account in the online market in accordance with certain embodiments of the disclosed subject matter. The financial account can include a bank account, a credit card account, a PayPal account, or any other accounts associated with financial institutions. The user can choose the type of financial account to be added to the WM account by choosing from a pull down menu 702. In this case, the user chose to add a bank account. To add a bank account to the WM account, a user can (1) submit the bank account information, (2) initiate verification deposits; and (3) confirm the deposit amounts. The user can use the bank account pane 704 to provide the bank account information, and click on the verification icon 706 to initiate the verification process. Other linking and verification processes known by those having ordinary skill in the art may also be used.

In some embodiments, a user's account can be configured as a buyer's account, which is allowed to create assignments for sellers. In some embodiments, a user's account can be configured as a seller's account, which is allowed to accept or apply for assignments from buyers. In some embodiments, a single account can serve as both a buyer's account and a seller's account.

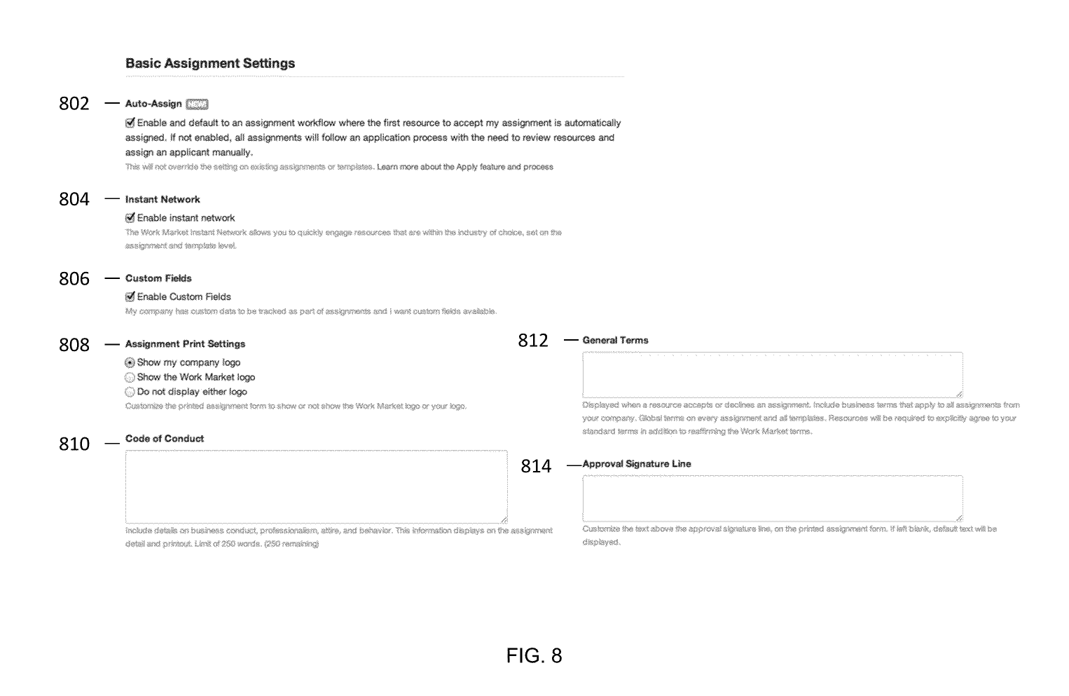

In some embodiments, a user can configure default assignment settings to be applied to assignments created by the user. FIG. 8 illustrates an interface for configuring default, basic assignment settings in accordance with some embodiments of the disclosed subject matter. The basic assignment settings can include an auto-assign feature 802. If a user configures its account with the auto-assign feature 802, the server 202 may automatically assign user's assignments to sellers. In some embodiments, the server 202 may automatically assign user's assignment to the first seller to accept the user's assignment. In other embodiments, the server 202 may automatically assign user's assignment to a seller based on preconfigured criteria. The preconfigured criteria can include a rating of sellers. For example, the server 202 may automatically assign user's assignment to the first seller to accept the user's assignment and also have a rating higher than a predetermined threshold. In another example, the server 202 may automatically assign user's assignment to the seller with the highest rating amongst sellers that have accepted the user's assignment. The preconfigured criteria can also include one or more of: (1) location of seller, (2) skills associated with seller, (4) credentials of seller, (5) qualifications of seller (6) an age of seller, (7) licenses held by seller, (8) a frequency at which seller's work was declined, and (9) an average fee charged by seller.

If the auto-assign feature is not enabled, all assignments can undergo an application process in which the user (1) reviews sellers willing to work on the created assignment and (2) selects one of those sellers.

The basic assignment settings can include an instant network feature 804. The instant network feature 804 allows the user to quickly engage sellers that are within a chosen industry. For example, when a buyer uses the WM for the first time, the buyer may not know which sellers to hire. Or, when a buyer has an assignment that may not require particular skills, the buyer may not care which sellers perform the assignment. In such circumstances, the buyer can turn on an instant network feature to access an entire database of resources, or a portion of the database relating to resources in a particular industry, and send the assignment to those resources.

In some embodiments, the buyer can set up a template level preference for the instant network feature. For example, the buyer can indicate that assignments generated using a particular template should be distributed to resources via the instant network feature. In other embodiments, the buyer can set up an assignment level preference for the instant network feature. For example, the buyer can indicate, for each assignment, whether the buyer would like to use the instant network feature. In yet other embodiments, the buyer can set up a characteristic-level preference for the instant network feature. For example, the buyer can indicate that whenever a buyer creates an assignment of a predetermined type (e.g., that the assignment requires a certain skill or a certain license), the assignment should be distributed via the instant network feature.

The basic assignment settings can also include a custom fields feature 806. The custom fields feature 806 allows the buyer to set up customized fields to provide or receive information specific to the buyer's business. The customized fields feature 806 allows a buyer to customize the information flow between the buyer and its sellers. In some embodiments, the buyer can group a plurality of customized fields into a customized field set. This way, the buyer can select a plurality of customized fields for use in an assignment with a single selection of the associated customized field set.

The basic assignment settings can also include an assignment print setting 808, which can specify the logo that would accompany the assignment. In some cases, the basic assignment settings can also include a code of conduct 810, general terms 812, and an approval signature line 814 to be included in assignments.

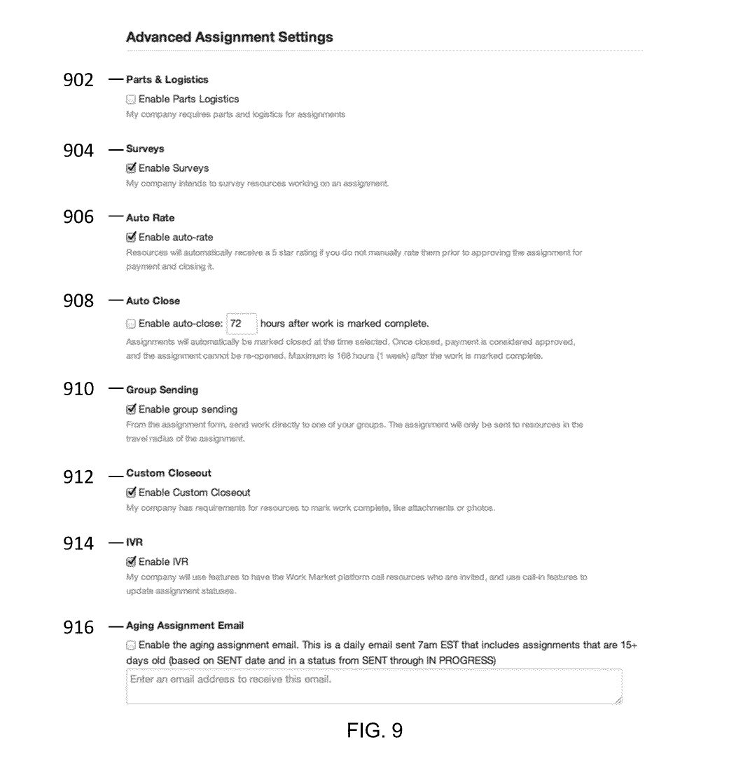

In some embodiments, a user can also specify default, advanced assignment settings, as illustrated in FIG. 9 in accordance with some embodiments of the disclosed subject matter. The advanced assignment settings can include a parts and logistics feature 902. If a user opts in for the parts and logistics feature 902, the sellers working on the buyer's assignment will be requested to provide parts and logistics for the buyer's assignment. The advanced assignment settings can also include a surveys feature 904. If a user opts in for the surveys feature 904, the assignment would indicate that the seller has to complete one or more surveys in order to complete the assignment.

The advanced assignment settings can also include an auto rate feature 906. If a user opts in for the auto rate feature 906, the server 202 would provide a 5-star rating to the seller if the user does not rate the seller before the closure of the assignment. The advanced assignment settings can also include an auto-close feature 908. If a user opts in for the auto-close feature 908, the server 202 would automatically close the assignment after a certain period of time once the seller completes the requested task. The advanced assignment settings can also include a group sending feature 910. If a user opts in for the group sending feature 910, the user's assignment would be sent directly to one of the groups. In some cases, the assignment will only be sent to sellers within a travel radius of the assignment.

The advanced assignment settings can also include a custom closeout feature 912. If a user opts in for the custom closeout feature 912, the user can customize the list of work product that should be provided by the seller in order to complete a particular assignment. For example, via the custom closeout feature 912, the user can indicate that the seller should provide attachments or photographs in order to closeout an assignment.

The advanced assignment settings can also include an interactive voice response (IVR) feature 914. If a user opts in for the IVR feature 914, the user would be enabled to use features to have the Work Market call invited sellers, and use call-in features to update assignments or assignment statuses.

The advanced assignment settings can also include an aging assignment email feature 916. If a user opts in for the aging assignment email feature 916, the server 202 would send an email to the user at a fixed interval, the email including assignments that are more than a fixed number of days old. For example, the server 202 can review the date on which the assignment was sent to the sellers, and determine which of those assignments have been outstanding for more than a fixed number of days. Then the server 202 would create an email listing the assignments that have been outstanding for more than a fixed number of days, and send that email to the user.

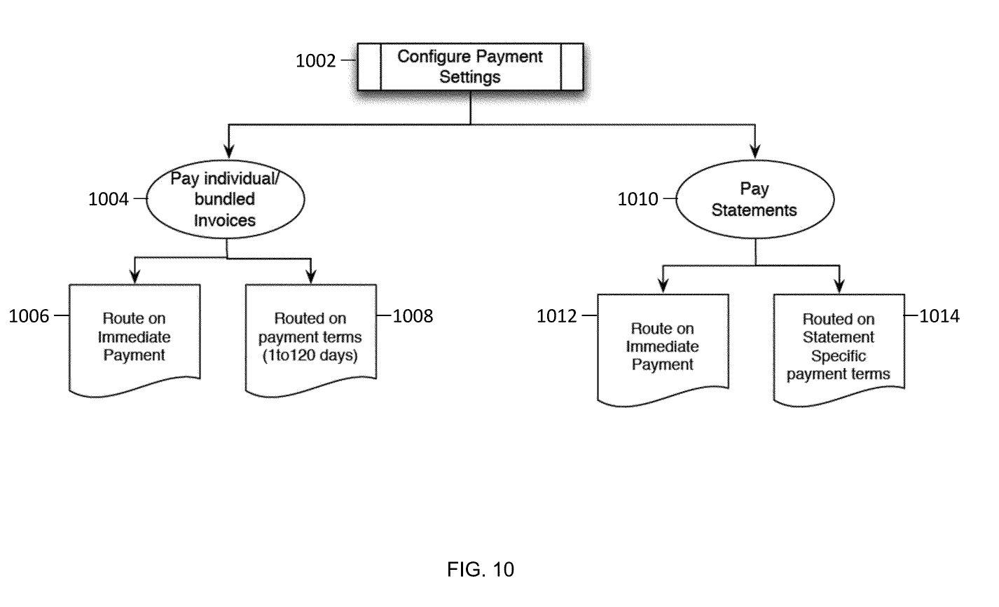

In some embodiments, during the account setup, the WM can request the buyer to subscribe to a payment mechanism. FIG. 10 illustrates payment mechanisms supported by the Work Market in accordance with some embodiments of the disclosed subject matter. The WM can support at least two payment mechanisms: the payment of invoices or the payment of statements. In step 1002, the buyer can configure the preferred payment mechanism.

If the buyer opts in for the invoice option, the server 202 would generate an invoice for each closed assignment, and in step 1004, the server 202 would request the buyer to pay the fee on the invoice. In some cases, the server 202 may not modify already created invoices, which is a standard accounting practice.

In some embodiments, the server 202 can bundle the buyer's invoices for payment. For example, the server 202 can bundle invoices associated with the same seller, but for multiple assignments; the server 202 can bundle invoices associated with multiple sellers, but for the same assignment; or the server 202 can bundle invoices for a particular group of sellers based on a predetermined criterion. In some cases, the server 202 can bundle invoices based on a request from the buyer.

Once the buyer pays the invoice, the server 202 can disburse the payment to appropriate sellers based on the payment term duration of the assignment. For example, if the payment term duration is 0 days (i.e., immediate payment), then in step 1006, the server 202 would disburse the payment immediately. If the payment term duration is a non-zero number of days, the server 202 would trigger the clock for the payment term duration as soon as the buyer approves the work and closes the assignment, and upon receipt of the payment from the buyer, the server 202 would disburse the payment by the payment term.

If the buyer opts in for the statement option in step 1002, the buyer would receive a statement that lists due payments for all sellers working for the buyer. The buyer would then be required to pay the fee on the statement by a predetermined date. In some cases, the server 202 can provide the statements in regular intervals.

In step 1010, upon reviewing the statement, the buyer can pay the due amount by the statement due date. Once the buyer pays the statement, the server 202 can disburse the payment to appropriate sellers based on the payment terms associated with the assignment. For example, in step 1012, the server 202 may disburse the payment immediately, or in step 1014, the server 202 may disburse the payment after a fixed period of time based on the payment terms associated with the assignment.

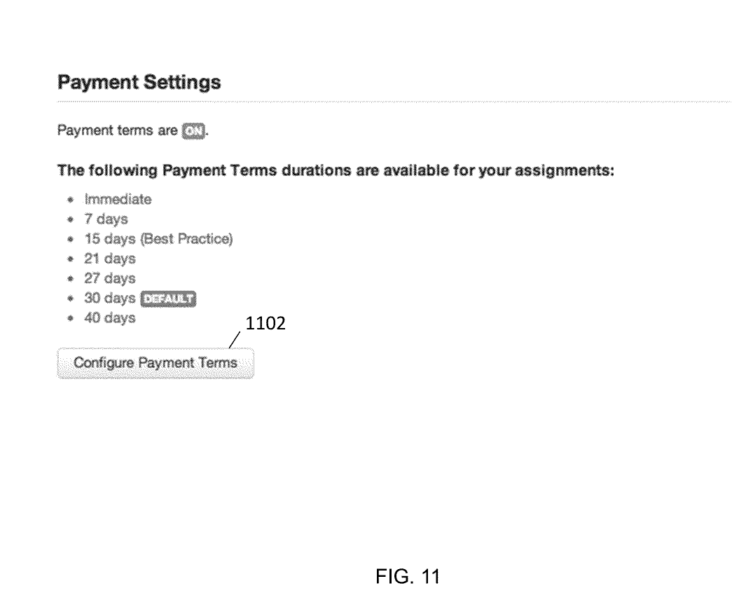

FIG. 11 illustrates an interface for configuring a payment mechanism in accordance with some embodiments of the disclosed subject matter. In some embodiments, the buyer can click on an icon 1102 to configure the payment terms.

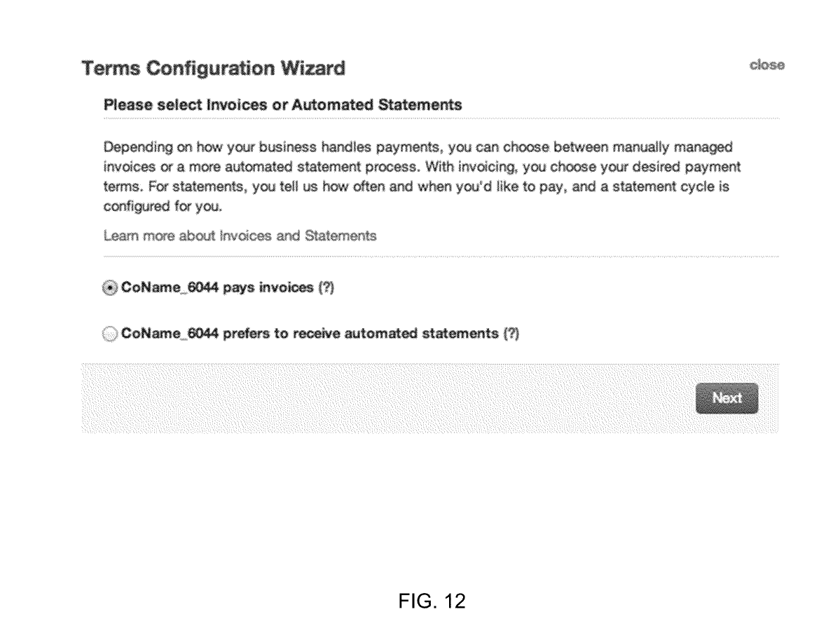

Once the buyer clicks on the icon 1102, the buyer is directed to a terms configuration wizard. FIG. 12 illustrates the payment terms configuration wizard in accordance with some embodiments of the disclosed subject matter. At this stage, the buyer is requested to choose between a plurality of payment options, in this case two options: an invoice option and a statement option. If the buyer opts in for the invoice option, as is done in FIG. 10, the buyer will pay for the completed assignment in a per-assignment basis.

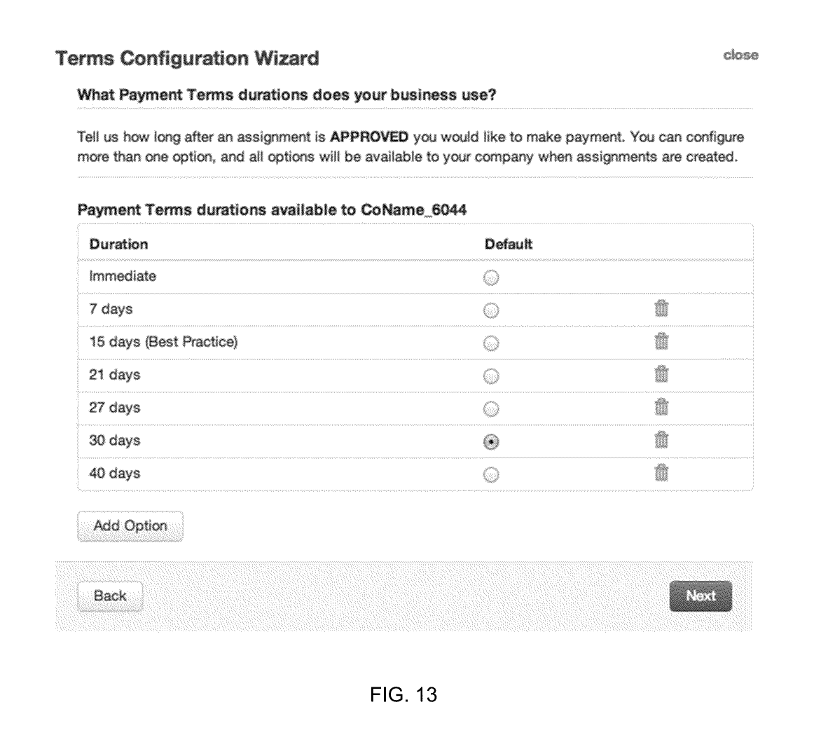

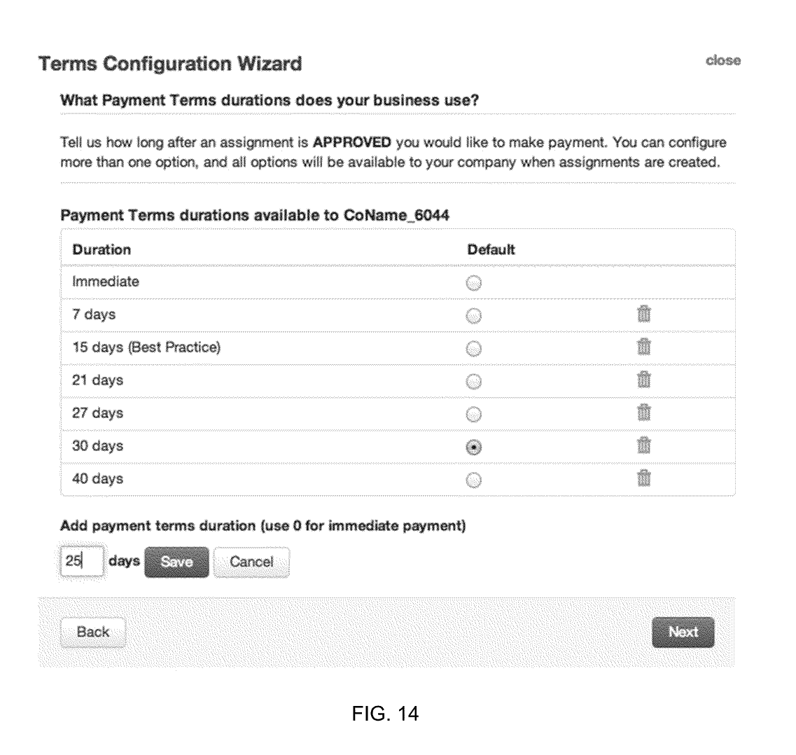

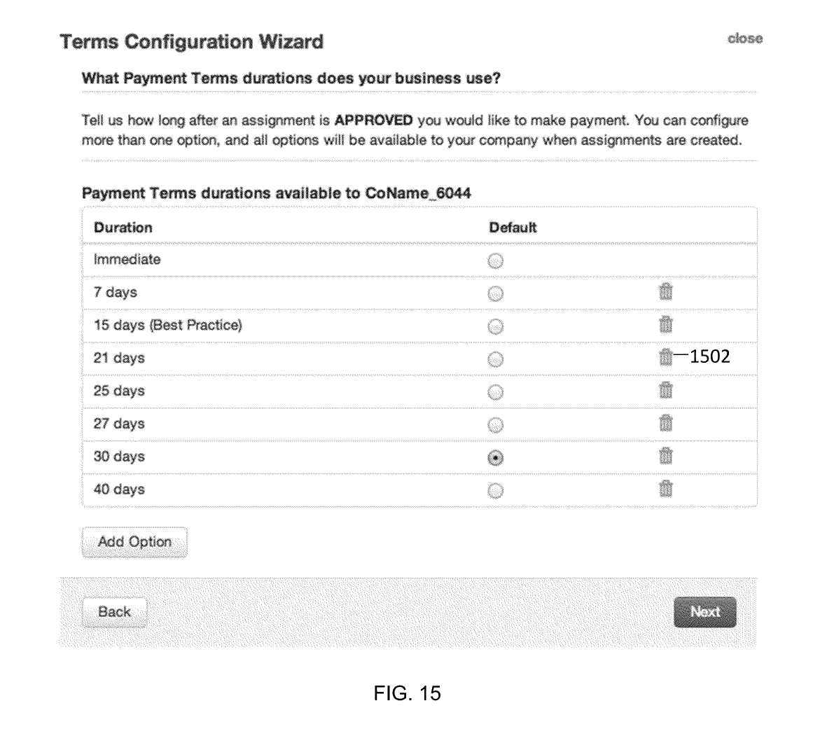

Once the buyer opts in for the invoice option, the buyer is requested to determine the default payment term duration for future assignments, as illustrated in FIG. 13 in accordance with some embodiments of the disclosed subject matter. The payment term duration can indicate how long after the approval of the assignment the buyer is willing to make the payment. If the desired payment term duration option is not available on the list, the buyer can generate a new payment term duration, as illustrated in FIG. 14 in accordance with some embodiments of the disclosed subject matter. In FIG. 14, the buyer adds a 25-day option to the payment term durations, and upon addition, the 25-day option is available as shown in FIG. 15. If the buyer would not use one of the listed payment term durations, the buyer can delete the one of the listed payment term durations by clicking on the associated trash bin. For example, if the buyer would not use the 21-day option, the buyer can click on the trash bin 1502 to remove that option.

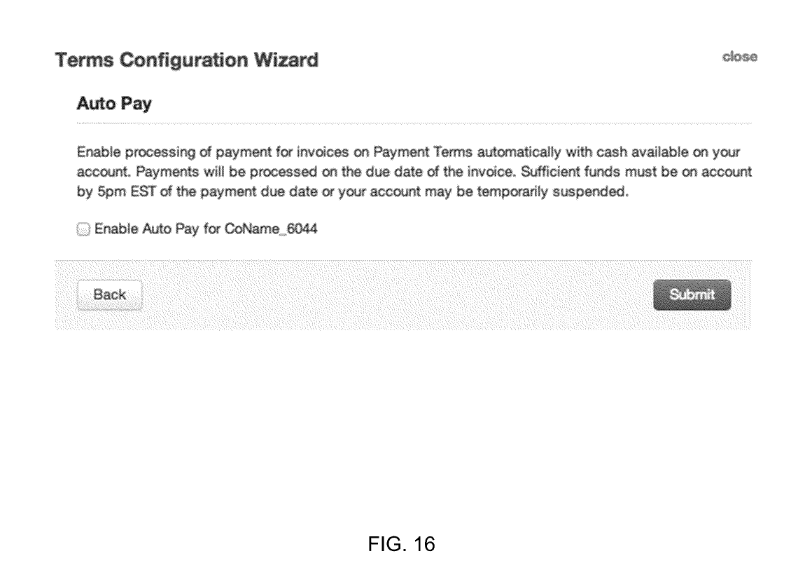

Subsequently, the buyer can enable or disable the auto-pay option, as illustrated in FIG. 16 in accordance with some embodiments of the disclosed subject matter. Even if a buyer opts in for the auto-pay option, the auto-pay option would not be effective until the buyer funds the account at the WM. For example, if $1000 is due on Feb. 1, 2013, then the buyer must fund its account with more than $1000 by 5 PM of Feb. 1, 2013 in order for the auto-pay to be effective for $1000.

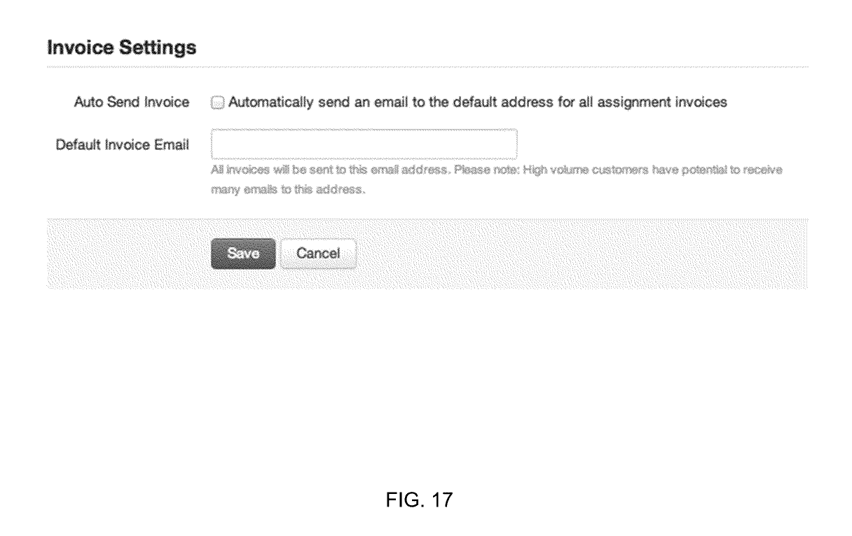

In some embodiments, the buyer can configure the server 202 to send invoices to the buyer automatically. FIG. 17 illustrates an interface for configuring the auto-send of invoices in accordance with some embodiments of the disclosed subject matter. On this interface, the buyer can indicate whether or not the buyer wants to receive invoices automatically, and if so, the email address to which the invoice should be sent.

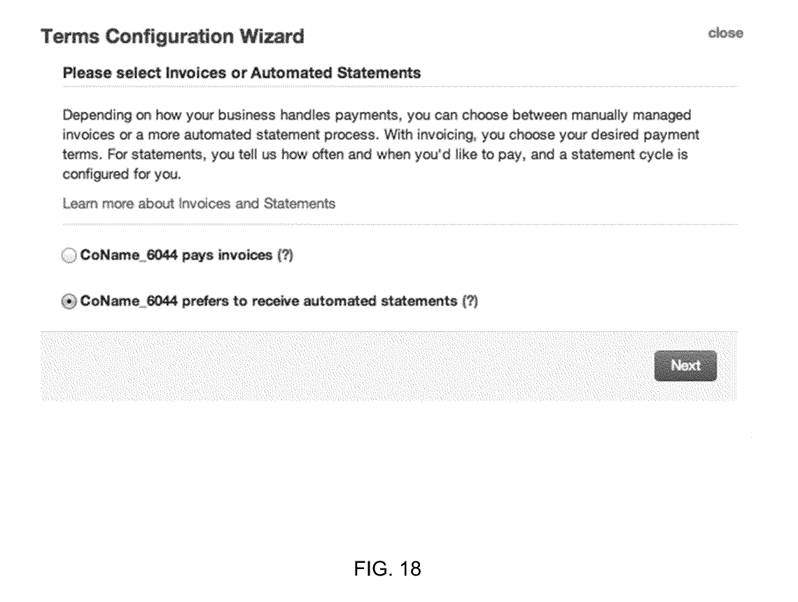

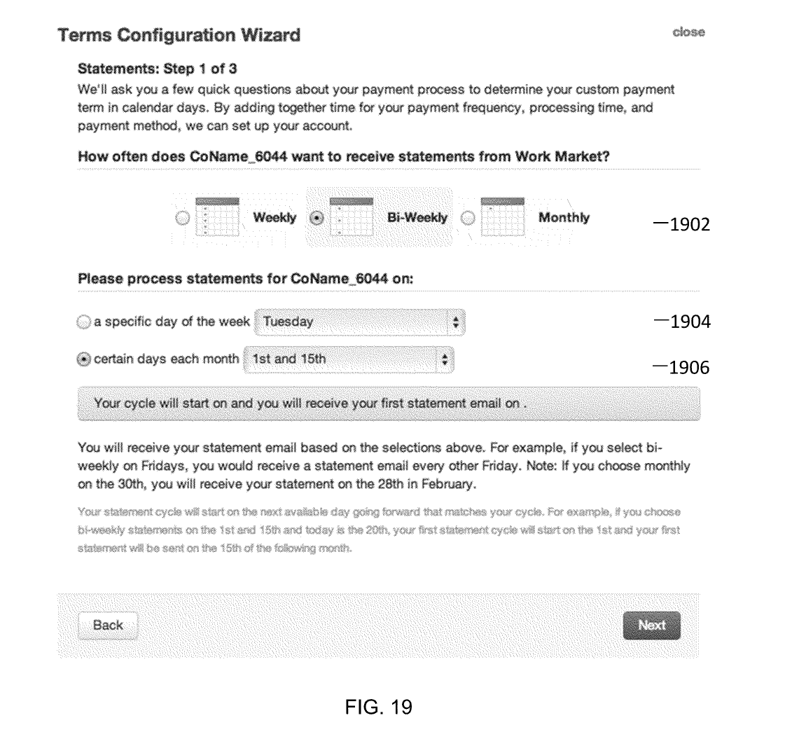

FIG. 18 illustrates the terms configuration wizard of FIG. 12, but in this case, the buyer opts in for the statement option. The buyer can configure the interval in which the server 202 provides statements to the buyer. FIG. 19 illustrates an interface for configuring the interval for the statements in accordance with some embodiments of the disclosed subject matter. In FIG. 19, the buyer is provided with three options 1902: weekly, bi-weekly, and monthly. If the buyer selects the weekly option, the buyer would receive the statement weekly; if the buyer selects the bi-weekly option, the buyer would receive the statement bi-weekly; and if the buyer selects the monthly option, the buyer would receive the statement bi-monthly. In other embodiments, the buyer may be provided any other number of interval options. In some embodiments, the buyer can also select the day of the week 1904 or the date of the month 1906 on which the statements would be processed and provided to the buyer.

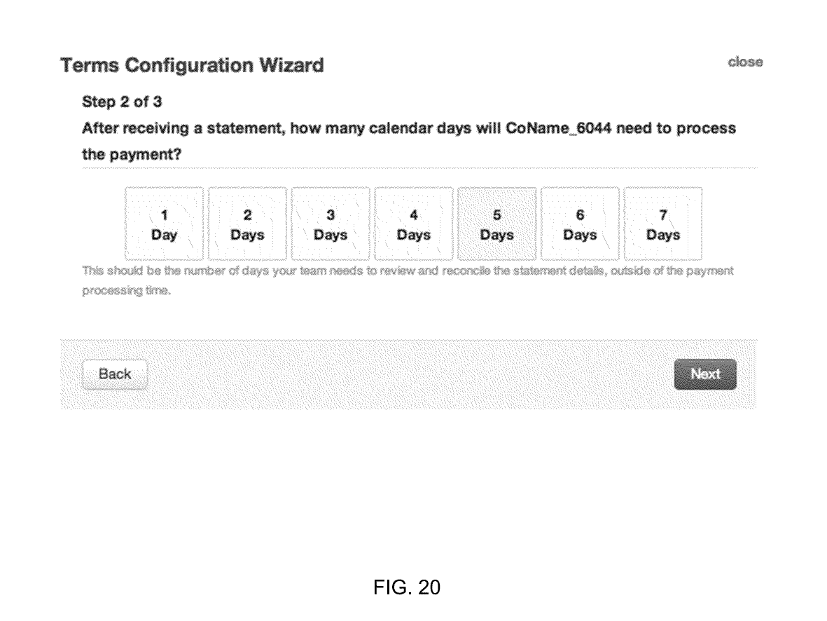

In some embodiments, the buyer can configure the number of days for processing the received statements. FIG. 20 illustrates an interface for configuring the number of days for processing the received statements in accordance with some embodiments of the disclosed subject matter. In this illustration, the buyer opted in for the 5-day processing option. This means that the buyer would take no more than 5 days to process the received statements. In some embodiments, the interface can include a statement that the number of days for processing the received statements should include the number of days the buyer would need in order to review and reconcile the statement details and to process the payment.

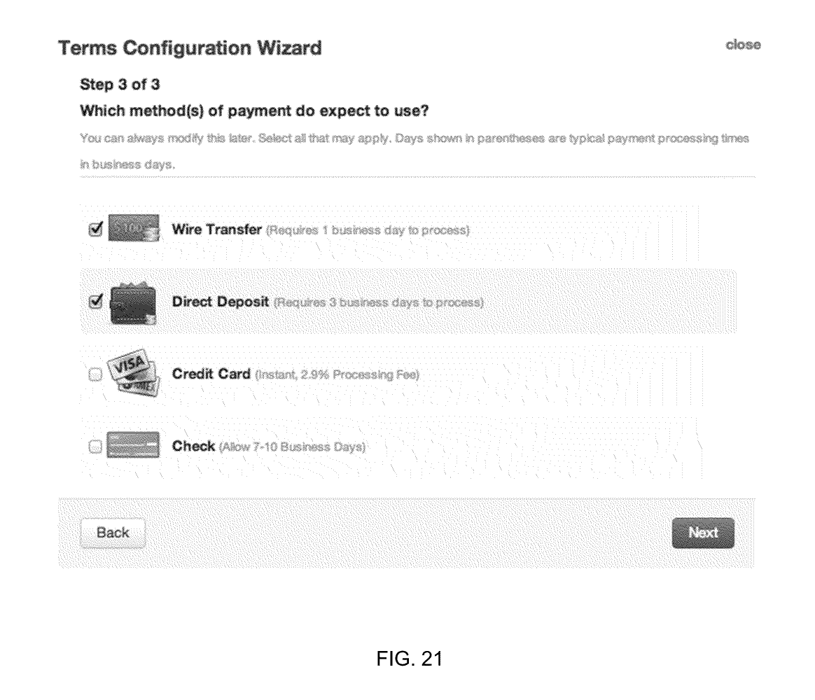

In some embodiments, the buyer can configure the default payment method for paying the received statements. FIG. 21 illustrates an interface for configuring the payment methods in accordance with some embodiments of the disclosed subject matter. The buyer can select more than one methods of payment; in FIG. 21, the buyer selected the wire transfer method and the direct deposit method as the default payment methods. In some embodiments, the payment methods can be modified at a later time.

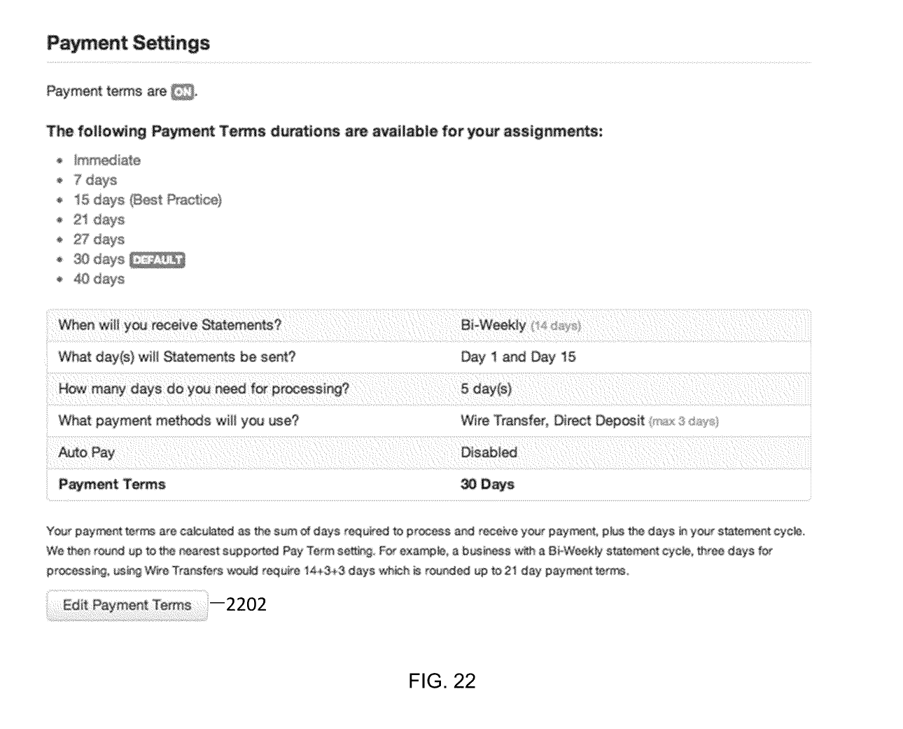

Once the user completes the payment term setup, the user can review the selected payment terms on a review panel. FIG. 22 illustrates a review panel in accordance with some embodiments of the disclosed subject matter. The payment terms can be edited by selecting an icon 2202 for editing the payment terms.

In the WM, a buyer can create assignments and contract with sellers by using facilities. A facility can be considered a “trade credit” from a single or a plurality of sources that can be used to buy seller's contract work. For example, when the server 202 credits the buyer's account with a facility of $1000, the buyer can use the $1000 facility to buy contract work for up to the value of $1000.

The buyer can “buy” facilities by prefunding (i.e., depositing money to) its account with actual money. For example, a buyer can deposit money from the buyer's bank account to the WM, and the deposited money is received at the server 202 using a master client landing account. Electronic identifiers including the buyer's name and account information are received along with the monetary deposit in these master accounts.

In other embodiments, the buyer can register a credit card with the account so that the buyer can pull its credit line to receive facilities. In yet other embodiments, the buyer can receive facilities from the server 202, as a credit extended to the buyer by the server 202. In some cases, the server 202 can provide facilities to the buyer even before receiving any funds for the buyer's account. For example, the server 202 can extend facilities to the buyer based on the buyer's credit terms, as further discussed below. In some embodiments, the server 202 can crowd-source trade credits from existing sellers, consolidate the trade credits, and distribute portions of the trade credits to buyers as facilities. The crowd-sourcing of trade credits is also further discussed below.

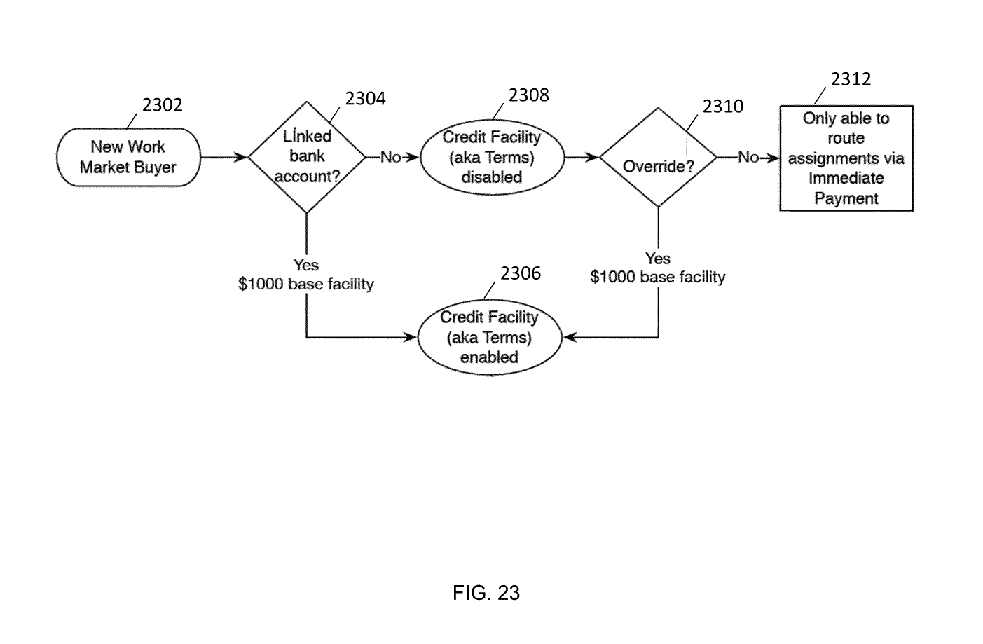

FIG. 23 illustrates a process for crediting a buyer's account with facilities in accordance with some embodiments of the disclosed subject matter. In step 2302, the new buyer can provide its profile information to the server 202. As discussed above, in some cases, the buyer can provide, as a part of the profile information, bank account information that would be used to fund the buyer's account.

In step 2304, the server 202 can determine if the profile information includes the bank account information. If the profile information does include the bank account information, in step 2306, the server 202 can credit the new user's account with a base facility and enable the buyer to generate assignments using the base facility.

In contrast, if the profile information does not include the bank account information, in step 2308, the server 202 can credit the buyer's account with zero facility (i.e., disable the credit facility.)

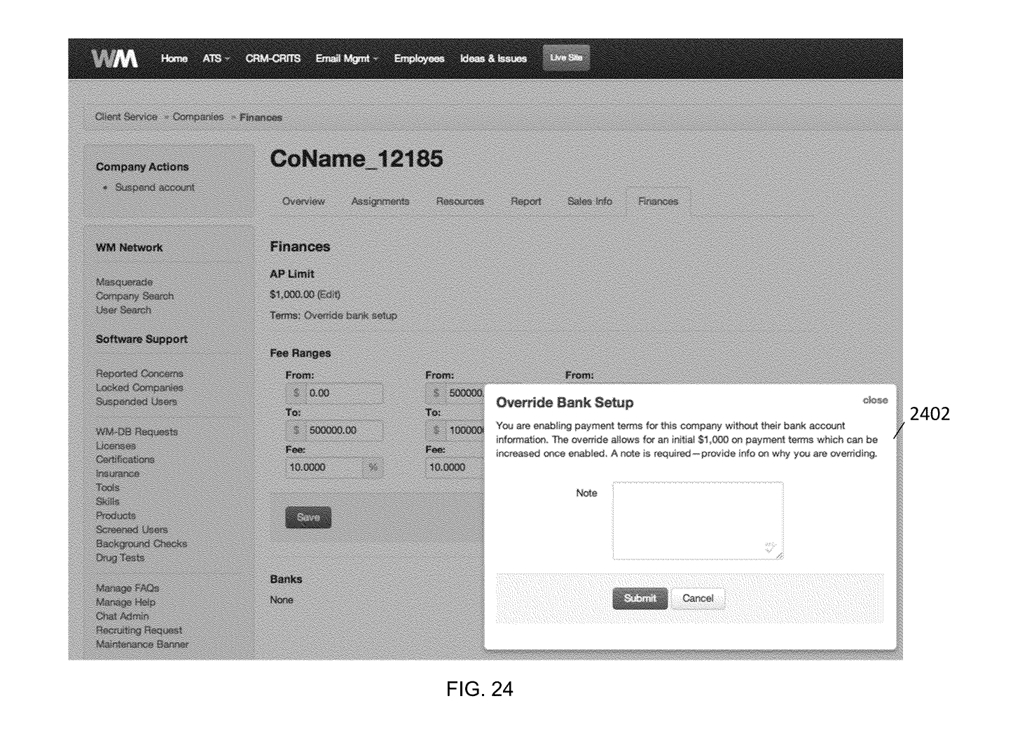

In some cases, in step 2310, the WM operator can manually override the server's bank setup in step 2308 (i.e., zero facility.) For example, the WM operator can manually override the server's bank setup in step 2308 and credit the buyer's account with a base facility despite the lack of bank account information. FIG. 24 illustrates an interface, displayed to the WM operator, for overriding the server's bank setup in accordance with some embodiments of the disclosed subject matter. In some cases, the WM operator may be required to provide reasons for overriding the server's bank setup, as shown by the pane 2402. Such a safety mechanism can reduce the number of instances in which the WM operator erroneously credits the buyer's account with a facility.

In other embodiments, the server 202 can algorithmically decide to override the bank setup in step 2308 and credit the buyer's account with a facility even if the account does not include bank account information. The server 202 can make the decision based on one or more of the following factors: (1) the amount of facility requested by the buyer, (2) a credit rating associated with the buyer, (3) the number of workers employed by the buyer, (4) the reputation of the operating officers employed by the buyer, (5) the number of years in business, and (6) the amount of facilities offered by sellers. The credit rating can include a Dun and Bradstreet (D&B) rating.

If the bank setup in step 2308 is overridden at step 2310, then in step 2306, the server 202 can credit the buyer's account with a base facility. If the bank setup in step 2308 is not overridden at step 2310, then the buyer is required to make immediate payments to the WM for any assignments created by the buyer.

In some embodiments, in step 2306, the server 202 or the WM operator can provide the buyer with more facility than the predetermined base facility. For example, the server 202 can determine the amount of facility to be provided to the buyer based on one or more of the following factors: (1) the amount of facility requested by the buyer, (2) a credit rating associated with the buyer, (3) the number of workers employed by the buyer, (4) the reputation of the operating officers employed by the buyer, (5) the number of years in business, (6) the amount of facilities offered by the sellers. The credit rating can include a Dun and Bradstreet (D&B) rating.

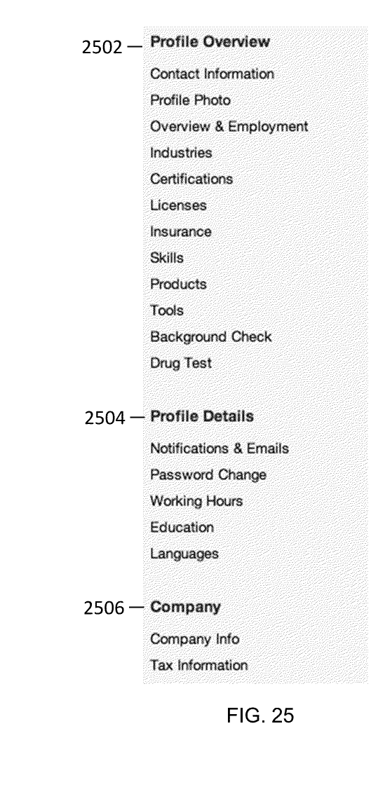

A new seller of the online market place can create an account in order to apply for or accept new assignments at the WM. FIG. 25 illustrates an interface for creating and setting up a seller's account in accordance with some embodiments of the disclosed subject matter. The profile overview pane 2502 can include fields to provide one or more of the following: contact information, a profile photograph, an overview of the seller's experience and employment history, industries associated with the seller, certifications and licenses held by the seller, insurance held by the seller, skill sets held by the seller, products created, sold, or supported by the seller, tools used by the seller, any background check information associated with the seller, and any drug test result. In some embodiments, the server 202 may gather information about the seller and pre-populate the profile information with the gathered information. In some cases, the server 202 may gather information from social networking sites, including LinkedIn and Facebook. In other cases, the server 202 may contact and search corporate databases to gather information. In some embodiments, the server 202 may gather information about the seller in response to a request from the seller; in other embodiments, the server 202 may automatically gather information about the seller.

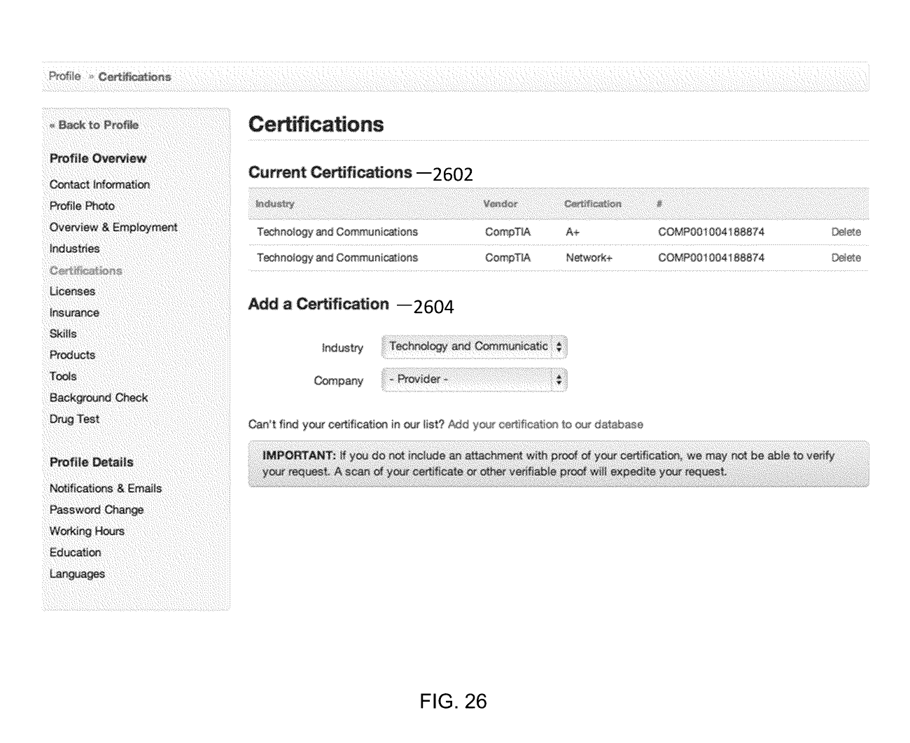

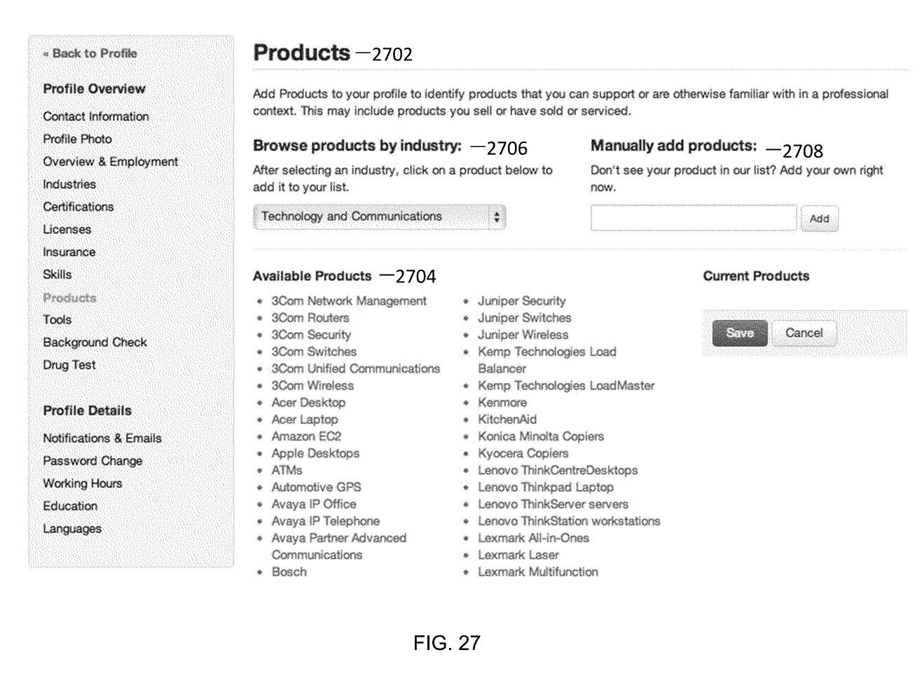

When the seller selects one of the elements on the profile overview pane 2502, the seller may receive an interface for specifying the selected elements. For example, FIG. 26 illustrates an interface for specifying the certifications associated with the seller in accordance with some embodiments of the disclosed subject matter. The current certification pane 2602 lists one or more certifications previously selected by the seller; and the certification addition pane 2604 allows the seller to select a new certification for the seller based on the industry and the company. As another example, FIG. 27 illustrates an interface for identifying products associated with the seller in accordance with some embodiments of the disclosed subject matter. The products pane 2702 can include a list of products 2704 maintained by the Work Market's database. In some cases, the seller can filter the list of products 2704 using a filter 2706. For example, the seller can filter the list based on the industry associated with the products. In some cases, the seller can manually add products to the seller's profile using a product field 2708.

As with the interface for the buyers, the profile details pane 2504 can allow the seller to provide or alter one of more of the following: notification and email settings, password, working hours, academic credentials, and/or list of languages at which the user is proficient. The company pane 2506 can allow the user to provide information about the company with which the user is affiliated, and any tax information associated with the company.

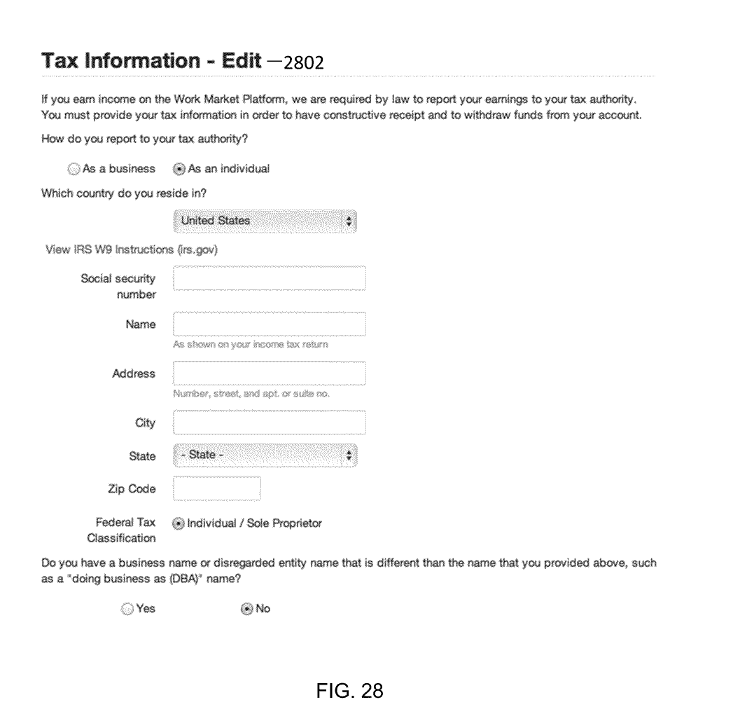

In some embodiments, the seller can also provide tax information to be associated with its Work Market system account. FIG. 28 illustrates an interface for providing tax information associated with a seller in accordance with some embodiments of the disclosed subject matter. The tax information pane 2802 provides a seller an option to report as a business or as an individual. The tax information pane 2802 also provides a seller an option indicate the country in which the seller is resident, and any relevant tax information. In some embodiments, the seller can provide a tax ID number, and information relating to a W9 form.

Once the server 202 has access to the tax information, the server 202 can port the received tax information to other accounting products, financial products, or any other system, for example, via application programming interfaces (APIs.) One example of an accounting and financial product can be a software product QUICKBOOKS, sold by Intuit, Inc. Those skilled in the art can appreciate that export or download of data—and in fact any communication of data disclosed herein either implicitly or impliedly—may be done in any desired format (such as .csv, or comma delimited) and/or via any API and/or any other method for communicating information by way of computers and networks and between software such as stand-alone software and web applications.

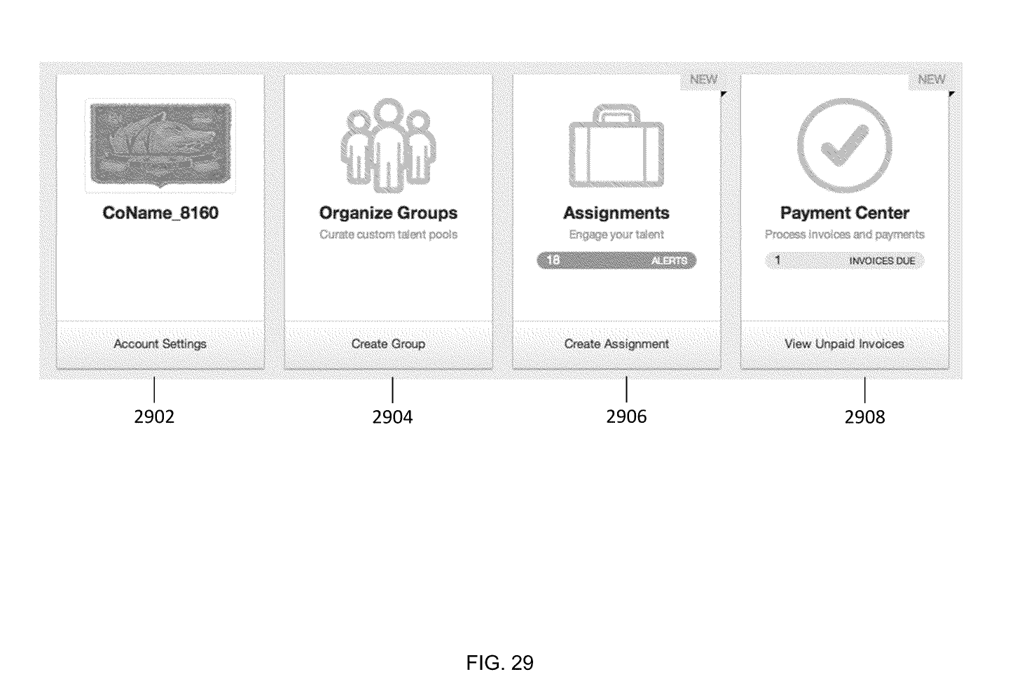

Once their accounts are set up, buyers and sellers can access the online market place using their account. FIG. 29 illustrates a home dashboard for buyers in accordance with some embodiments of the disclosed subject matter. The home dashboard can include one or more of an account settings box 2902, a group creation box 2904, an assignment management box 2906, and a payment center box 2908. A buyer can select one of the boxes to start the process associated with the selected box. The account settings box 2902 can allow a buyer to manage and modify account settings previously specified during the account setup; the group creation box 2904 can allow a buyer to create groups of professionals that the buyer is interested in working with; the assignment management box 2906 can allow a buyer to manage and create assignments; and the payment center 2908 can allow a buyer to process invoices and payments associated with assignments created by the buyer.

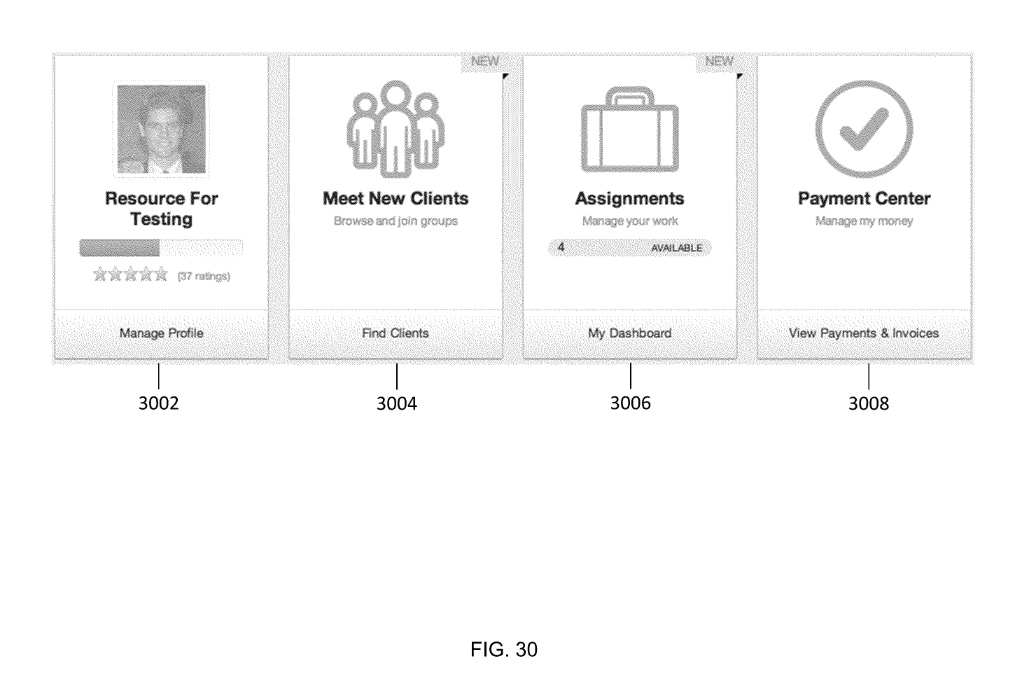

FIG. 30 illustrates a home dashboard for sellers in accordance with some embodiments of the disclosed subject matter. The home dashboard can include one or more of a profile management box 3002, a buyer management box 3004, an assignment management box 3006, and a payment center box 3008. The profile management box 3002 can allow a seller to manage and modify its profile previously specified during the account setup; the buyer management box 3004 can allow a seller to manage a list of buyers with whom the seller has worked; the assignment management box 3006 can allow a seller to manage and accept assignments; and the payment center box 3008 can allow a seller to process invoices and payments associated with assignments.

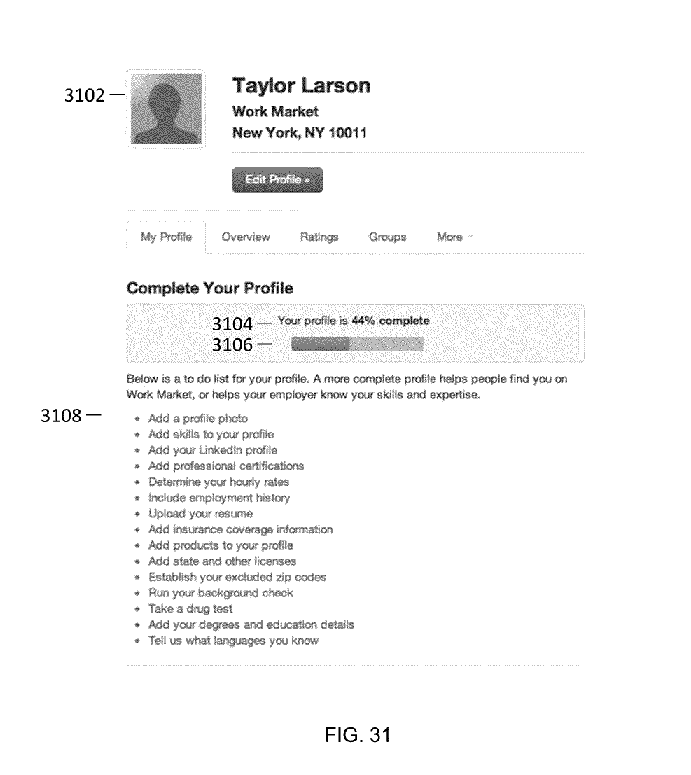

In some embodiments, a user can view its profile on the WM. FIG. 31 illustrates an interface for viewing the profile in accordance with some embodiments of the disclosed subject matter. The profile can include an introduction pane 3102 for general information and a photograph, and the profile can also include the status pane 3104 showing the status of the user.

In some embodiments, if the user's profile is not complete, the profile can indicate the progress of a user's profile setup. In some cases, the progress of the profile setup can be illustrated as a number 3104. In other cases, the progress of the profile setup can be illustrated as a bar 3106. The profile can also identify missing information 3108. For example, the profile can indicate that the user has not provided a profile photo, qualifications, resume, or list of licenses.

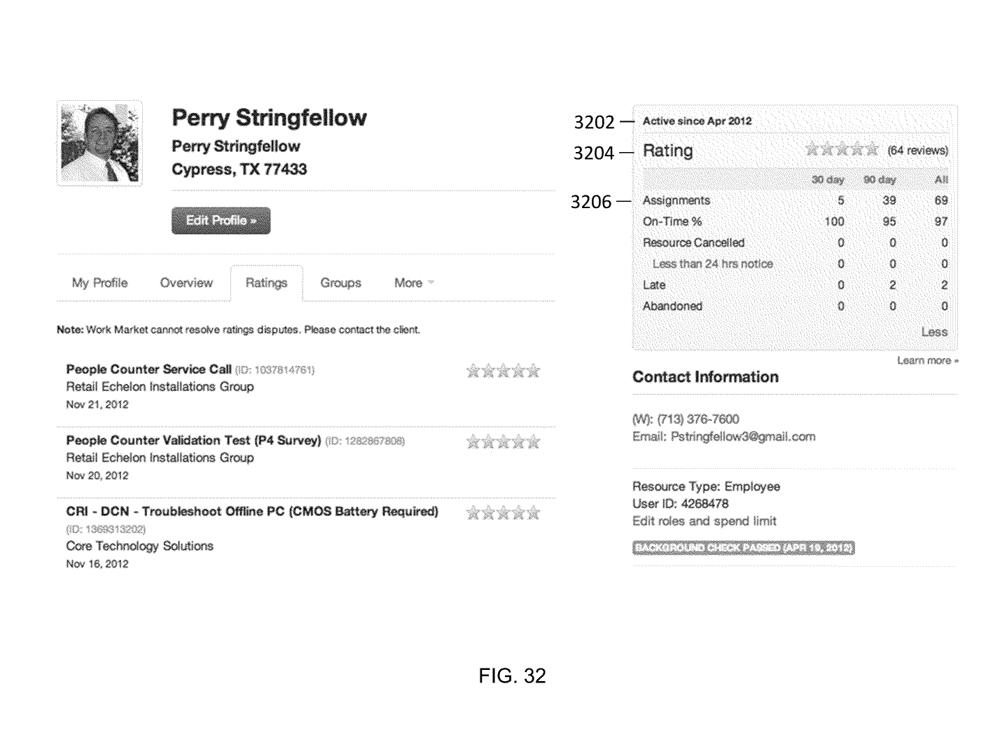

In some embodiments, the profile page can include a status pane 3202. FIG. 32 illustrates a profile page with a status pane in accordance with some embodiments of the disclosed subject matter. The status pane 3202 can include an average rating 3204 of the user and the assignment status 3206 of the user. The assignment status 3206 can indicate the number assignments completed by the user over a particular period of time. The assignment status 3206 can also indicate the percentage of times in which the user delivered the work product on time.

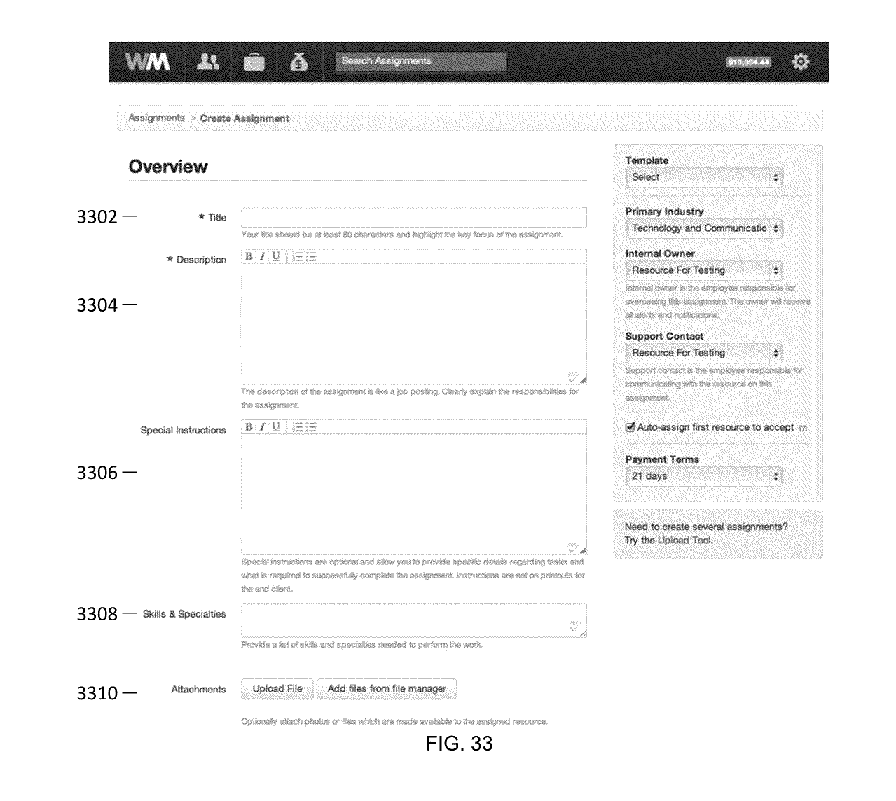

Once the buyer's account is set up, a buyer can create an assignment. FIG. 33 illustrates an interface for creating an assignment in accordance with some embodiments of the disclosed subject matter. In some cases, the WM can treat an assignment as a job posting. In other cases, the WM can treat an assignment as a message from a buyer to one or more sellers. The assignment can include a title 3302, a description of the task 3304, any special instructions 3306, any desirable skills and specialties possessed by the seller 3308, and any attachments associated with the task or the assignment 3310.

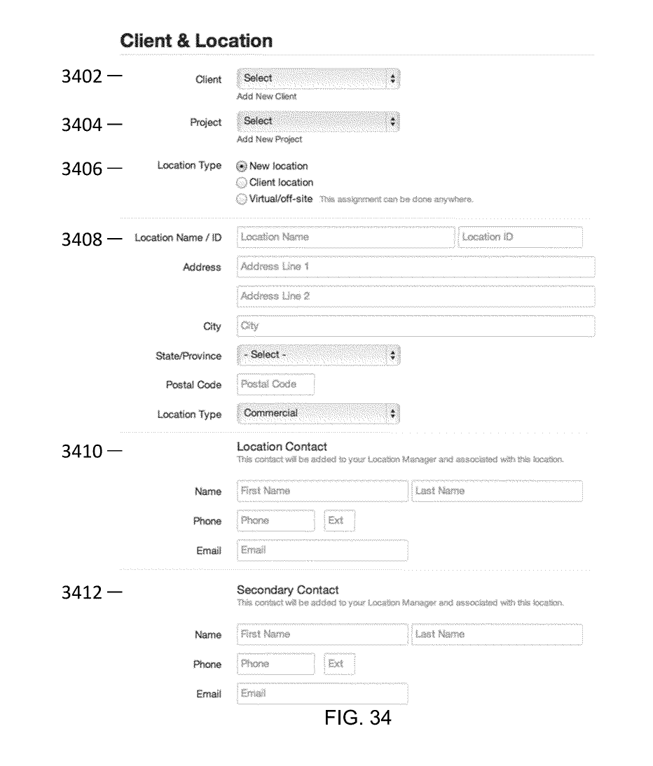

In some embodiments, the buyer can also identify the client or company name and the project associated with the assignment. FIG. 34 illustrates an interface for identifying the client and the project for the assignment in accordance with some embodiments of the disclosed subject matter. The buyer can use the interface to identify the name of the client 3402, the name of the project 3404, the location type 3406, the physical address of the location 3408, the primary contact person for the location 3410, and/or the secondary contact person for the location 3412. In some cases, a project can include a single task; in other cases, a project can include a plurality of tasks. The location type can indicate whether the location is a new location, a client location, or virtual.

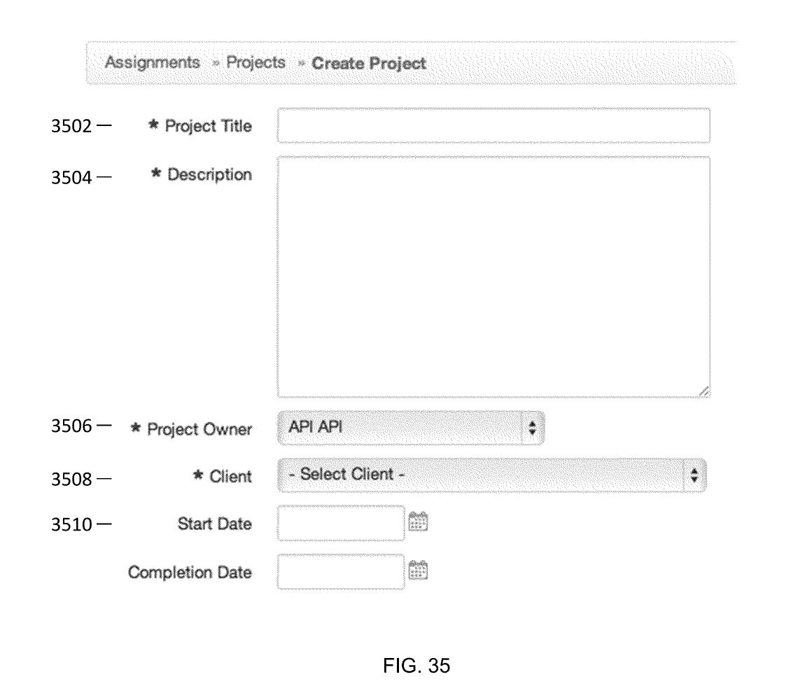

In some embodiments, the buyer can create a project for an assignment. In some cases, a project can include a single task; in other cases, a project can include a plurality of tasks. FIG. 35 illustrates an interface for creating a project for an assignment in accordance with certain embodiments of the disclosed subject matter. The interface can include fields for specifying the project title 3502, the description of the project 3504, the project owner 3506, the client for the project 3508, and the start/completion dates 3510.

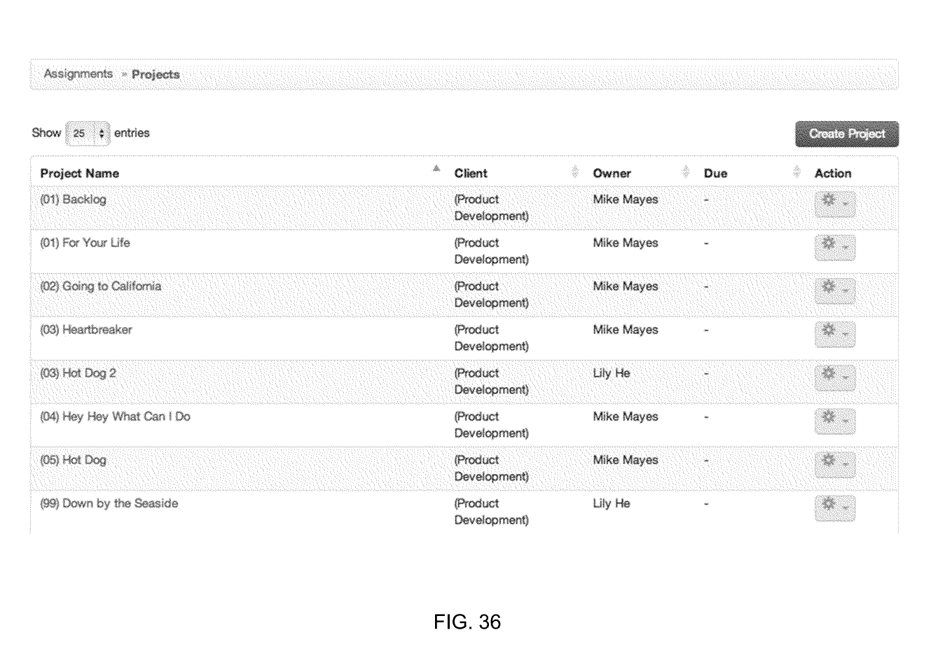

In some embodiments, the buyer can manage the list of projects associated with an assignment using a project table. FIG. 36 illustrates a project table for maintaining the list of projects associated with an assignment in accordance with some embodiments of the disclosed subject matter.

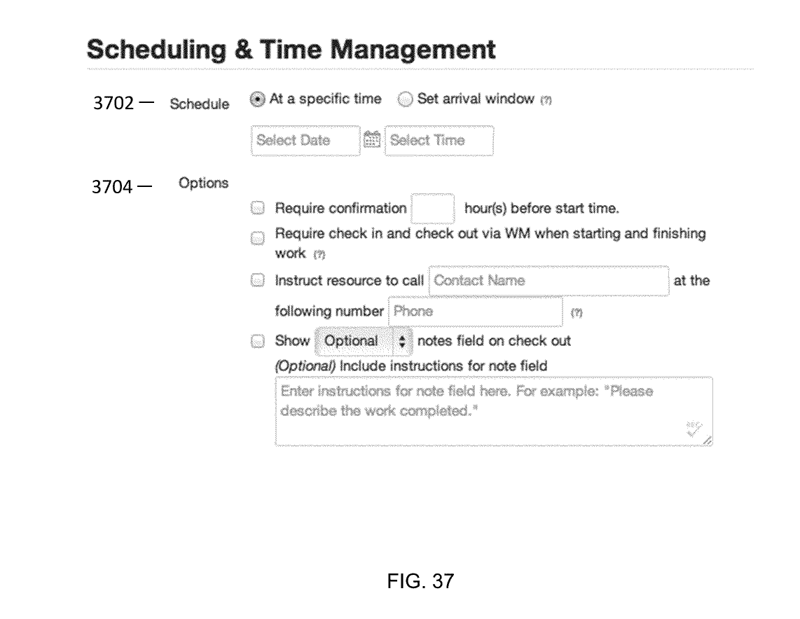

In some embodiments, the buyer can specify the schedule for the assignment. FIG. 37 illustrates an interface for specifying the schedule for the assignment in accordance with some embodiments of the disclosed subject matter. For example, the buyer can use the schedule pane 3702 to indicate whether the task should be performed at a specific time or between a time window, and what the specific time or the time window is. The buyer can also use the options pane 3704 to optionally specify that the seller is required (1) to confirm several hours before the start time, (2) to check in and check out via the WM when starting and finishing the work, (3) to instruct the seller to call a personnel at a phone number, and/or (4) to perform certain tasks identified in the note field.

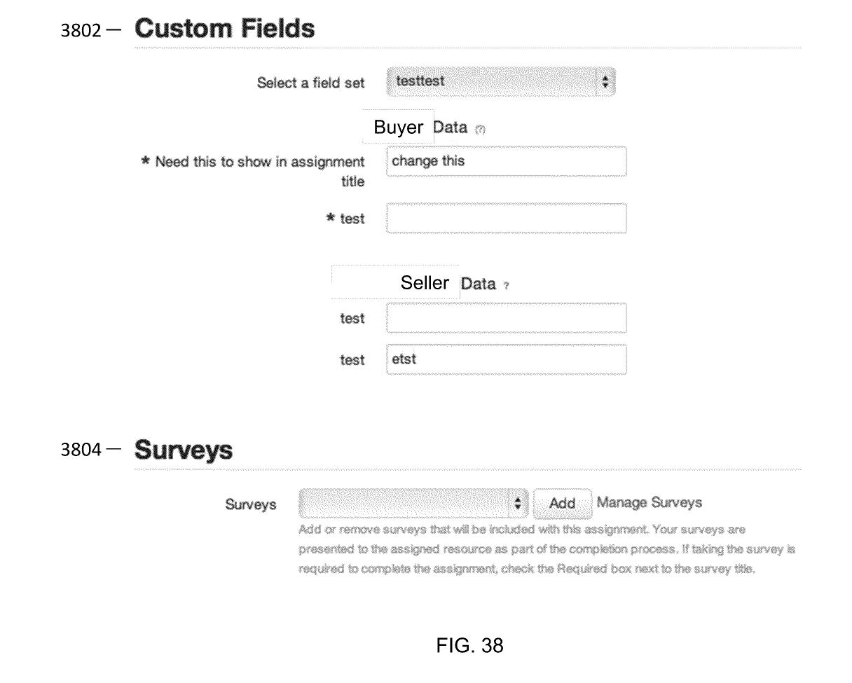

In some embodiments, the buyer can specify the custom fields and surveys for the assignment. FIG. 38 illustrates a custom fields pane and a surveys pane for specifying the custom fields and surveys in accordance with certain embodiments of the disclosed subject matter. Custom fields refer to customized fields to be displayed on an assignment interface to sellers. The custom fields pane 3802 provides mechanisms for specifying custom fields for a particular assignment. In some cases, the custom fields pane 3802 can allow a buyer to specify a customized field set, including a plurality of custom fields, for the assignment. The surveys pane 3804 includes fields for specifying the surveys to be provided to sellers working on the assignment. In some embodiments, the buyer can require the seller to complete the surveys before completing the assignment.

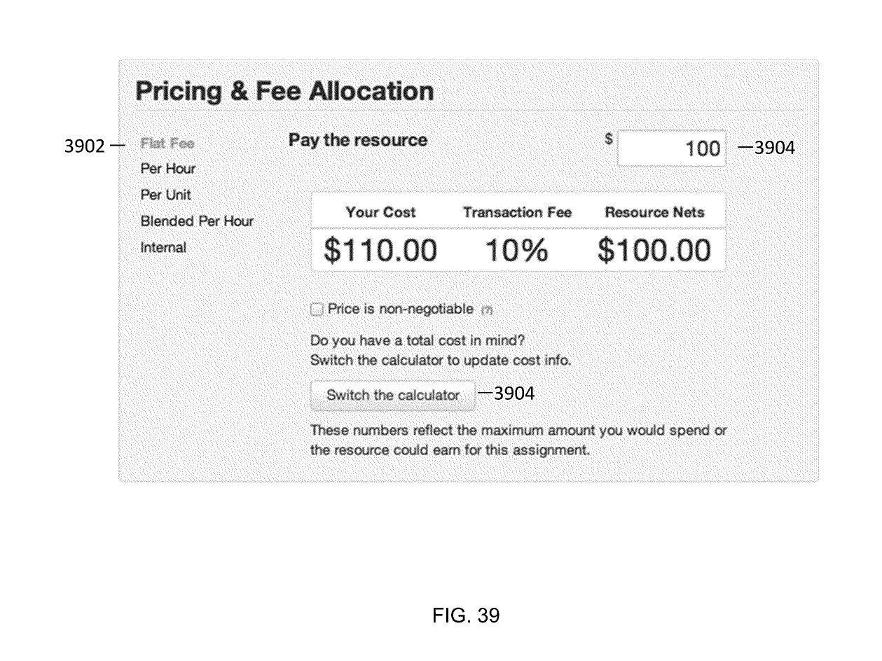

In some embodiments, the buyer can specify the fee for the assignment. FIG. 39 illustrates an interface for specifying the fee for the assignment in accordance with some embodiments of the disclosed subject matter. The fee can be specified based on one or more fee structures available on the fee pane 3902. In some embodiments, the available fee structure can include a flat fee structure, a billing-per-hour structure, a billing-per-unit structure, a blended-per-hour structure, and an internal structure. For example, if the buyer opts in for a flat fee, the buyer would pay the seller a fixed fee upon the completion of the assignment. The blended-per-hour structure allows a buyer to provide additional incentives to quickly finish the assignment. For example, the blended-per-hour structure can specify that the seller would receive $200 if the seller completes the assignment within an hour, but only $100 if the seller completes the assignment in more than an hour. The internal structure can indicate that the seller would not receive any payment for completing the assignment because of seller's obligations owed to the buyer. For example, the seller may be engaged in a contractual relationship or an employment relationship with the buyer, which may indicate that the seller is paid on a payroll and not on an assignment by assignment basis.

In some embodiments, the server 202 can collect transaction fees for providing the online market system for contract work. For example, when the server 202 receives a payment for the assignment from the buyer, the server 202 can keep a predetermined amount from the received payment as a transaction fee and provide only the remaining amount to the seller. In some aspects, the transaction fee can be a flat fee. In other aspects, the transaction fee can be a fixed percentage of the fee for completed assignments.

In some embodiments, under the flat fee structure, the buyer may pay the WM a transaction fee for the assignment. Therefore, under the flat fee structure, the total fee charged to the buyer for an assignment would be the sum of the fixed fee for the assignment and the transaction fee. In some embodiments, the transaction fee can be fixed; in other embodiments, the transaction fee can be a fixed percentage of the fee paid to the seller for the assignment. Therefore, keeping track of the total cost incurred to the buyer can be cumbersome.

To address these issues, the server 202 can provide a pricing calculator to determine the total cost to be charged to the buyer for an assignment. In FIG. 39, the buyer can indicate, in the field 3904, that the buyer would pay the seller a fixed fee for the assignment, in this case $100. The pricing calculator would subsequently add a transaction fee to the fixed fee, which in this case is 10% of the fixed fee, to compute the total cost to the buyer, which is $110. When the seller views the assignment, the seller would only see the fixed fee (i.e., $100) not the total cost incurred to the buyer.

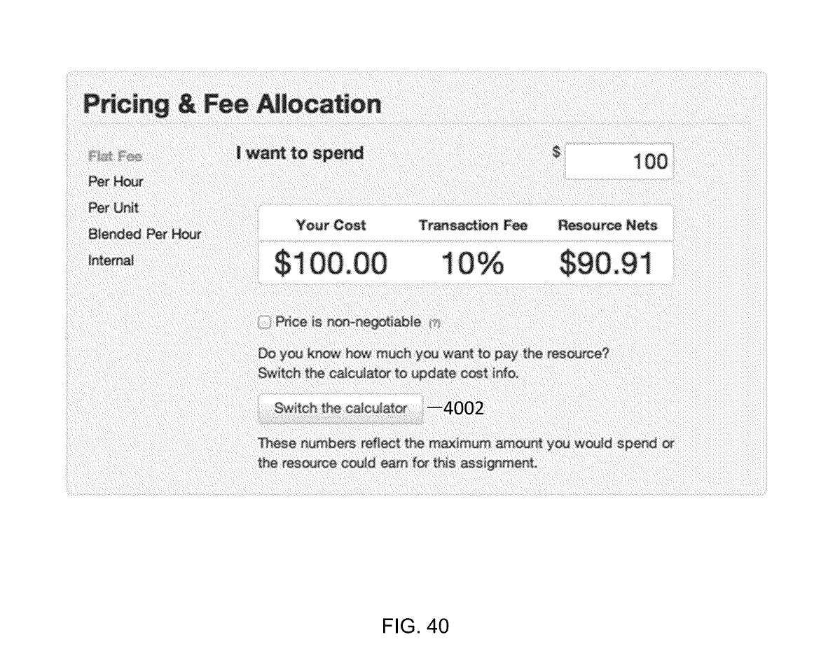

FIG. 40 illustrates another pricing calculator in accordance with some embodiments of the disclosed subject matter. In FIG. 40, the buyer can specify the total cost that the buyer is willing to incur for the assignment. The pricing calculator would subsequently subtract a transaction fee from the specified total cost, which in this case is a 10% of the fixed fee to be paid to the seller, to compute the fixed fee to be paid to the seller, which in this case is $90.91. Using this pricing calculator, the buyer can easily determine or limit the total cost for the assignment without separately computing the transaction fee, which can simplify the cost management. Also, when the seller views the assignment, the seller would only see the fixed fee to be paid to the seller (i.e., $90.91) not the total cost incurred to the buyer. Therefore, the seller need not be aware of the transaction fee charged by the WM.

In some embodiments, the buyer can switch between the pricing calculators. For example, when the buyer clicks on the icon 3904 in FIG. 39, the interface would provide the pricing calculator illustrated in FIG. 40; when the buyer clicks on the icon 4002 in FIG. 40, the interface would provide the pricing calculator illustrated in FIG. 39.

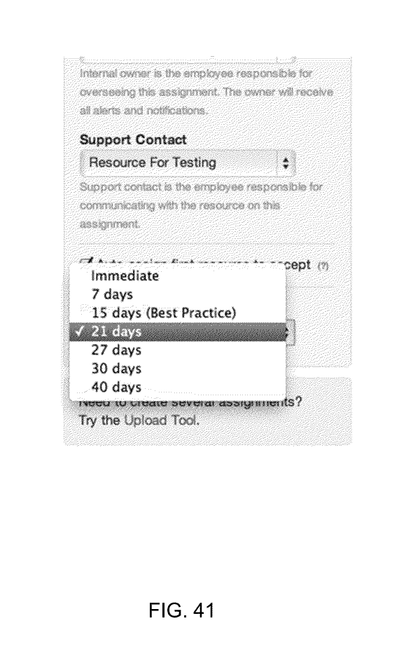

In some embodiments, if the buyer opted in for the invoice option for the payment, the buyer can select the payment term duration for this assignment. FIG. 41 illustrates an interface for modifying the payment term duration for an assignment in accordance with some embodiments of the disclosed subject matter. The buyer can select one of the payment term duration options that were created during the account setup, as discussed in FIGS. 13-15. In some embodiments, if the buyer does not select any payment term duration for the assignment, the payment term duration for this assignment defaults to the default payment term duration that was selected during the account setup.

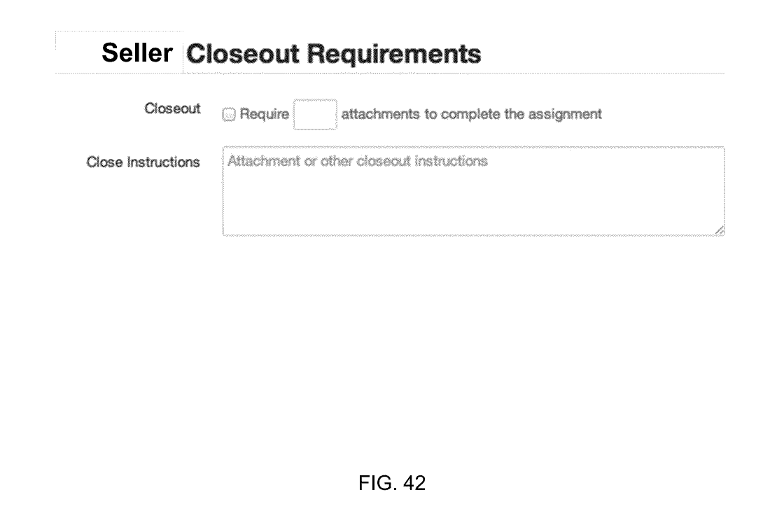

In some embodiments, a buyer can provide instructions for closing an assignment. FIG. 42 illustrates an interface for specifying the closing instructions in accordance with certain embodiments of the disclosed subject matter. In some cases, the buyer can require the seller to provide a certain number of attachments to close the assignment. In other cases, the buyer can provide certain instructions to be followed in order to close the assignment.

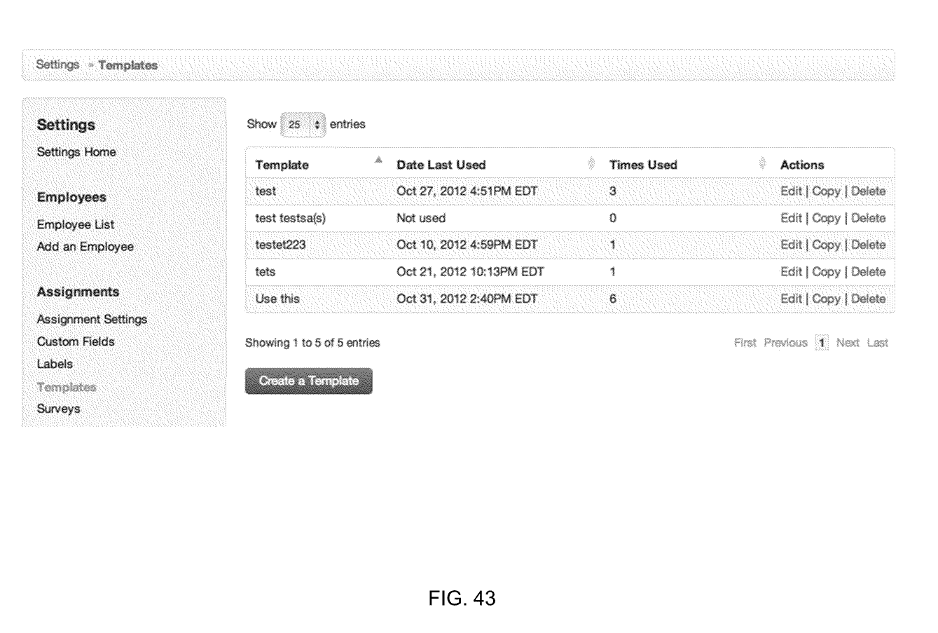

In some embodiments, a buyer can use a template to create an assignment. FIG. 43 illustrates an interface for managing assignment templates in accordance with some embodiments of the disclosed subject matter. The interface includes a template listing. Each template can be listed by its associated fields, including a name, the last-used date, the number of times used, and/or possible actions on the template. The list can also be sorted by the associated fields. The buyer can select one of the templates to quickly create an assignment.

In some embodiments, once a buyer creates an assignment, the buyer can distribute the assignment to sellers, requesting the sellers to accept the assignment and complete the assignment. In some cases, the buyer can distribute the assignments only up to a fixed number of sellers, for example, up to 100 sellers. Once the created assignment is distributed to the sellers, the amount of facility available to the buyer is reduced by the total cost associated with the assignment.

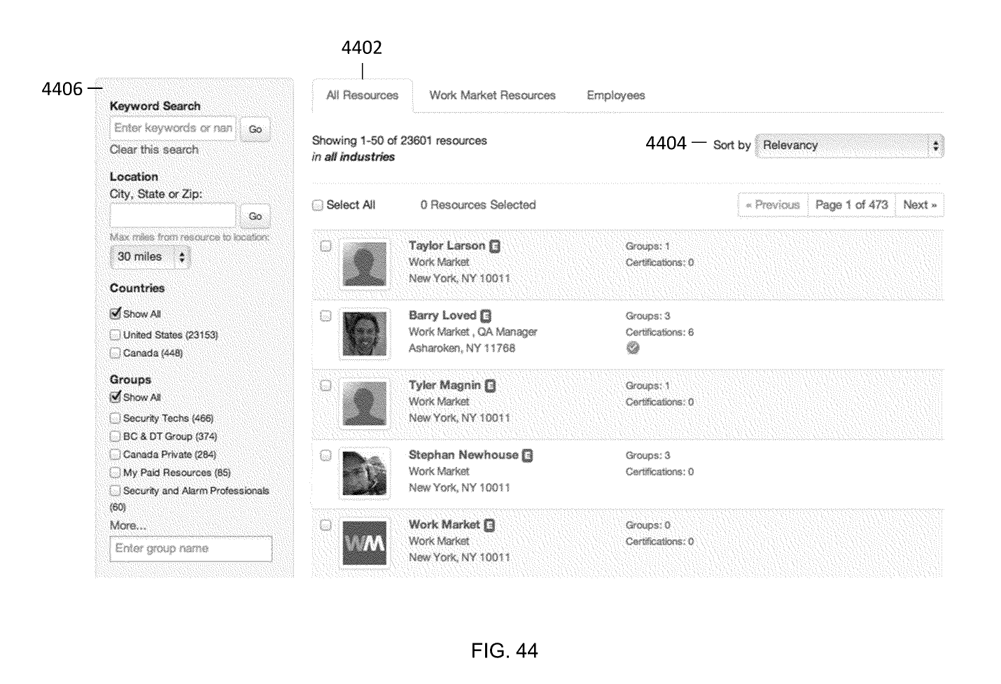

In some embodiments, the buyer can select the target sellers from a list of sellers. FIG. 44 illustrates an interface for selecting target sellers in accordance with some embodiments of the disclosed subject matter. The interface can include a listing pane 4402 that lists the sellers. The listed sellers can be sorted according to a sorting preference 4404 that can be configured by the buyer.

In some embodiments, the buyer can select the target sellers by filtering the list of sellers. The filter pane 4406 allows the buyer to specify the parameters for the filter. The parameters for the filter can include one or more of the following: (1) the location of the seller, (2) the group with which the seller is affiliated, (3) skills, (4) credentials or qualifications, (5) age, (6) licenses, (7) ratings, (8) the frequency at which the seller's work was declined by buyers, and (9) cost of services or work product.

In some embodiments, a rating associated with a seller can include a Seller Quality Metric (SQM) score. The SQM score can offer one simple aggregated value for comparison among sellers in the marketplace. In some cases, the SQM score of a seller can take into account many aspects of the seller's performance and behavior on the Work Market system.

In some embodiments, the SQM score of a seller can be computed based on one or more of the following factors: (1) total number of completed assignments, (2) total number of completed assignments for a particular buyer, (3) total number of completed assignments for a particular industry, (4) average rating of assignments completed by the seller, (5) percentage of assignments in which the seller delivered the work product later than a promised date, (6) percentage of assignments in which the seller cancelled within a predetermined amount of time from the deadline (e.g., the seller cancelled within 24 hours from the deadline), (7) percentage of assignments in which the seller abandoned the assignment, (8) percentage of assignments in which the seller delivered the work product on time, (9) average amount of time to complete an assignment for a particular buyer, (10) completeness of the seller's profile, (11) the status of seller's background check and drug screening, and (12) number of buyers from which the seller is blocked.

In some embodiments, the SQM score can be computed dynamically. In particular, the SQM score can be computed as a weighted average of scores associated with one or more factors. In some cases, the weights for computing the weighted average can be determined dynamically. For example, a weight for a particular factor can be determined based on the amount of score variations associated with the factor across all sellers. In some aspects, the weight for a particular factor can be a normalization factor. The normalization factor can be determined as an inverse of a standard deviation of scores associated with the factor across all sellers.

The SQM score can be used in various embodiments. In some embodiments, as discussed above, the SQM score can be used by a buyer to identify a seller that has relevant skills and is of high-quality. In some embodiments, the SQM score can also be used by external systems, e.g., systems outside of the Work Market system, to provide information about a seller. For example, the external system can provide a profile of a seller, and the profile can include the SQM score to indicate the quality of the seller.

In some embodiments, a buyer can manage sellers in groups and send an assignment to sellers associated with particular groups. Each group can be associated with sellers having certain characteristics. For example, a group can include sellers having a license to practice law in New York.

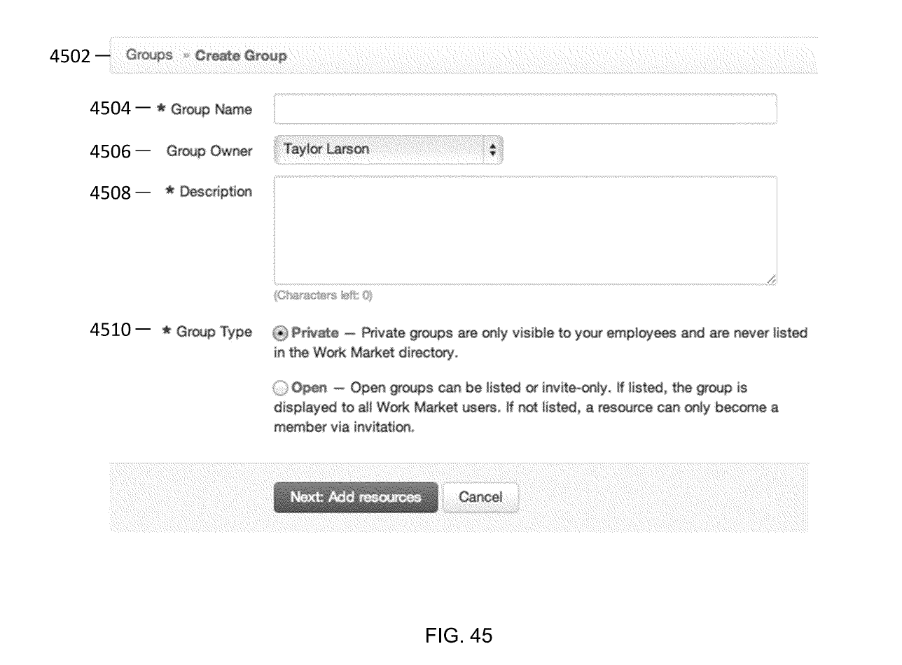

In some embodiments, a buyer can create groups for sellers. FIG. 45 shows an interface for creating a group of sellers in accordance with some embodiments of the disclosed subject matter. A buyer can create a group of sellers using a group pane 4502. The group pane 4502 can include a field for providing a group name 4504, a group owner 4506, a description of the group 4508, and a privacy setting 4510 for the group. The buyer can create a group based on one or more of the following factors: (1) the location of the seller, (2) skills, (3) credentials or qualifications, (4) age, (5) licenses, (6) ratings, (7) the % of times in which the seller's work was declined by other buyers, (8) prior interactions with the buyer, and (9) cost of buyer's services or work product.

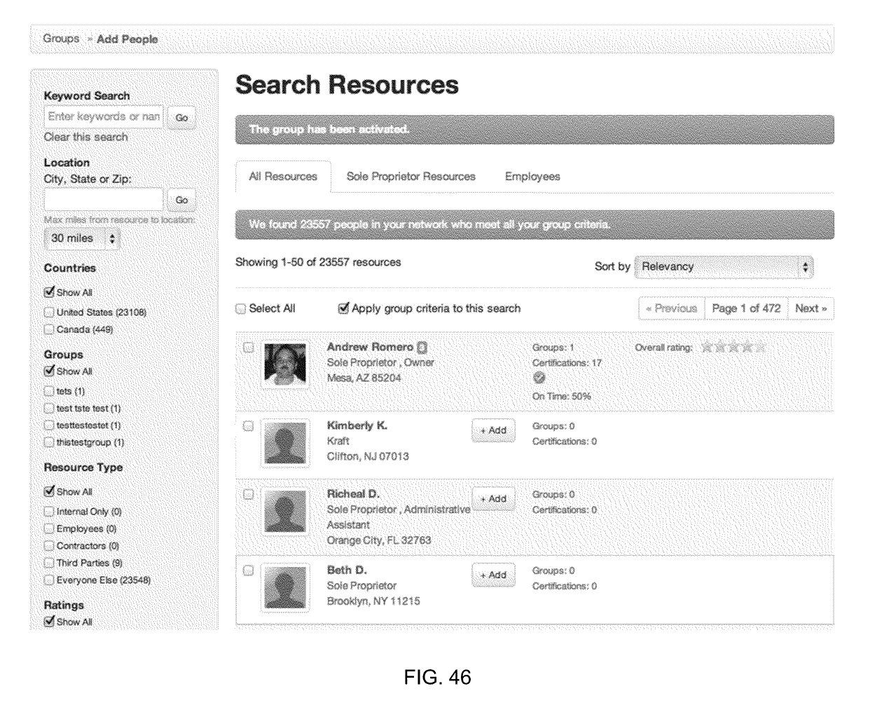

In some embodiments, a buyer can request sellers to join the created group. FIG. 46 illustrates an interface for sending invitations to join a group in accordance with some embodiments of the disclosed subject matter. If the group is associated with certain characteristics, the interface can filter the list of sellers so that the list shows only the sellers that satisfy the characteristics associated with the group. This way, the user can quickly select sellers satisfying the characteristics associated with the group and send invitations only to those sellers.

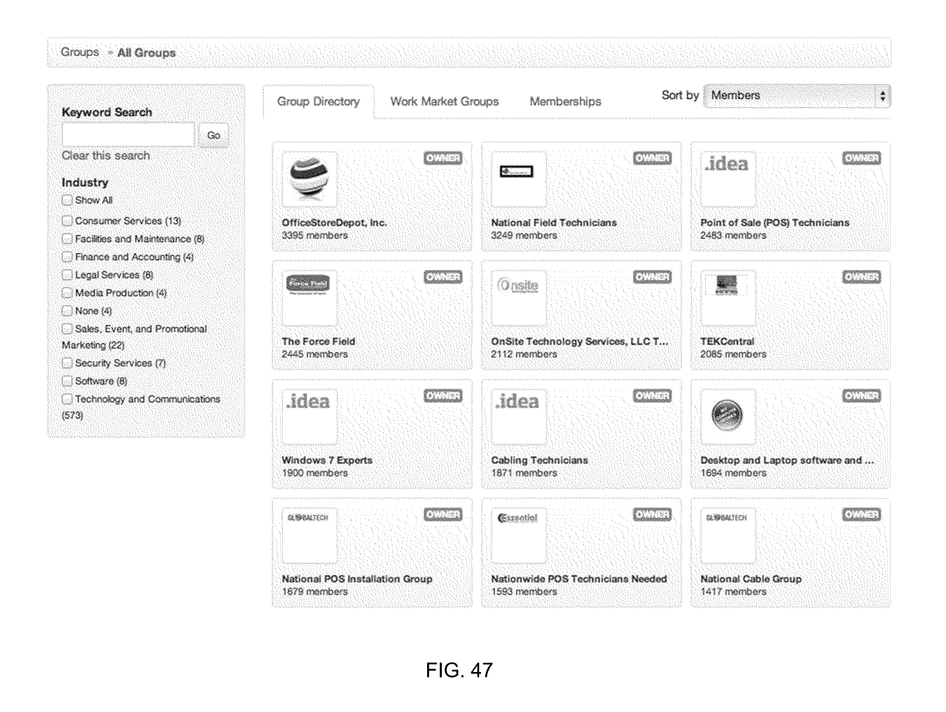

In some embodiments, a buyer can use one or more groups created by other users. FIG. 47 illustrates an interface listing groups of sellers available for the user in accordance with some embodiments of the disclosed subject matter.

In some embodiments, a seller can also create groups. For example, a seller may use an interface substantially similar to the interface illustrated in FIG. 45 to create a group and use an interface substantially similar to the interface illustrated in FIG. 46 to invite sellers to the group.

In some embodiments, the user can request potential sellers to complete a test relating to the assignment before accepting the assignment. Once sellers complete the test, the user can review the test results to determine which of the sellers to hire. In some cases, the test results can be used as a basis to bar some sellers from accepting the assignment.

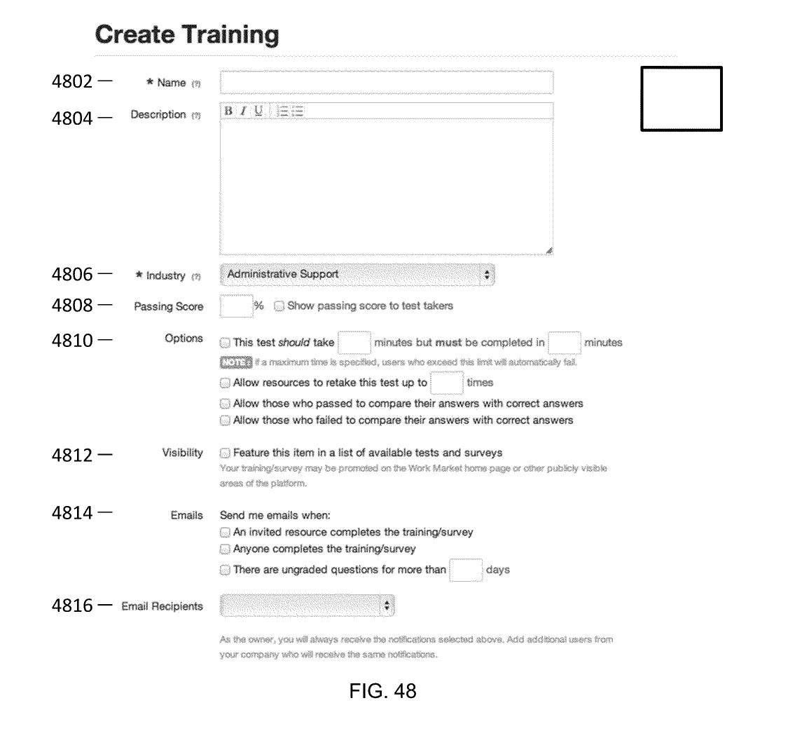

FIG. 48 illustrates an interface for creating a test in accordance with some embodiments of the disclosed subject matter. In some cases, the test can be referred to as training. The interface can include a field for specifying the name of the test 4802, a description of the test 4804, and an industry relevant for the test 4806. In some cases, the user can identify the passing score 4808 for the test. If the passing score 4808 is specified, any sellers failing to receive the passing score 4808 would not be eligible to accept the assignment or become a member of a group.

In some embodiments, the user can specify optional information about the test using the options field 4810. For example, the user can indicate how much time a seller should spend on taking the test, how many times a seller can retake the test, and whether test takers are allowed to compare the answers. In some cases, the user can allow the server 202 to publish the created test. This way, other users can review the test, and either use the test again for their assignments or benchmark it to create their own tests. Also, in some cases, the server 202 can use the published tests to create a learning center, as further discussed below.

In some embodiments, the user can set notification settings 4814 for the test. For example, the user can request the server 202 to notify the user whenever an invited seller completes the test, any seller completes the test, and/or there are ungraded questions for more than a predetermined number of days. The user can also specify the recipients of the notifications 4816.

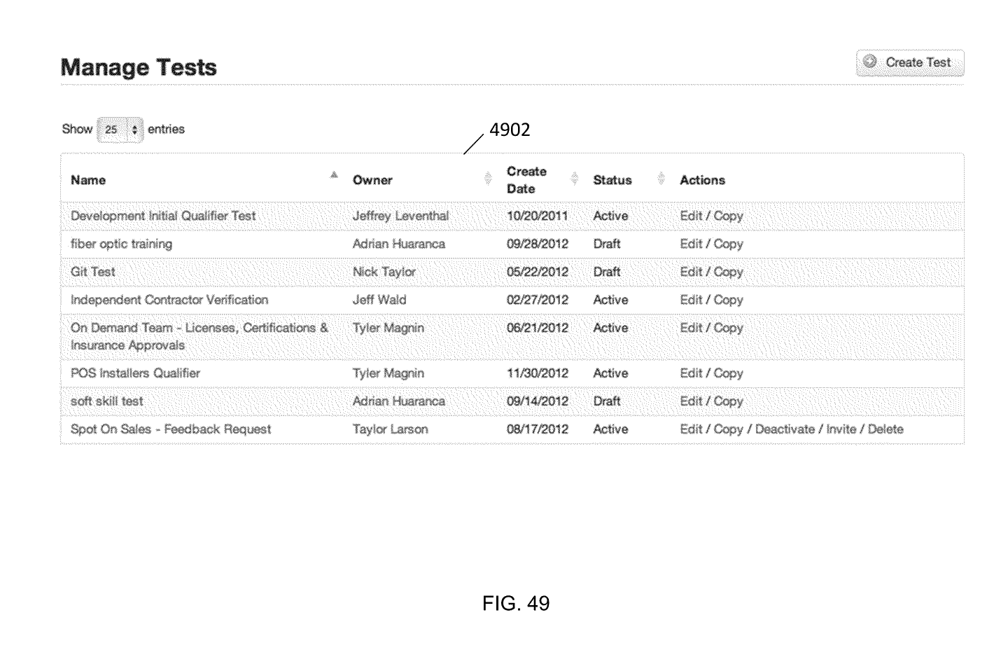

In some embodiments, the server 202 can provide a list of tests that can be used by a particular user. For example, the server 202 can provide the list of tests using a test pane. FIG. 49 shows a test pane for providing a list of tests in accordance with some embodiments of the disclosed subject matter. The test pane 4902 can show the name of the test, the owner of the test, the created date of the test, the status of the test, and possible actions on the test. In some embodiments, the test pane 4902 would only show tests created by the user. In other embodiments, the test pane 4902 would show tests that could be used by the user, including tests that are publicly available. The user can select one or more of the tests on the test pane 4902 to select tests to be used for an assignment.

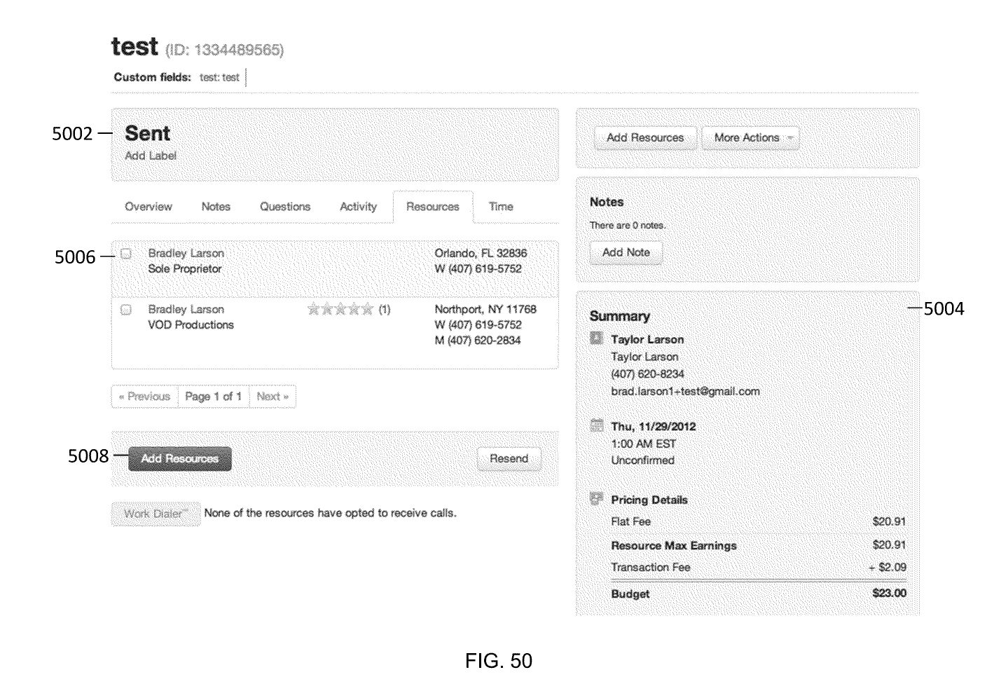

Once the buyer distributes an assignment to target sellers, the buyer can view the summary of the distributed assignment. FIG. 50 shows an interface showing a summary of the assignment distributed to sellers in accordance with some embodiments of the disclosed subject matter. The interface can include a title 5002 of the assignment, a summary pane 5004 showing the details of the assignment, and a list of sellers 5006 to whom the assignment has been distributed. In some embodiments, the buyer can use this interface to distribute the assignment to additional sellers. For example, the buyer can click on the “Add resources” icon 5008 to distribute the assignment to additional sellers.

In some embodiments, the server 202 can deliver the assignment to the target seller via electronic communication mechanisms. In other embodiments, the server 202 can simply notify the target seller via electronic communication mechanisms that the assignment is available for the seller. The electronic communication mechanisms can include, for example, electronic mails and a Short Message Service (SMS) message.

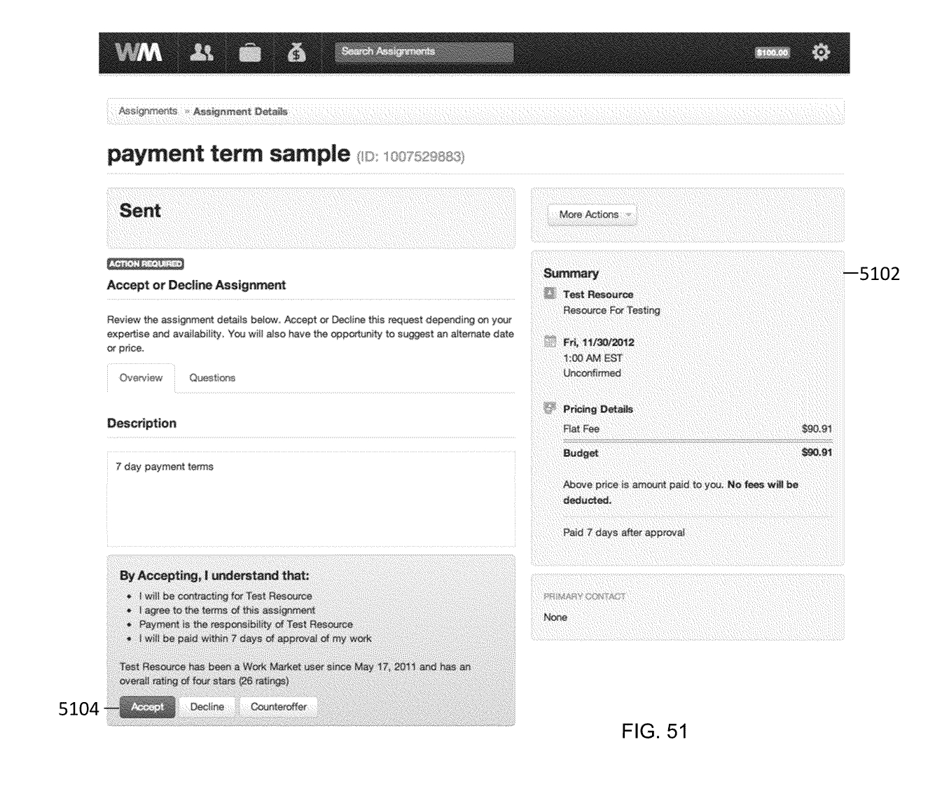

FIG. 51 illustrates an assignment viewed by a seller in accordance with some embodiments of the disclosed subject matter. The assignment includes a summary of the task 5102, including the pricing details. As shown in FIG. 51, the seller is shielded from the transactional fees paid to the server 202 by the buyer.

In some embodiments, the seller and the buyer can negotiate the terms of the assignment. The negotiation mechanism allows the seller and the buyer to modify the terms of the assignment in a flexible manner. For example, the seller and the buyer can negotiate the payment terms, including the fee, the budget, the expenses, and the payment due date. In other examples, the seller and the buyer can negotiate the deliverables.

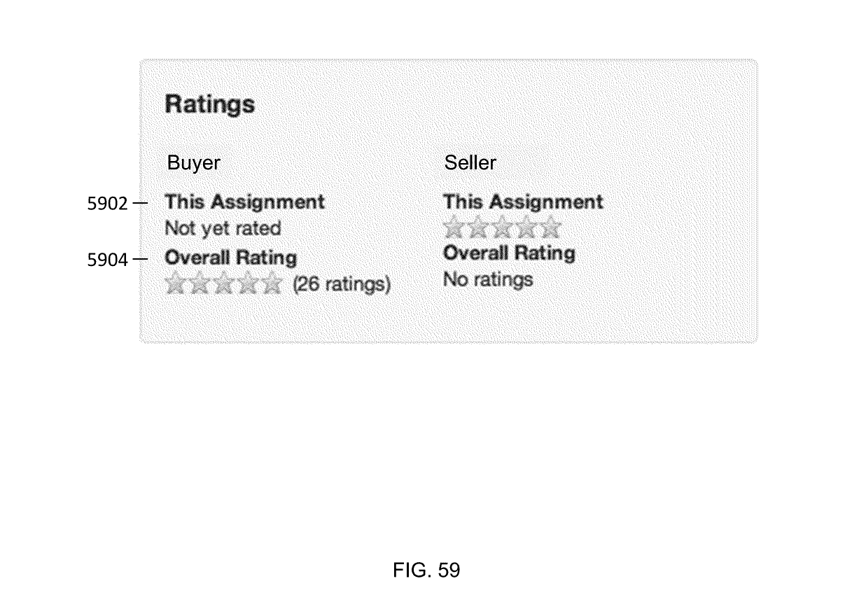

In some embodiments, the seller can determine whether the seller wants to work with the buyer by reviewing information about the buyer. This information about the buyer can include a rating of the buyer. The rating can be a consolidation of recommendations from the WM or other sellers, based on the buyer's prior activities. For example, if the buyer was bankrupt multiple times, then the buyer may be considered an unreliable party with whom to work. Therefore, the WM would provide a low rating for the buyer. Also, for example, if the buyer rejected the work product of sellers too many times, then the buyer would likely be an unreasonable person to work with. Therefore, the WM would provide a low rating for the buyer. In yet another example, if the buyer was not pleasant to work with, or if the buyer was not reliable, a seller can provide a low rating to the buyer. As discussed further below, sellers may use an interface illustrated in FIG. 59 to rate buyers.

By clicking on the accept button 5104, the seller can accept the assignment. In some embodiments, when one of the sellers accepts the assignment, the assignment is considered “taken” and is no longer available for the other sellers to accept. Subsequently, the profile information associated with the accepting seller is shared with the buyer. In other embodiments, the assignment may be accepted by a preselected number of sellers. For example, the buyer can configure the assignment so that the assignment can be accepted by five sellers. In other embodiments, even if the seller accepts the assignment, the seller may still need to be approved by the buyer before the seller can work on the assignment. The buyer can use this feature to ensure that the assignment is performed by a well-qualified seller.

Once the seller accepts the assignment, and, in some embodiments, receives an approval from the buyer to perform the requested task, the seller can perform the requested task. In some embodiments, during the performance of the assignment, the seller can communicate with the buyer to modify the assignment. The modification can include modifications of payment terms, fees, and deadlines for work products.

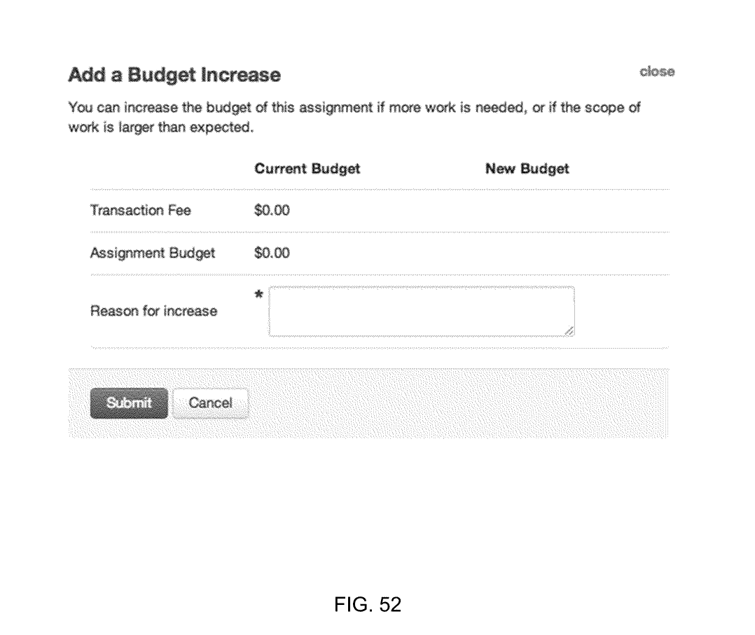

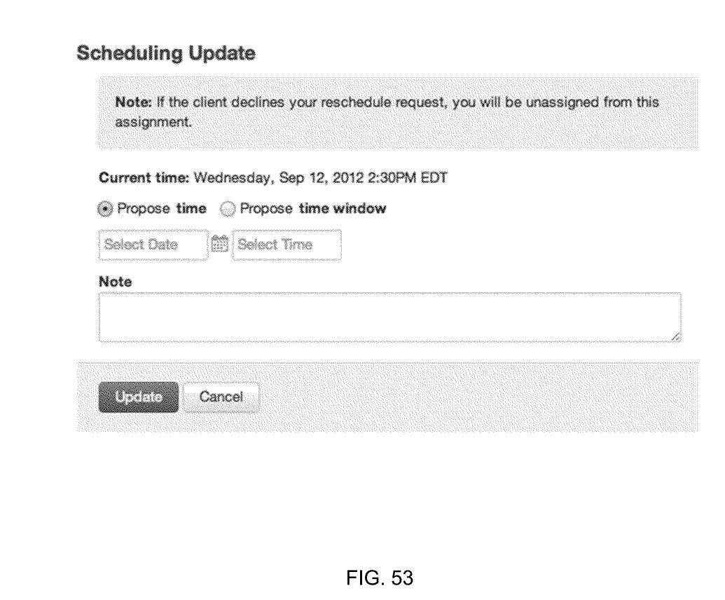

In some embodiments, the seller can request modification of the assignment using the tools provided by the server 202. For example, the buyer can send a message to the buyer via a messaging interface provided by the server 202. FIG. 52 illustrates an interface for modifying terms of an assignment in accordance with some embodiments of the disclosed subject matter. In particular, FIG. 52 illustrates an interface for requesting a budget increase. Similarly, FIG. 53 illustrates an interface for requesting modification of schedules for the assignment in accordance with some embodiments of the disclosed subject matter. For example, the seller can propose a modified due date or a modified time window for the assignment. In some cases, the seller can negotiate with the buyer using offline communication tools such as telephone calls, in face meetings, or external emails.

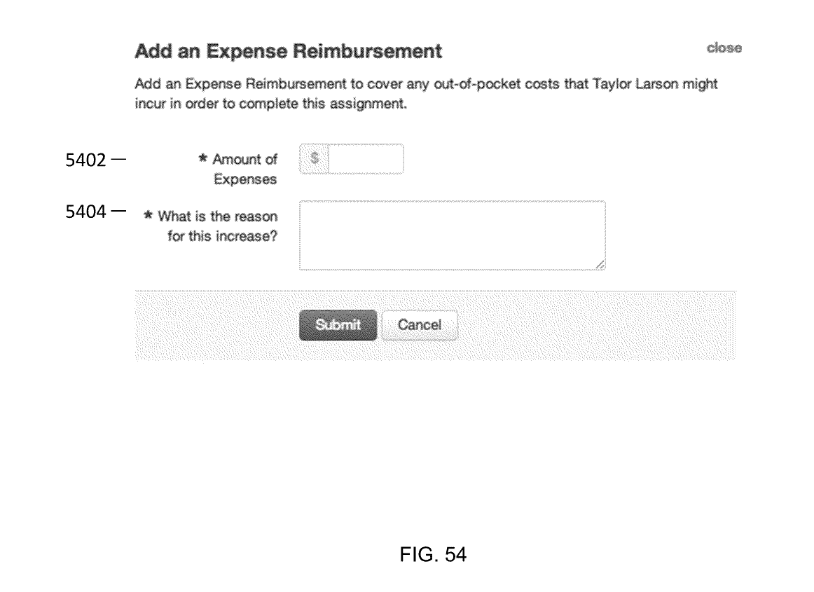

In some embodiments, during the performance of the assignment or after the completion of the assignment, the seller can request a reimbursement to cover any out-of-pocket expenses incurred to complete the assignment. FIG. 54 illustrates a reimbursement request pane for requesting a reimbursement in accordance with some embodiments of the disclosed subject matter. The reimbursement request pane can include a field for identifying the amount of incurred expense 5402, and reasons for requesting the reimbursement 5404.

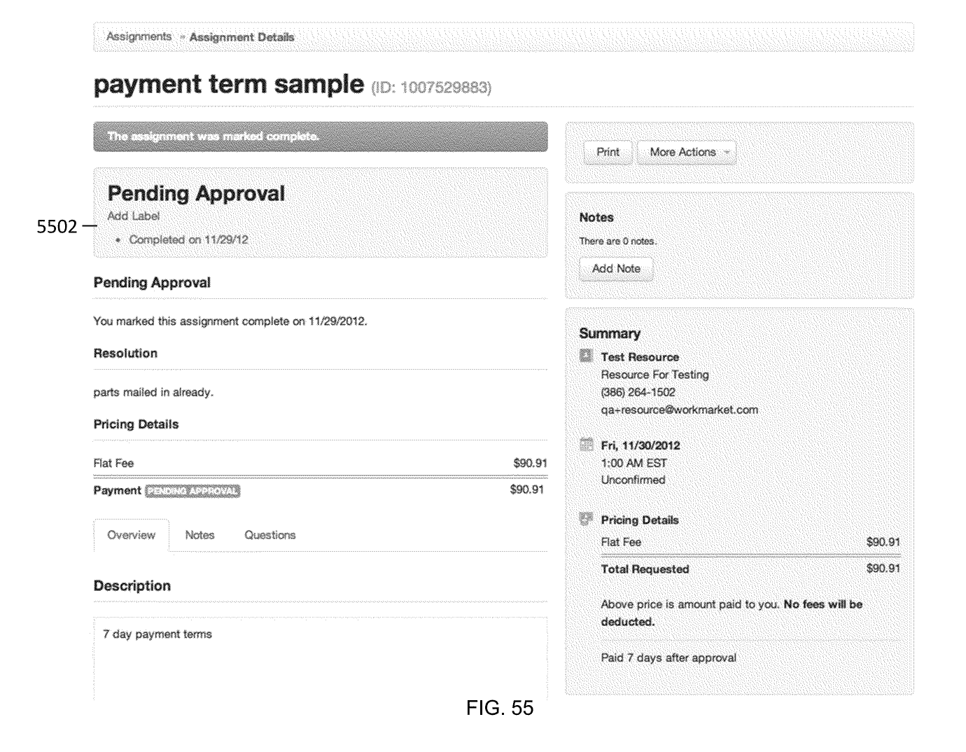

Upon completion of the assignment, the seller can indicate that the requested tasks are completed. At this stage, the assignment is said to be “completed.” Once the seller completes the tasks, the seller can notify the buyer that the assignment is completed and wait for approval of the work product. FIG. 55 shows a status pane for the seller in accordance with some embodiments of the disclosed subject matter. The status pane 5502 can indicate that the seller is waiting for the buyer's approval of the work product. In some cases, the seller can provide the work product via the server 202; in other cases, the seller can provide the work product off-line, for example, via postal service, express mailing service, or hand-delivery.

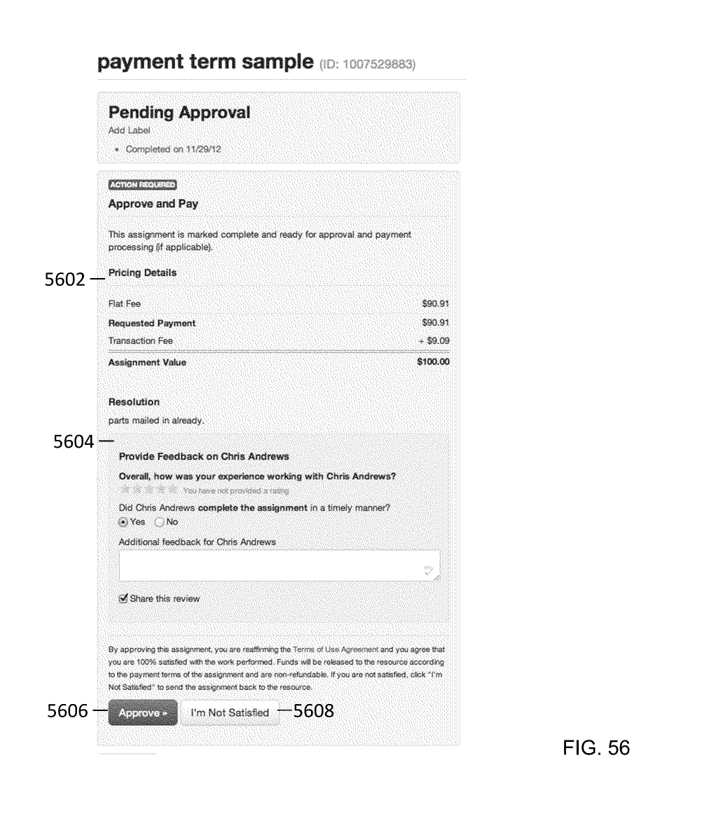

Once the seller notifies the completion of the assignment, the buyer can review the completed tasks, and can either approve the work to close the assignment, or reject the work and give the seller a chance to cure. FIG. 56 illustrates an interface for evaluating the seller's work product in accordance with some embodiments of the disclosed subject matter. The buyer can review the pricing details 5602 of the assignment, optionally provide a review of the seller using the review pane 5604, and approve or reject the work product using the approval icon 5606 or the decline icon 5608.

In some embodiments, the buyer or the seller can close the assignment even before the seller completes the requested tasks. This feature allows the buyer and seller to complete the transactions when the buyer no longer needs to receive the requested service.

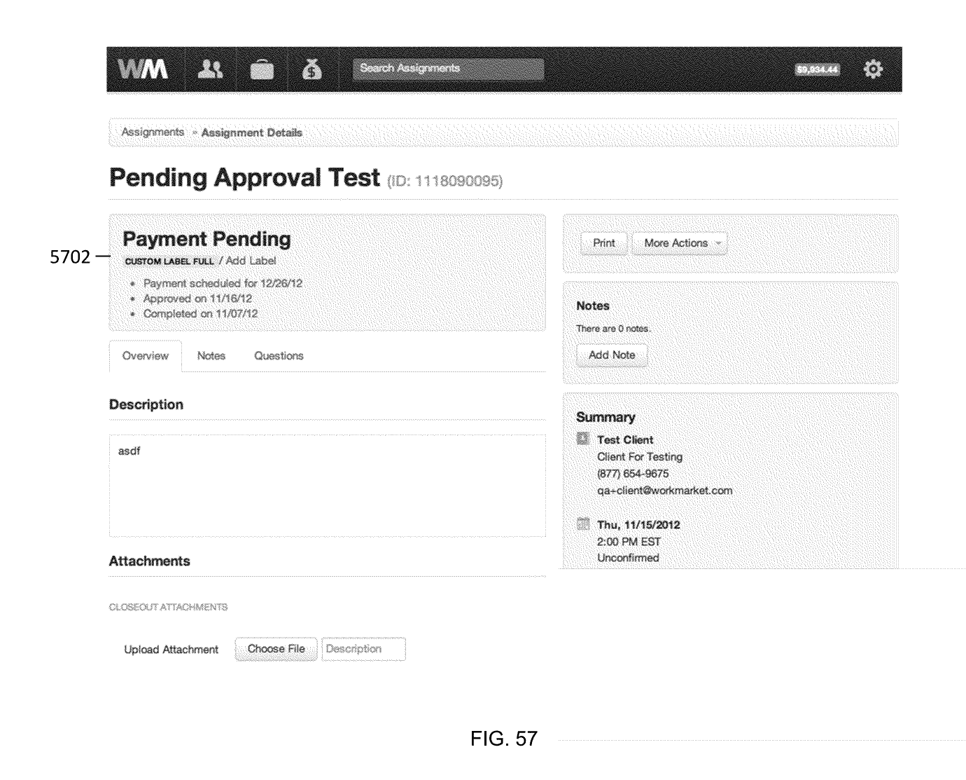

Once the buyer approves the work product, the buyer is requested to make the due payments. As discussed above, the buyer will pay to the WM, and the WM will disburse the due payment to appropriate sellers. FIG. 57 shows an interface requesting the buyer to pay the due balance in accordance with some embodiments of the disclosed subject matter. The status pane 5702 shows the dates on which certain events took place. For example, the status pane 5702 can indicate that the assignment was completed on Nov. 7, 2012, approved on Nov. 16, 2012, and that the payment should be paid by Dec. 26, 2012.

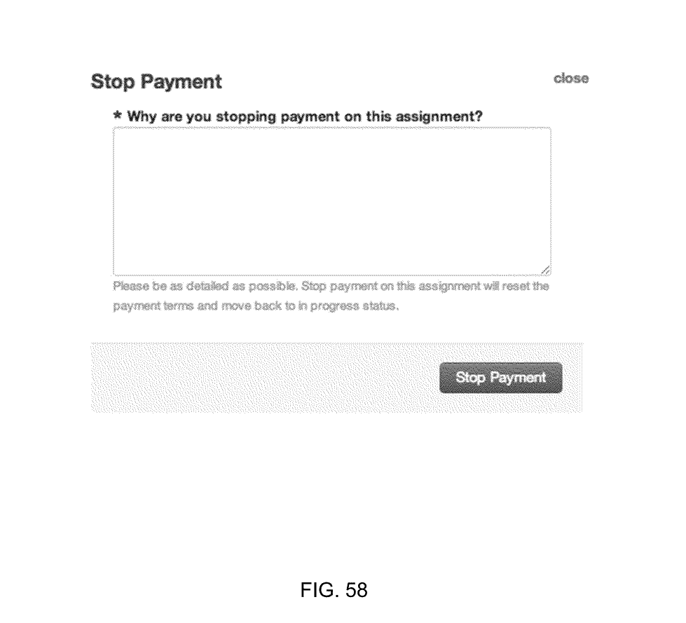

In some embodiments, prior to receiving the invoice, the buyer can retract the approval of the assignment and stop the payment. For example, if the buyer was expecting some parts to be delivered physically, but the parts were never delivered, then the buyer can suspend the payment until the seller cures the deficiencies. FIG. 58 shows an interface for stopping the payment in accordance with some embodiments of the disclosed subject matter. The interface can request the buyer to provide reasons for stopping payment on the associated assignment.

In some embodiments, if the buyer does not pay the due balance, the buyer can be barred from creating additional assignments until the buyer pays the due balance. However, the buyer can still manage the assignments that have already been created. In some embodiments, buyer's average amount of time for making due payments can be available to the public, including potential sellers. Since this information can be critical when the seller decides to accept an assignment, the buyer may not indefinitely delay the payment.

In some embodiments, the buyer and the seller can rate each other. FIG. 59 illustrates an interface for rating each other in accordance with some embodiments of the disclosed subject matter. The buyer can provide the rating to the seller based on the buyer's experience in working with the seller; the seller can provide the rating to the buyer based on the seller's experience in working with the buyer. In some aspects, the ratings can be provided using a star-based interface 5902. The interface can also show the aggregate rating 5904 of the buyer and the seller.

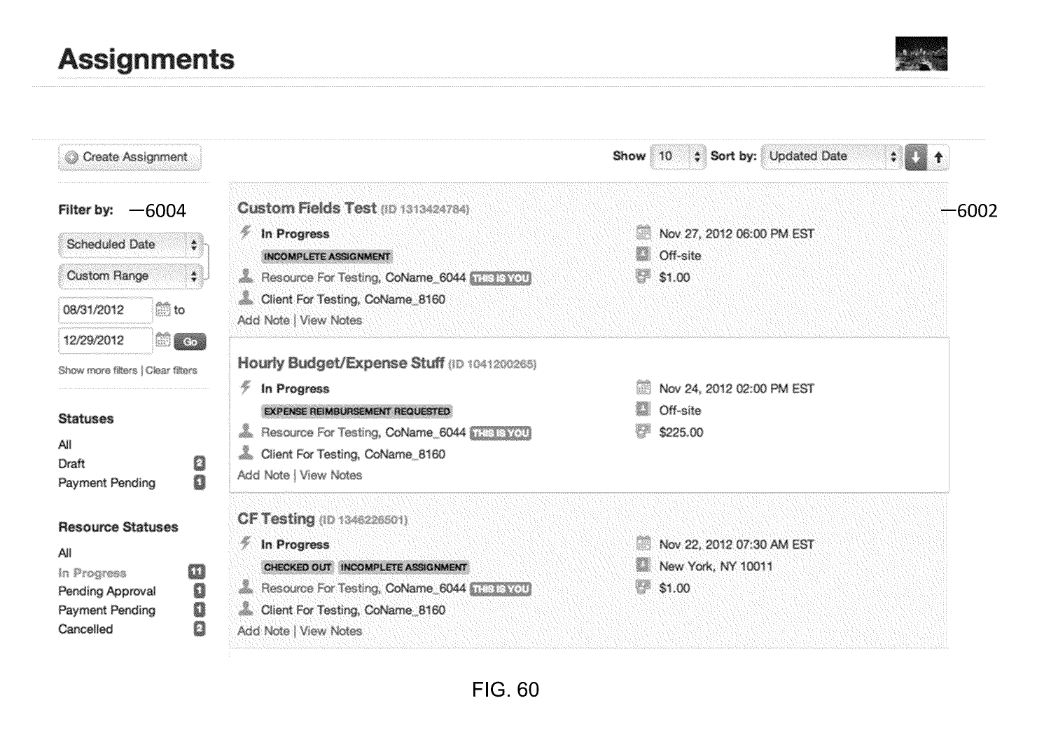

FIG. 60 shows an assignment dashboard in accordance with some embodiments of the disclosed subject matter. The buyer can use the assignment dashboard to manage all the assignments created by the buyer. The assignment pane 6002 in the dashboard can indicate, for each assignment, the status of the assignment, a brief summary of the assignment, and any action items for the assignment. In some embodiments, the buyer can filter the assignments using a filter 6004.

In some embodiments, the seller may also have its own assignment dashboard. On the assignment dashboard, the seller can see the list of assignments the seller has accepted or applied for but missed. In some cases, for assignments that the seller has missed, the seller can see the profile of the seller that received the assignment.

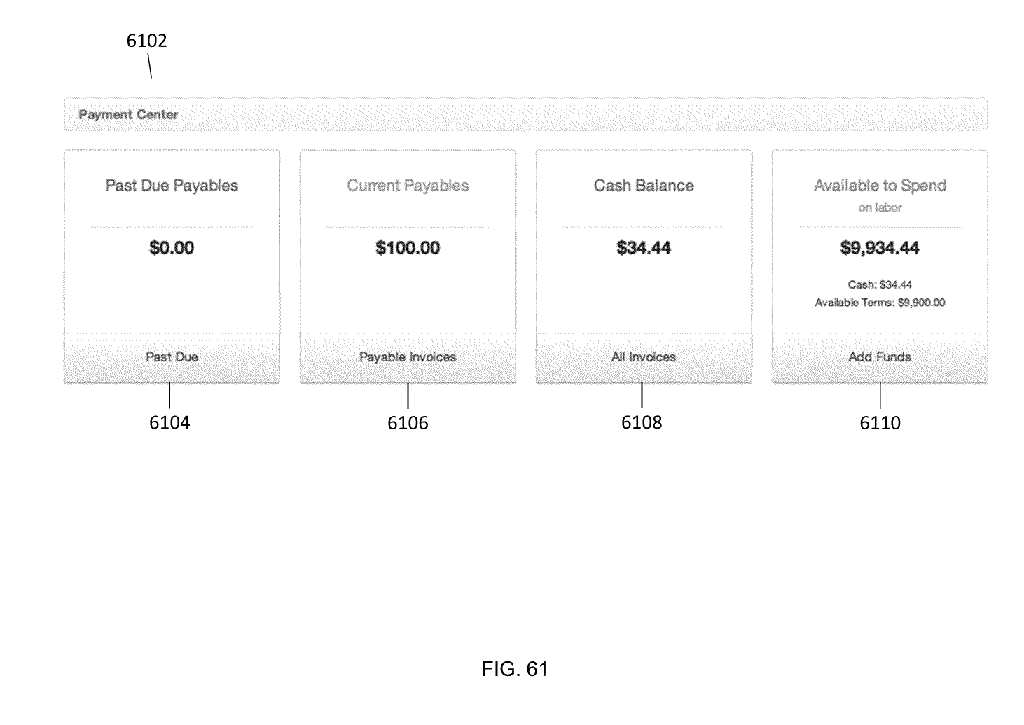

FIG. 61 shows a finance dashboard in accordance with some embodiments of the disclosed subject matter. The buyer can use the finance dashboard 6102 to manage the past due payables 6104, current payables 6106, cash balance 6108, and the available facilities 6110. The term payable refers to money that the buyer has to pay off for approved assignments. The available facilities can be computed by adding the base facility and the cash balance, and subtracting the payables.

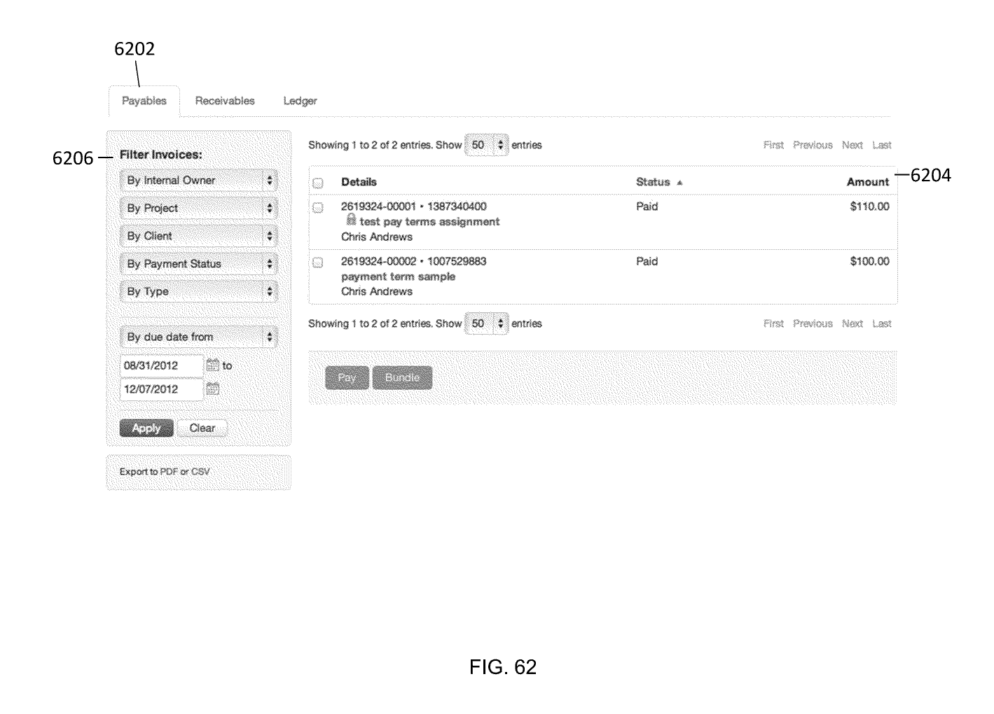

FIG. 62 shows a payable dashboard in accordance with some embodiments of the disclosed subject matter. The payable dashboard 6202 allows the buyer to keep track of invoices or statements that need to be paid off. The payable dashboard 6202 includes a payable table 6204 that itemizes invoices and/or statements. In some embodiments, the buyer can filter the itemized invoices and/or statements using a filter 6206.

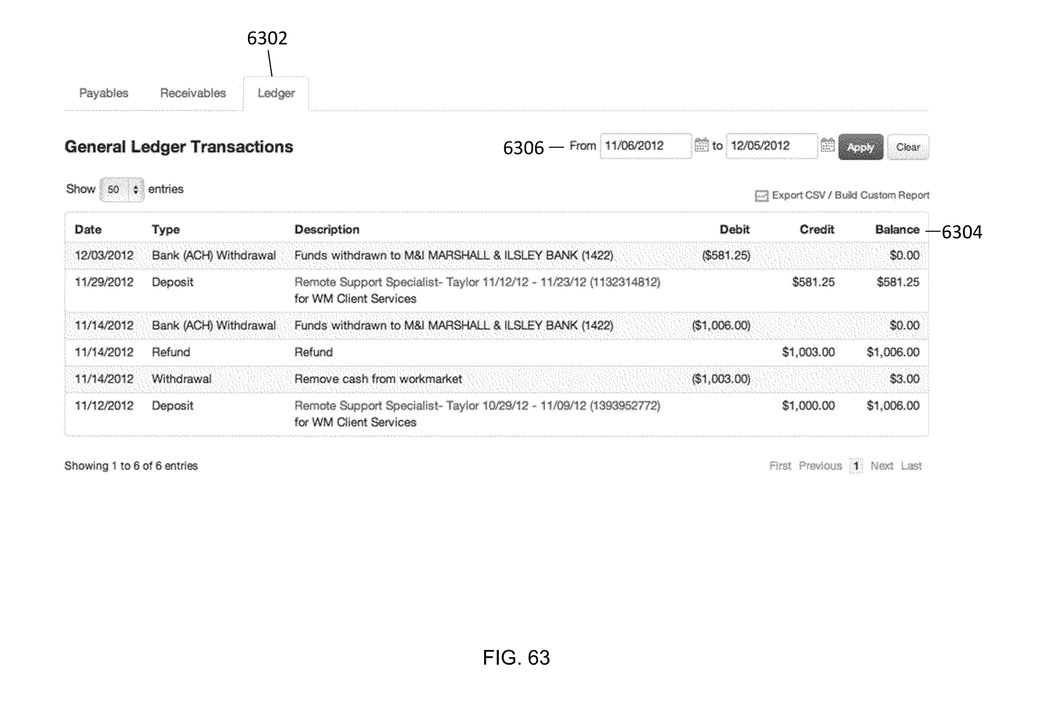

FIG. 63 shows a ledger dashboard in accordance with some embodiments of the disclosed subject matter. The ledger dashboard 6302 allows the buyer to keep track of cash flow for the account. The ledger dashboard 6302 includes a list of cash transactions 6304 associated with the buyer. The list of cash transactions 6304 is similar to a bank statement that lists all the credits and debits associated with the account. In some embodiments, the buyer can filter the list of cash transactions using a filter 6306.

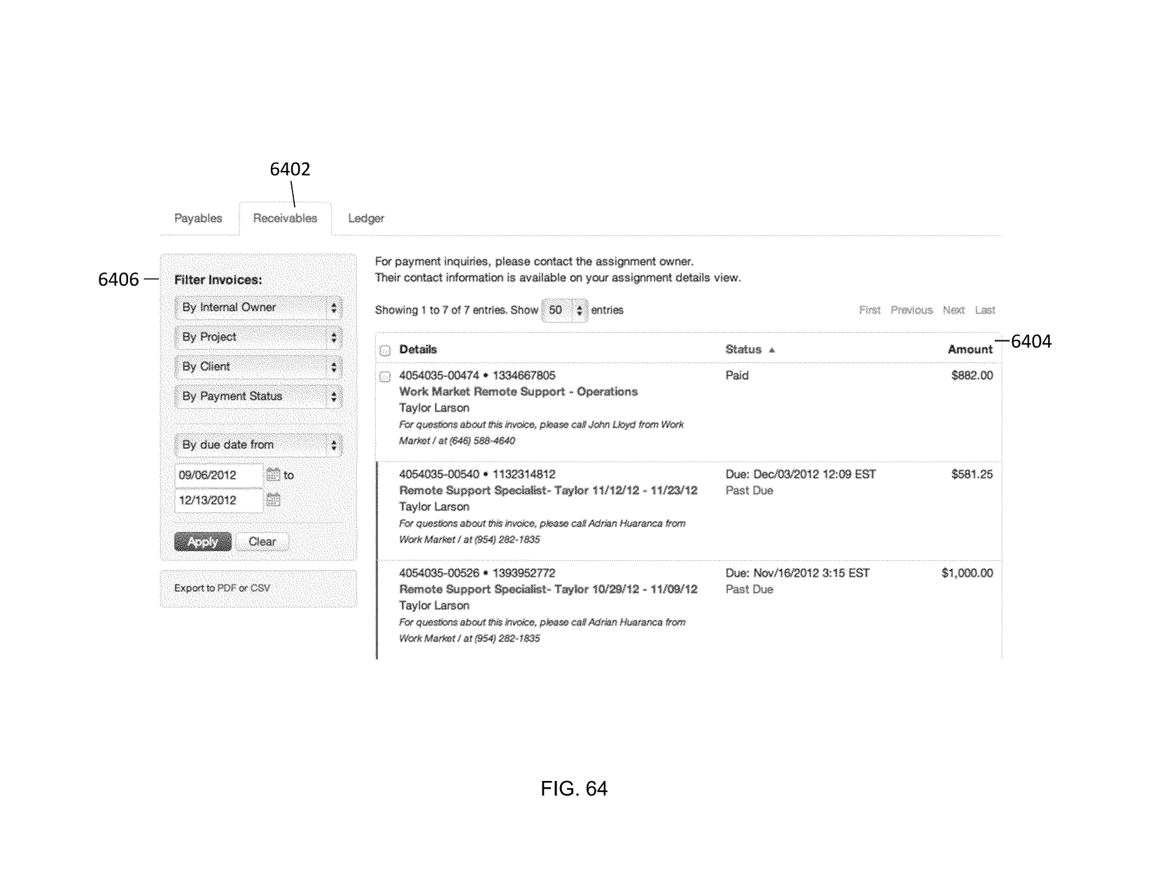

FIG. 64 shows a receivable dashboard in accordance with some embodiments of the disclosed subject matter. The receivable includes money that the user is expected to receive from one or more buyers. The receivable dashboard 6402 allows the buyer to keep track of invoices or statements for which the user is expected to receive payment. The receivable dashboard 6402 can include a receivable table 6404 that itemizes invoices and/or statements. In some embodiments, the user can filter the itemized invoices and/or statements using a filter 6406.

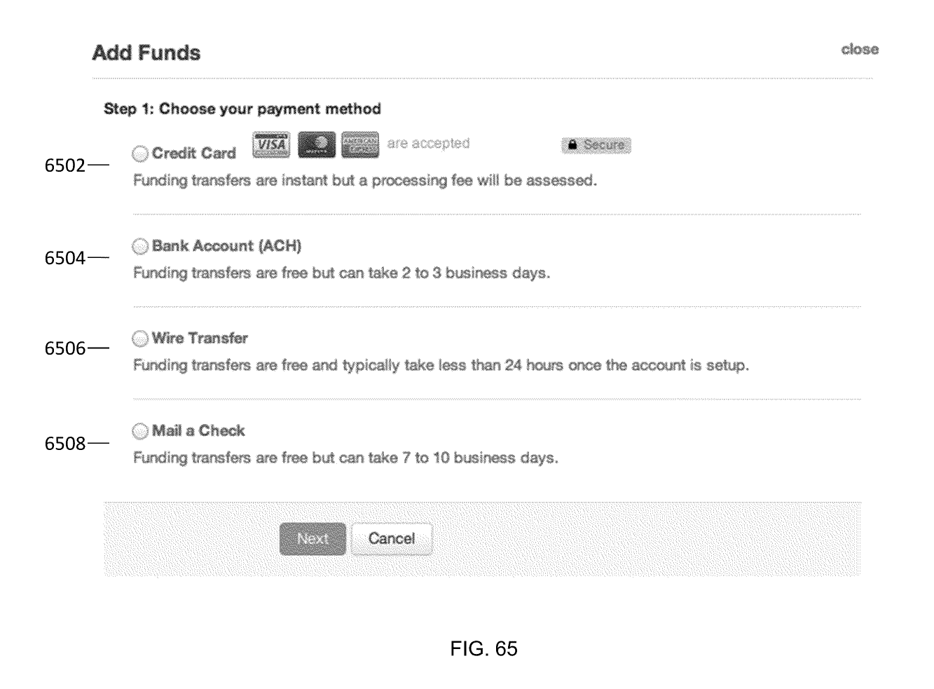

FIG. 65 shows an interface for funding an account in accordance with some embodiments of the disclosed subject matter. The server 202 provides at least four options to fund an account: a credit card option 6502, a bank account (ACH) option 6504, a wire transfer option 6506, and a check option 6508.

In some embodiments, as discussed above, the server 202 can crowd-source trade credits from users to grant trade credits (or facilities) to buyers. Trade credit is a form of short-term financing through which the seller agrees to provide goods or services without requiring payment up front. Trade credit often specifies a payment term duration during which the buyer should pay for the received services. Although trade credit is useful for buyers, a seller is often hesitant to extend trade credit to a buyer with which the seller has not established a long-standing relationship or history. One reason for such hesitance is the difficulty of receiving the payment after rendering the service or delivering the goods.

To alleviate concerns associated with granting trade credits to unfamiliar parties, the seller can instead grant trade credits to a pool managed by the WM. The sellers would be more willing to grant trade credits to the pool managed by the WM since the WM can (1) guarantee payment, (2) expose the seller to a large number of profitable assignments from new, albeit sometimes unknown, buyers, and (3) allow the seller to build a solid and reliable reputation among the buyers in the WM, thereby improving the chances that the seller would receive even more work in the future. The seller can grant trade credits by indicating the maximum amount of work the seller is willing to do before receiving payment. In some sense, the seller is bearing the risk for the trade credit provided to the pool of trade credits managed by the WM.

In some embodiments, the server 202, managed by the WM, can consolidate all the trade credits received from the sellers, and allocate portions of the consolidated trade credits to buyers as facilities. The server 202 may allocate the consolidated trade credits, for example, upon request and/or approval, and according to the credit terms. In some embodiments, the server may receive trade credits from sellers by receiving promises or pledges that the sellers would agree to a certain amount of work without receiving any payment up front. In some cases, the amount of work is measured in terms of a monetary value. In other cases, the amount of work is measured in terms of the number of hours of work performed.

In some embodiments, the server may consolidate the received trade credits by combining or merging the trade credits from the sellers. As discussed above, the credit request/approval process may be automated or performed electronically. While individual trade credit may be small in value, for example $50, $100, or $200, and the payment term duration may be short, for example 10 days, the value and duration of the aggregate trade credit from all the sellers may be large and long, respectively.

To ensure that the server 202 receives payments from the buyers, the WM can implement mechanisms to induce buyers to pay for the due payments. For example, buyers that do not pay the due balance may be banned from the WM. Also, the WM may enforce payment via various legal proceedings if the buyer defaults on any payments. The various enforcement mechanisms can include notifying the buyer that the WM is entitled to a lien, such as a mechanics lien, against the buyer, filing documents and records with the appropriate agencies, filing liens, and commencing lawsuits.

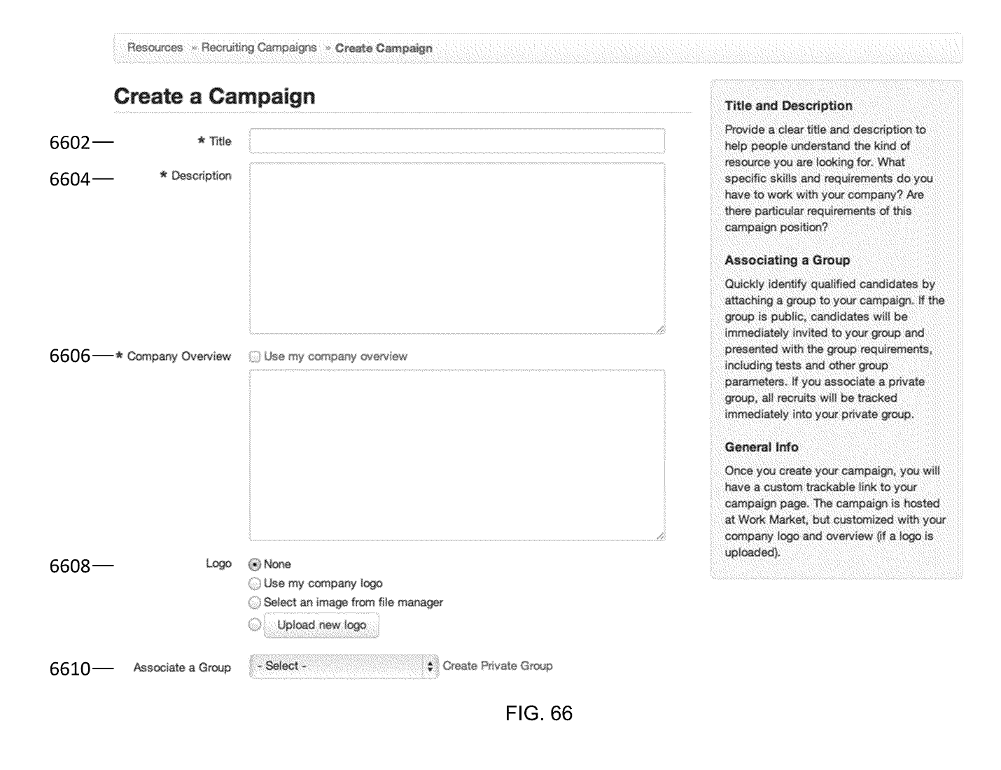

In some embodiments, the WM enables users to find or recruit professionals. For example, a user can provide an advertisement or a campaign having a description of the sought-after professionals to the system, and the system can distribute the advertisement or the campaign to potentially interested professionals. The professionals can subsequently respond to the advertisement or the campaign to apply for the available position. FIG. 66 illustrates an interface for creating a campaign in accordance with some embodiments of the disclosed subject matter. The interface can include fields for specifying a title of the campaign 6602, a description of the campaign 6604, an overview of the company 6606 associated with the campaign, a logo 6608 for the campaign, and/or a group 6610 to which the campaign will be distributed.

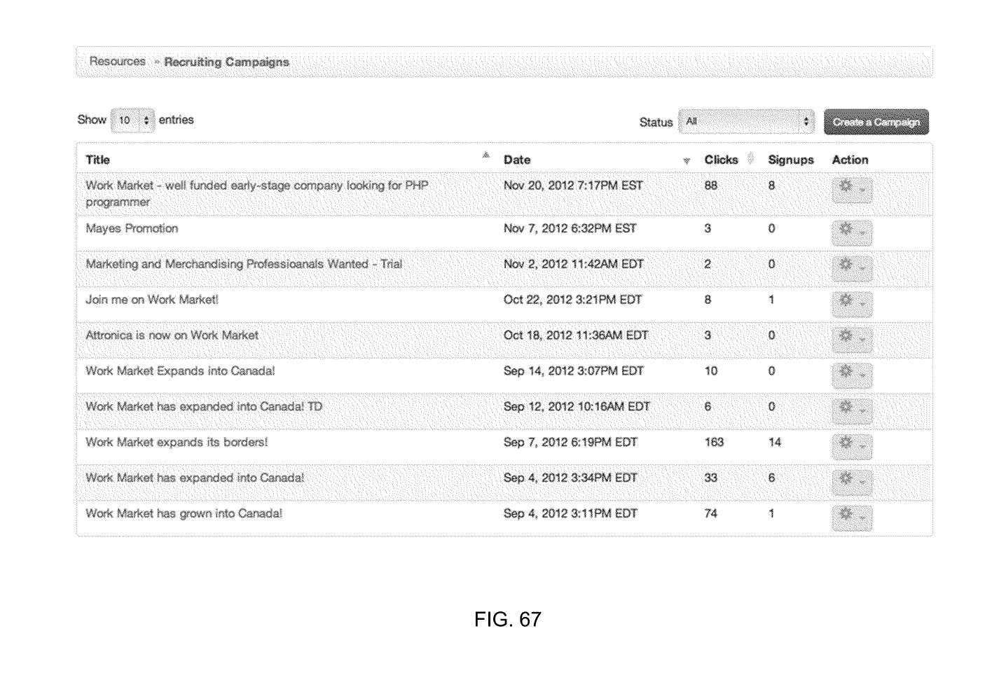

In some embodiments, the recruiter can manage the recruiting campaigns on the WM. FIG. 67 shows an interface for managing recruiting campaigns in accordance with some embodiments of the disclosed subject matter. The interface can include a listing of campaigns, identified by a title, date of creation, a number of clicks, a number of people signed up for the campaign, and possible actions available for the campaign.

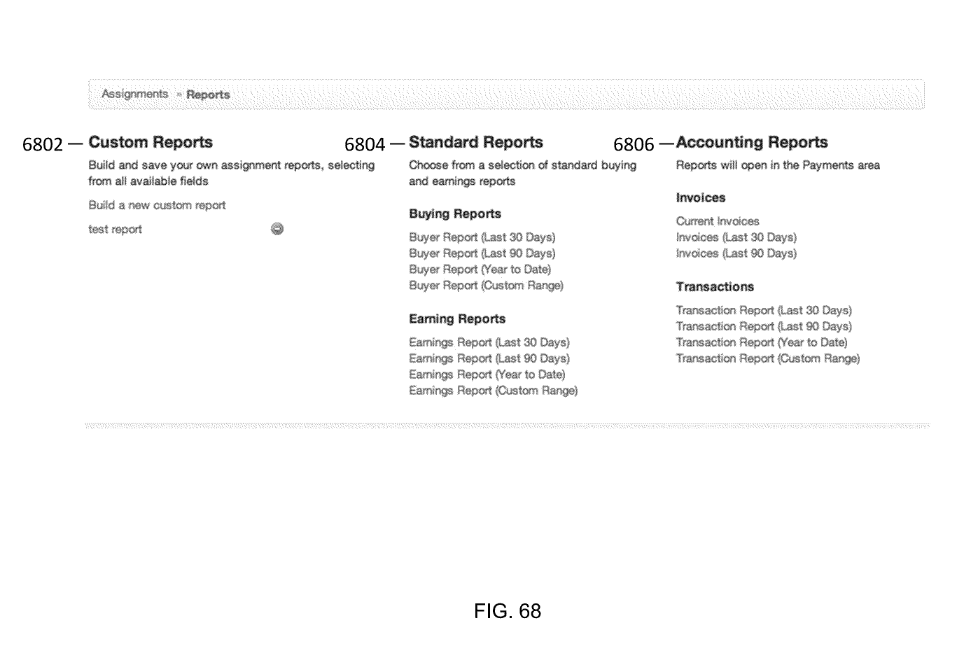

In some embodiments, a buyer can receive a report of its activities on the WM. FIG. 68 illustrates an interface for receiving a report of its activities in accordance with some embodiments of the disclosed subject matter. The user can have an option to receive one or more of a custom report 6802, a standard report 6804, and an accounting report 6806. The custom report 6802 can include a listing of assignments that satisfy user-specified conditions; a standard report can include a buying report or an earnings report; and an accounting report can include invoices or financial transaction reports. In some cases, the buying report can include a list of assignments formatted according to a standard format.

In some embodiments, the user-specified conditions for the custom report 6802 can include dates associated with the assignment, basic information about the assignment, location of performance associated with the assignment, fees associated with the assignment, sellers working on the assignment, the client for whom the assignment is performed, labels associated with the assignment, routing, check-in data, and parts.

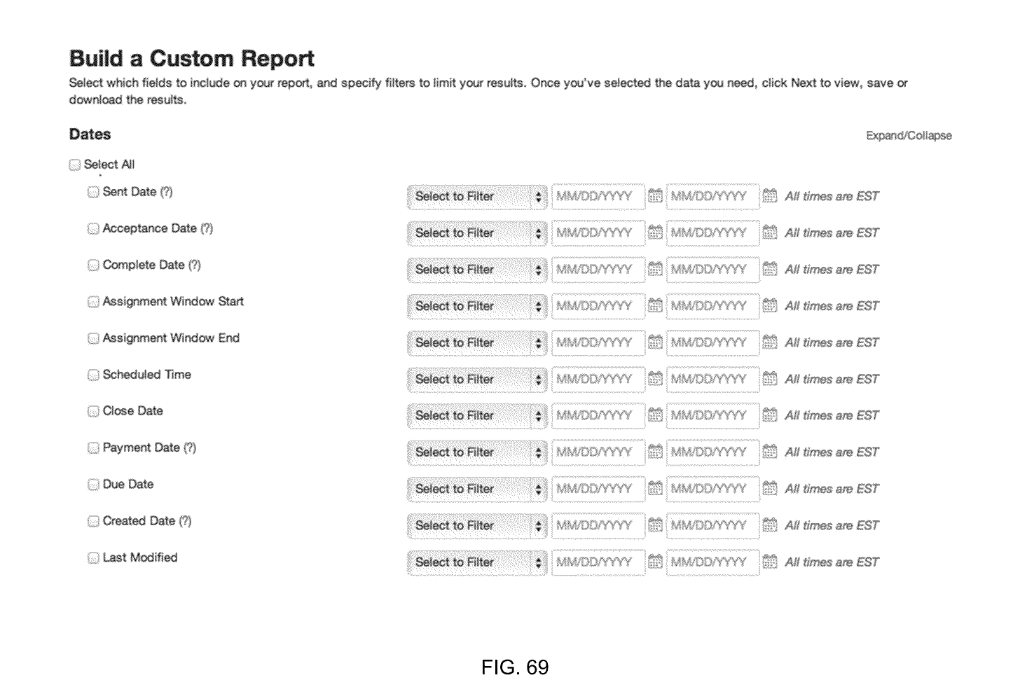

FIG. 69 shows an interface for building a custom report in accordance with some embodiments of the disclosed subject matter. FIG. 69 shows an example in which the user specifies date conditions for the custom report. The date condition can include the sent date, the acceptance date, the completion date, the start/end of the assignment, scheduled time for performance of the assignment, the closing date, the payment date, the due date for the assignment, the assignment creation date, and/or the date on which the assignment was last modified. Similar interfaces can also be available for specifying other conditions for the custom report.

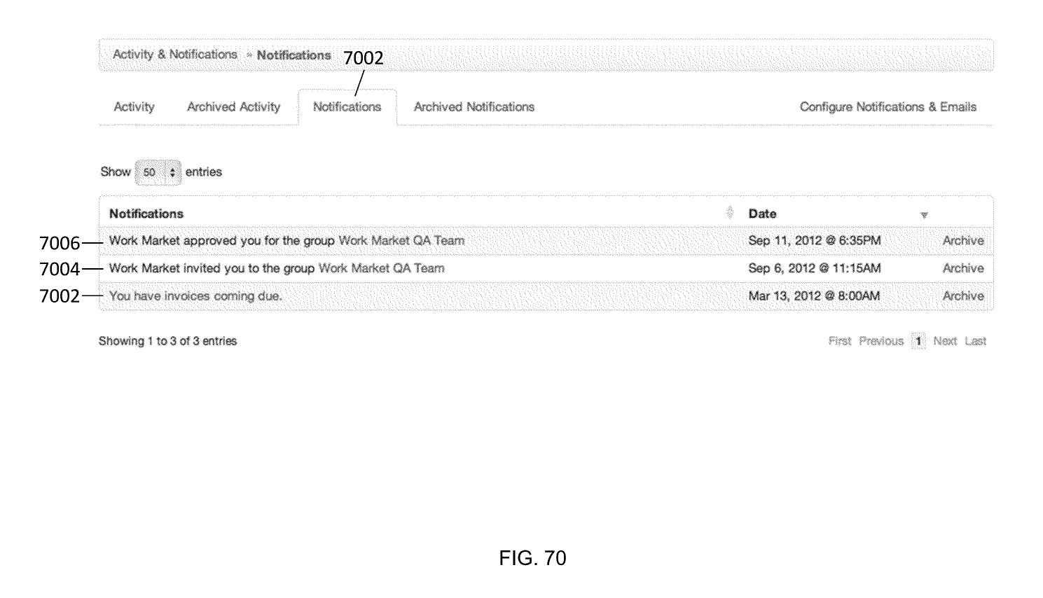

FIG. 70 shows a notification pane for an account in accordance with some embodiments of the disclosed subject matter. The notification pane 7002 can notify the account user of any activities associated with the account. For example, the notification pane 7002 can indicate that the account user has invoices coming due 7002, that the account user is invited to a group 7004, or that the account user is approved to be a member of a group 7006.

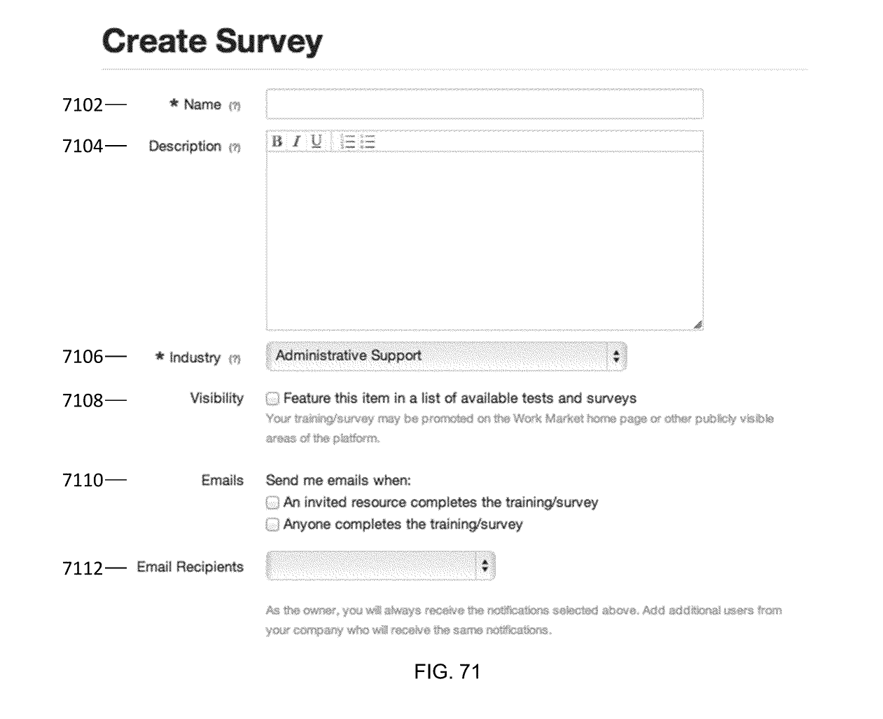

In some embodiments, as discussed above, a user can create a custom survey to be completed by sellers. FIG. 71 shows an interface for creating a survey in accordance with certain embodiments of the disclosed subject matter. The interface can include fields for specifying the name 7102, the description 7104, and the industry 7106 associated with the survey and/or the assignment.

In some embodiments, the user has an visibility option 7108 for allowing the WM to publish the survey. This way, other users can review the survey, and either use the survey again for their assignments or benchmark it in creating their own surveys. In some aspects, the user can set notification settings 7110 for the survey. For example, the user can request the WM to notify the user whenever an invited seller completes the survey, or any seller completes the survey. The user can also specify the recipients of the notifications 7112. In some aspects, a user can modify a survey after creating the survey. In some embodiments, the user can use an interface similar to FIG. 71 to modify the survey.

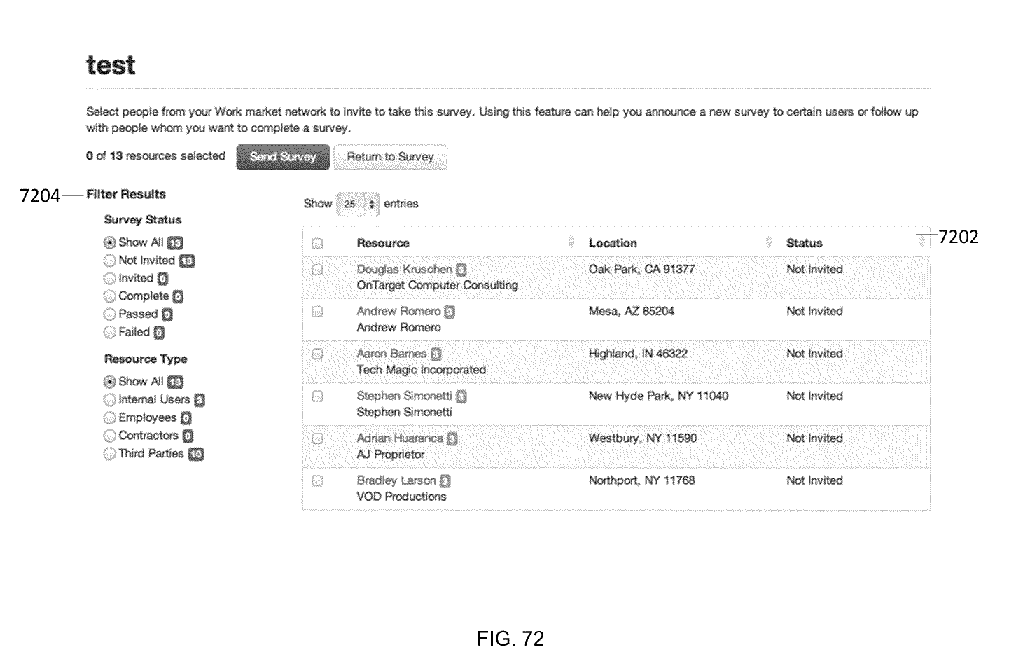

In some embodiments, a user can invite sellers to take a survey. The survey can be independent of an assignment. FIG. 72 illustrates an interface for inviting sellers to take a survey in accordance with some embodiments of the disclosed subject matter. The interface can include a user listing 7202, showing the list of sellers to whom the survey can be sent, and a user can select one or more sellers from the user listing 7202 to send the survey. The user can filter the user listing 7202 using a filter 7204.

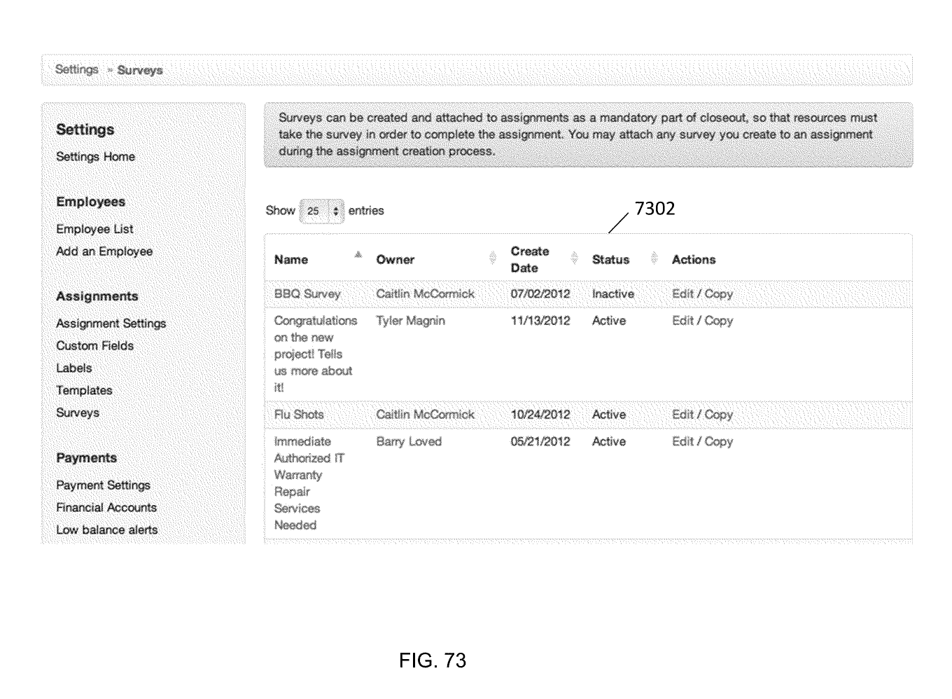

In some embodiments, a user can maintain a list of surveys that can be used by the user. The list of surveys can be maintained using a survey pane. FIG. 73 shows a survey pane for maintain a list of surveys in accordance with some embodiments of the disclosed subject matter. The survey pane 7302 can show the name of the survey, the owner of the survey, the created date of the survey, the status of the survey, and possible actions on the survey. In some embodiments, the survey pane 7302 would only show surveys created by the user. In other embodiments, the survey pane 7302 would show surveys that could be used by the user, including surveys that are publicly available. The user can use the survey pane 7302 to select one or more surveys to be used for an assignment.

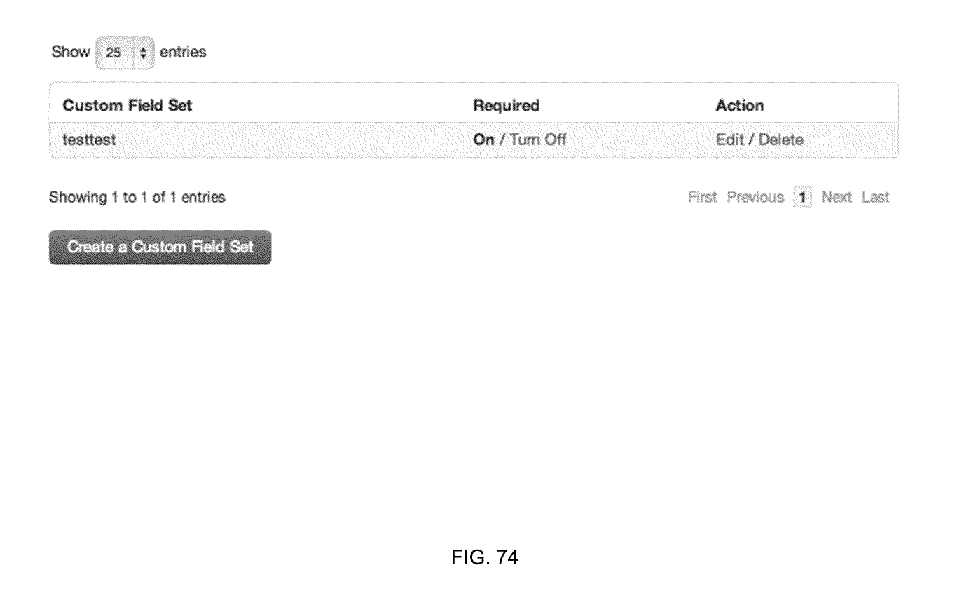

In some embodiments, a user can create a custom field for assignments. FIG. 74 illustrates an interface for managing custom fields created by a user in accordance with some embodiments of the disclosed subject matter. The interface allows a user to view available custom fields, and also specify whether the custom fields are turned on or turned off.

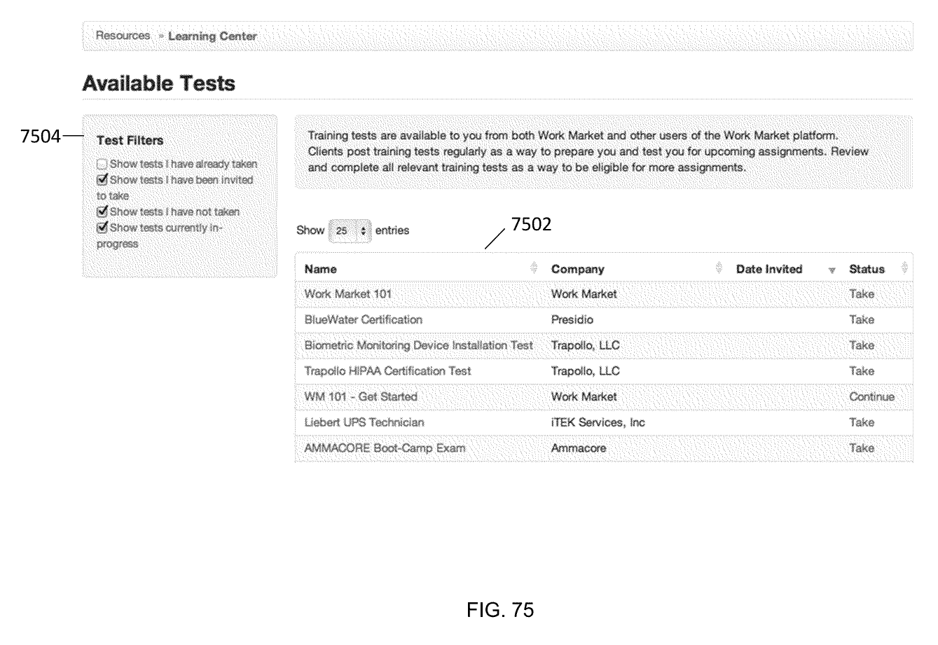

In some embodiments, the server 202 provides a learning center through which potential sellers can acquire new skills. For example, the server provides publicly available tests to users so that users can take the tests and acquire skills. This way, the test takers can gain more skills and become eligible to take on additional assignments, and the buyers can select a seller from a broader pool of candidates. FIG. 75 illustrates a learning center in accordance with some embodiments of the disclosed subject matter. The learning center can list available tests using a test pane 7502. The test pane 7502 can list the tests, showing the name, the company that created the test, the date of invitation to take the test, and the current status of the test. A test taker can use the filter 7504 to view (1) the tests that the test taker has taken, (2) the tests that the test taker has been invited to take, (3) the tests that the test taker has not taken, and/or (4) tests that the test taker is currently taking.

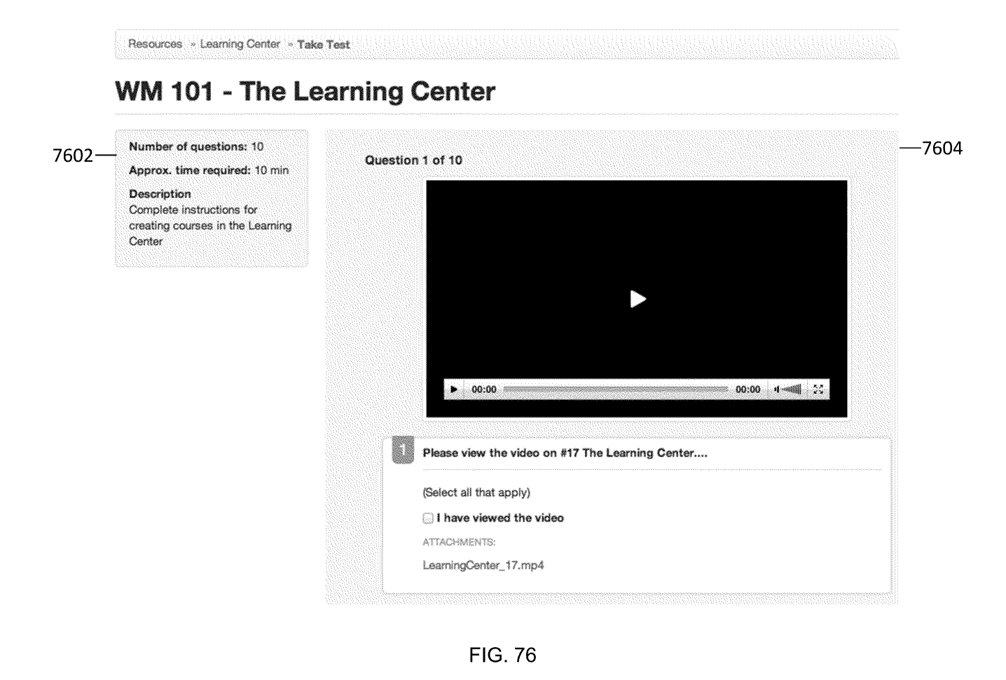

FIG. 76 illustrates an interface for taking a test in accordance with some embodiments of the disclosed subject matter. The interface can include a summary pane 7602, indicating the number of questions for the test, the approximate time required to take the test, and/or a brief description of the test. The question pane 7604 can include the actual question. The question can include text and media including audio and/or video.

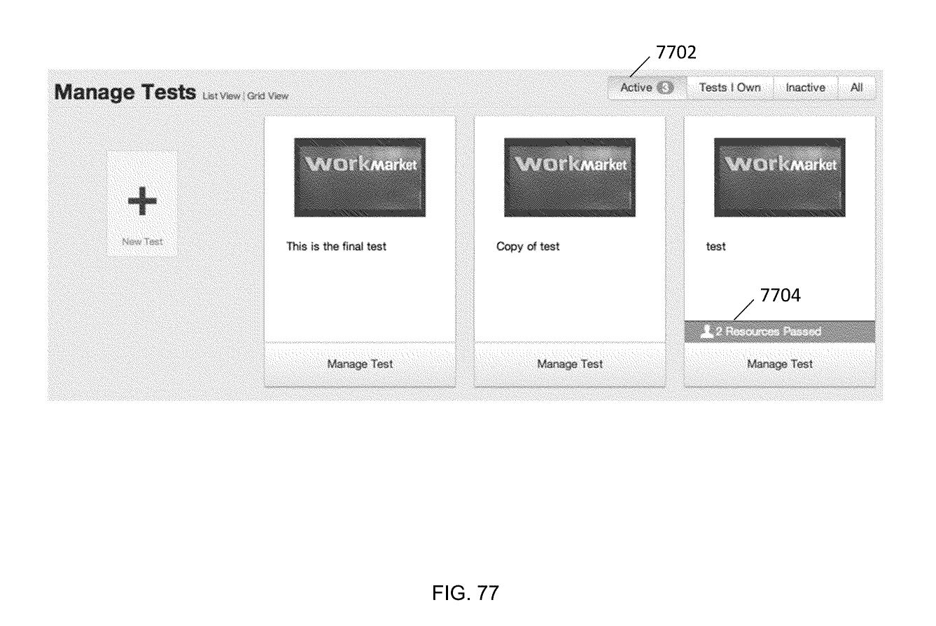

In some embodiments, the test taker can also manage the test using a test manager pane. FIG. 77 shows a test manager pane in accordance with some embodiments of the disclosed subject matter. The test taker can user the filters 7702 to view (1) all the tests, (2) inactive tests, (3) tests owned by the test taker, and/or (4) tests that are currently active. In some cases, the test manager pane can show a status indicator 7704, indicating how many users have passed the displayed test.

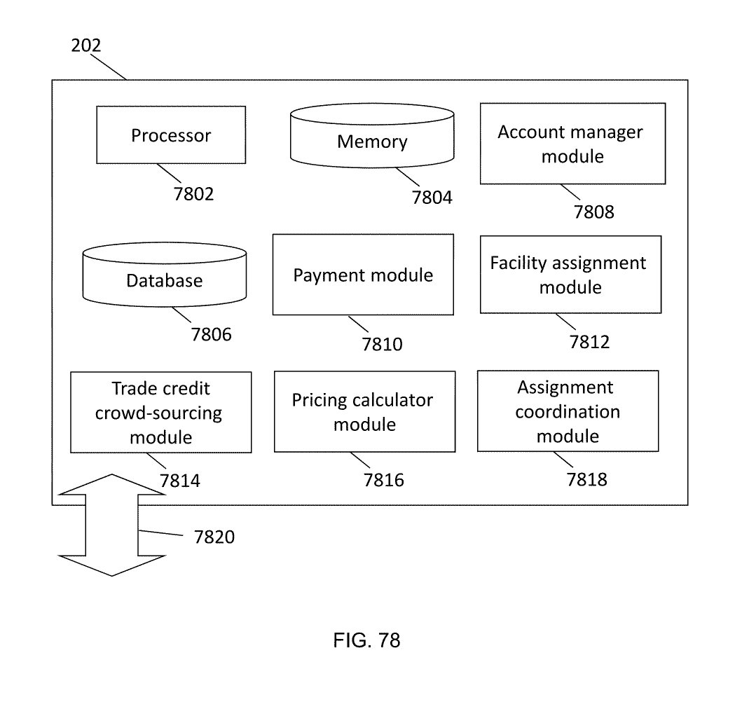

FIG. 78 illustrates a logical diagram of a server 202 in accordance with some embodiments. The server 202 can include a processor 7802, memory 7804, a database 7806, an account manager module 7808, a payment module 7810, a facility assignment module 7812, a trade credit crowd-sourcing module 7814, a pricing calculator module 7816, an assignment coordination module 7818, and an interface 7820.

The account manager module 7808 is configured to manage account information associated with buyers and sellers. The account information associated with a buyer's account can include the profile information, the bank account information, information relating to assignments created by the buyer, the amount of due payables, the amount of available cash, the amount of facilities, and the rating of the buyer. The account information associated with a seller's account can include the profile information, the bank account information, information relating to assignments accepted by the seller, and the rating of the seller. In some aspects, the account manager module 7808 can compute the rating of the buyer or the seller. In some embodiments, the account manager module 7808 can maintain the account information in the database 7806.

The payment module 7810 is configured to request payments from buyers, to process payments received from buyers, and to disburse the received payments to sellers. The payment module 7810 can use the payment terms associated with the corresponding assignment to determine when the payment should be disbursed to the sellers. The payment module 7810 can communicate with the bank server 208 to transfer money from the buyer's bank accounts to the WM's bank account, and from the WM's bank account to the seller's bank account. In some embodiments, the payment module 7810 can use automated clearing house transfers (ACH) mechanism to credit and debit bank accounts.

The facility assignment module 7812 is configured to assign facilities to buyers. The facility assignment module 7812 can determine the amount of facility to be assigned to each buyer. In some embodiments, the facility assignment module 7812 can use one or more of the following factors to determine the amount of facility to be assigned to each buyer: (1) the amount of facility requested by the buyer, (2) a credit rating associated with the buyer, (3) the number of workers employed by the buyer, (4) the reputation of the operating officers employed by the buyer, (5) the number of years in business, (6) the number of sellers offering facilities, and (7) the amount of facilities offered by sellers.

The trade credit crowd-sourcing module 7814 is configured to receive trade credits from one or more sellers maintained by the account manager module 7808, and consolidate all received trade credits so that the portions of the consolidated trade credits can be allocated to buyers as facilities.

The pricing calculator module 7816 is configured to use one of two pricing schemes to determine the fees for the assignment. In the first pricing scheme, the pricing calculator module 7818 can receive the value of the fixed fee that the buyer is willing to pay the seller. The pricing calculator module 7816 would subsequently add a transaction fee to the fixed fee to compute the total cost to the buyer. In the second pricing scheme, the pricing calculator module 7816 can receive the value of the total cost that the buyer is willing to incur for the assignment. The pricing calculator module 7816 would subsequently subtract a transaction fee from the specified total cost to compute the fixed fee to be paid to the seller. The pricing calculator module 7816 allows the buyer to easily determine or limit the total cost of the assignment.

The assignment coordination module 7818 is configured to intermediate communication between the buyer and the seller to facilitate the distribution and acceptance of assignments. In some embodiments, the assignment coordination module 7818 can receive assignments from buyers via the interface 7820, and distribute or advertise the received assignments to sellers via the interface 7820. If one of the sellers accepts one or more assignments, the assignment coordination module 7818 can notify the buyer that created the accepted assignments for further steps.

The account manager module 7808, the payment module 7810, the facility assignment module 7812, the trade credit crowd-sourcing module 7814, the pricing calculator module 7816, and the assignment coordination module 7818 are implemented in software, which is stored in memory 7804. The memory 7804 includes a programmable read only memory (PROM), flash memory, or some other form of computer readable medium. The software runs on a processor 302 capable of executing computer instructions or computer code. These modules might also be implemented in hardware using an application specific integrated circuit (ASIC), programmable logic array (PLA), field programmable gate array (FPGA), or any other integrated circuit.

An interface 7820 provides an input and/or output mechanism to communicate over a network. The interface 7820 enables communication with servers, as well as other core network nodes to send and receive data. The interface 7820 is implemented in hardware to send and receive signals in a variety of mediums, such as optical, copper, and wireless, and in a number of different protocols some of which may be non-transient.

The server 202 operates using an operating system (OS) software. In a preferred embodiment, the OS software is based on a Linux software kernel and runs specific applications in the server such as monitoring tasks and providing protocol stacks. The OS software allows server resources to be allocated separately for control and data paths. For example, certain packet accelerator cards and packet services cards are dedicated to performing routing or security control functions, while other packet accelerator cards/packet services cards are dedicated to processing user session traffic. As network requirements change, hardware resources are dynamically deployed to meet the requirements in some embodiments.

The server's software is divided into a series of tasks that perform specific functions. These tasks communicate with each other as needed to share control and data information throughout the server 202. A task is a software process that performs a specific function related to system control or session processing. Three types of tasks operate within the server 202 in some embodiments: critical tasks, controller tasks, and manager tasks. The critical tasks control functions that relate to the server's ability to process calls such as server initialization, error detection, and recovery tasks. The controller tasks mask the distributed nature of the software from the user and perform tasks such as monitor the state of subordinate manager(s), provide for intra-manager communication within the same subsystem, and enable inter-subsystem communication by communicating with controller(s) belonging to other subsystems. The manager tasks can control system resources and maintain logical mappings between system resources.

Individual tasks that run on processors in the application cards are divided into subsystems. A subsystem is a software element that either performs a specific task or is a culmination of multiple other tasks. A single subsystem includes critical tasks, controller tasks, and manager tasks. Some of the subsystems that run on the server 202 include a system initiation task subsystem, a high availability task subsystem, a shared configuration task subsystem, and a resource management subsystem.

The system initiation task subsystem is responsible for starting a set of initial tasks at system startup and providing individual tasks as needed. The high availability task subsystem works in conjunction with the recovery control task subsystem to maintain the operational state of the server 202 by monitoring the various software and hardware components of the server 202. Recovery control task subsystem is responsible for executing a recovery action for failures that occur in the server 202 and receives recovery actions from the high availability task subsystem. Processing tasks are distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will not be affected by that problem.

The shared configuration task subsystem provides the server 202 with an ability to set, retrieve, and receive notification of server 202 configuration parameter changes and is responsible for storing configuration data for the applications running within the server 202. The resource management subsystem is responsible for assigning resources (e.g., processor and memory capabilities) to tasks and for monitoring the task's use of the resources.

In some embodiments, the server 202 resides in a data center and forms a node in a cloud computing infrastructure. The server 202 provides services on demand. A module hosting a client is capable of migrating from one server to another server seamlessly, without causing any program faults or system breakdown. The server 202 on the cloud can be managed using a management system, which can include the Rightscale Cloud Management Platform provided by Rightscale, Inc.

In some embodiments, the server 202 uses cryptography methods to encrypt and decrypt information. The cryptography method can include, for example, the RSA algorithm, the Data Encryption Standards (DES), the triple-DES, the Advanced Encryption Standard (AES), the blowfish algorithm, the International Data Encryption Algorithm (IDEA), the Software-optimized Encryption Algorithm (SEAL), the Message Digest algorithms, and the RC4 algorithm.

In some embodiments, the software needed for implementing a process or a database includes a high level procedural or an object-orientated language such as C, C++, C#, Java, or Perl. The software may also be implemented in assembly language if desired. The language can be a compiled or an interpreted language. Packet processing implemented in a server includes any processing determined by the context. For example, packet processing may involve high-level data link control (HDLC) framing, header compression, and/or encryption. In some embodiments, the software is stored on a storage medium or device such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Other embodiments are within the following claims. For example, the server groups in the server can each be a logical module running on a single server.

We claim:

1. A method for operating an online market, the method comprising:
receiving, at a trade credit crowd sourcing module within a server, trade credit from a plurality of accounts associated with one or more computing devices, wherein the server is configured to communicate with the one or more computing devices over a communication network;
consolidating, at the trade credit crowd sourcing module, the trade credit received from the one or more computing devices;
determining, at an account manager module within the server and in communication with the trade credit crowd sourcing module, if a first account of the online market is associated with a bank account, wherein the first account is associated with a first computing device; and
if the first account is associated with a bank account, providing, by a facility assignment module within the server and in communication with the trade credit crowd sourcing module, a portion of the consolidated trade credit as a facility to the first account, wherein the facility comprises trade credit with which the first account can create assignments to purchase one of work services and work product.

2. The method of claim 1, further comprising:
receiving, at an assignment coordination module within the server, an assignment from the first computing device, wherein the assignment comprises a description of a requested task, a payment term duration, and a fee associated with the assignment;
providing, by the assignment coordination module within the server, the assignment to a second computing device associated with a second account;
receiving, at the assignment coordination module within the server, an acceptance message from the second computing device, accepting the assignment created by the first computing device; and
providing, by the assignment coordination module within the server, the acceptance message to the first computing device, thereby causing a formation of an agreement to perform the assignment.

3. The method of claim 2, wherein providing the assignment to the second computing device comprises providing the assignment to the second computing device selected by the first computing device.

4. The method of claim 3, wherein the second computing device is selected by the first computing device based in part on a Seller Quality Metric score.

5. The method of claim 1, further comprising determining, by the facility assignment module within the server, an amount of the facility to be provided to the first account based on one or more of following factors: (1) an amount of facility requested by a user of the first account, (2) a credit rating associated with the user of the first account, (3) a number of workers employed by the user of the first account, (4) a number of years in business by the user of the first account, (5) a reputation of officers working with the user of the first account, and (6) an amount of trade credit offered by a plurality of accounts associated with one or more computing devices.

6. The method of claim 1, wherein if the first account is not associated with a bank account, determining whether the first account should nevertheless receive the facility, and if so, providing, by the facility assignment module within the server, the facility to the first account.

7. The method of claim 2, further comprising:
sending a request to the first computing device, by a pricing calculator module within the server and in communication with the assignment coordination module, to specify the fee associated with the assignment;
computing a transaction fee based on the fee associated with the assignment; and
providing a total fee, including the fee associated with the assignment and the transaction fee, to the first account.

8. The method of claim 2, further comprising:
sending a request to the first computing device, by a pricing calculator module within the server and in communication with the assignment coordination module, to specify a total fee to be paid for the assignment; and
computing a transaction fee based on the total fee.

9. A network device for operating an online market, the network device comprising:
one or more interfaces configured to provide communication with a first computing device, a second computing device, and one or more additional computing devices over a communication network, wherein the first computing device is associated with a first account, and the second computing device is associated with a second account; and
a processor, in communication with the one or more interfaces, and configured to:
receive trade credit, through a trade credit crowd sourcing module, from accounts associated with the one or more computing devices;
consolidate, through the trade credit crowd sourcing module, the trade credit received from the one or more computing devices;
determine, through an account manager module, if a first account of the online market is associated with a bank account; and
if the first account is associated with a bank account, provide, through a facility assignment module, a portion of the consolidated trade credit as a facility to the first account, wherein the facility comprises trade credit with which the first account can create assignments to purchase one of work services and work product.

10. The network device of claim 9, wherein the processor is further configured to:
receive, through an assignment coordination module, an assignment from the first computing device, wherein the assignment comprises a description of a requested task, a payment term duration, and a fee associated with the assignment,
provide, through the assignment coordination module, the assignment to the second computing device,
receive, through the assignment coordination module, an acceptance message from the second computing device, accepting the assignment created by the first computing device, and
provide, through the assignment coordination module, the acceptance message to the first computing device.

11. The network device of claim 10, wherein the processor is further configured to provide, through the assignment coordination module, the assignment to the second computing device selected by the first computing device.

12. The network device of claim 11, wherein the second computing device is selected by the first computing device based in part on a Seller Quality Metric score.

13. The network device of claim 9, wherein the processor is configured to determine, through the facility assignment module, an amount of the facility to be provided to the first account based on one or more of following factors: (1) an amount of facility requested by a user of the first account, (2) a credit rating associated with the user of the first account, (3) a number of workers employed by the user of the first account, (4) a number of years in business by the user of the first account, (5) a reputation of officers working with the user of the first account, and (6) an amount of trade credit offered by a plurality of accounts associated with one or more computing devices.

14. The network device of claim 9, wherein if the first account is not associated with a bank account, the processor is configured to determine, through the facility assignment module, whether the first account should nevertheless be credited with a facility, and if so, the processor is configured to provide the facility to the first account.

15. The network device of claim 10, wherein the processor is configured to:
send a request, through a pricing calculator module, to the first computing device to specify the fee associated with the assignment,
compute a transaction fee based on the fee associated with the assignment, and
provide a total fee, including the fee associated with the assignment and the transaction fee, to the first account.

16. Tangible, non-transitory computer readable media comprising machine-readable executable code operable to cause a data processing apparatus to:
receive trade credits, through a trade credit crowd sourcing module, from a plurality of accounts associated with one or more computing devices over a communication network;
consolidate, through the trade credit crowd sourcing module, the trade credit received from the one or more computing devices;
determine, through an account manager module, if a first account of the online market is associated with a bank account; and
if the first account is associated with a bank account, provide, through a facility assignment module, a portion of the consolidated trade credit as a facility to the first account, wherein the facility comprises trade credit with which the first account can create assignments to purchase one of work services and work product.

17. The computer readable media of claim 16, wherein the machine-readable executable code is further operable to cause the data processing apparatus to:
receive, through an assignment coordination module, an assignment from the first computing device, wherein the assignment comprises a description of a requested task, a payment term duration, and a fee associated with the assignment,
provide, through the assignment coordination module, the assignment to the second computing device,
receive, through the assignment coordination module, an acceptance message from the second computing device, accepting the assignment created by the first computing device, and
provide, through the assignment coordination module, the acceptance message to the first computing device.

18. The computer readable media of claim 16, wherein if the first account is not associated with a bank account, the machine-readable executable code is further operable to cause the data processing apparatus to determine, through the facility assignment module, whether the first account should nevertheless be credited with a facility, and if so, the processor is configured to provide the facility to the first account.

19. The computer readable media of claim 17, wherein the machine-readable executable code is further operable to cause the data processing apparatus to:
send a request, through a pricing calculator module, to the first computing device to specify the fee associated with the assignment,
compute a transaction fee based on the fee associated with the assignment, and
provide a total fee, including the fee associated with the assignment and the transaction fee, to the first account.

20. The computer readable media of claim 17, wherein the machine-readable executable code is further operable to cause the data processing apparatus to:
send a request, through a pricing calculator module, to the first computing device to specify a total fee to be paid for the assignment, and
compute a transaction fee based on the total fee.
